(19) United States
(12) Patent Application Publication
(10) Pub. No.: US 2022/0382443 A1
(43) Pub. Date: Dec. 1, 2022

(54) AGGREGATED CONTENT ITEM USER INTERFACES

(71) Applicant: Apple Inc., Cupertino, CA (US)

(72) Inventors: Graham R. CLARKE, Scotts Valley, CA (US); Simon BOVET, Zurich (CH); Eric M. G. CIRCLAEYS, Los Gatos, CA (US); Bruno J. CONEJO, New York, NY (US); Kaely COON, San Francisco, CA (US); Alan C. DYE, San Francisco, CA (US); Craig M. FEDERIGHI, Los Altos Hills, CA (US); Woosung KANG, San Jose, CA (US); Chia Yang LIN, San Francisco, CA (US); Matthieu LUCAS, San Francisco, CA (US); Behkish J. MANZARI, San Francisco, CA (US); Charles A. MEZAK, Fairfield, CT (US); Pavel PIVONKA, San Francisco, CA (US); William A. SORRENTINO, III, Mill Valley, CA (US); Andre SOUZA DOS SANTOS, San Jose, CA (US); Denys STAS, Santa Clara, CA (US)

(21) Appl. No.: 17/542,947

(22) Filed: Dec. 6, 2021

Related U.S. Application Data
(60) Provisional application No. 63/195,645, filed on Jun. 1, 2021.

(51) Int. Cl. G06F 3/04847; G06F 3/16; G06F 3/0482; G06F 3/04883

(52) U.S. Cl. CPC G06F 3/04847; G06F 3/165; G06F 3/0482; G06F 3/04883

(57) ABSTRACT

The present disclosure generally relates to user interfaces for navigating, viewing, and editing content items, including aggregated content items.

### CROSS-REFERENCE TO RELATED APPLICATION

This application claims priority to U.S. Provisional Patent Application No. 63/195,645, entitled “AGGREGATED CONTENT ITEM USER INTERFACES,” filed on Jun. 1, 2021, the contents of which is hereby incorporated by reference in its entirety.

### FIELD

The present disclosure relates generally to computer user interfaces, and more specifically to techniques for navigating, viewing, and editing a collection of media items, including aggregated content items.

### BACKGROUND

As the storage capacity and processing power of devices continues to increase, coupled with the rise of effortless media sharing between interconnected devices, the size of user's libraries of media items (e.g., photos and videos) continues to increase.

### BRIEF SUMMARY

However, as libraries of media items continue to grow, creating an archive of the user's life and experiences, the libraries can become cumbersome to navigate. For example, many libraries arrange media items by default in a substantially inflexible manner. A user browsing for media can desire to see media that is related to a current context across different time periods. However, some interfaces require the user to navigate to an excessive number of different media directories or interfaces to locate the content that they seek. This is inefficient and a waste of the user's time and resources. Accordingly, it is therefore desirable to facilitate presentation of media items in a contextually-relevant way and thereby provide an improved interface for engaging with media content.

Further, some techniques for navigating, viewing, and/or editing a collection of media items using electronic devices are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for navigating, viewing, and editing a collection of media items, including aggregated content items (e.g., aggregated media items). Such methods and interfaces optionally complement or replace other methods for navigating, viewing, and editing a collection of media items. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with a display generation component and one or more input devices: playing, via the display generation component, visual content of a first aggregated content item, wherein the first aggregated content item comprises an ordered sequence of a first plurality of content items that are selected from a set of content items based on a first set of selection criteria; while playing the visual content of the first aggregated content item, playing audio content that is separate from the content items; while playing the visual content of the first aggregated content item and the audio content, detecting, via the one or more input devices, a user input; and in response to detecting the user input: modifying audio content that is playing while continuing to play visual content of the first aggregated content item.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: playing, via the display generation component, visual content of a first aggregated content item, wherein the first aggregated content item comprises an ordered sequence of a first plurality of content items that are selected from a set of content items based on a first set of selection criteria; while playing the visual content of the first aggregated content item, playing audio content that is separate from the content items; while playing the visual content of the first aggregated content item and the audio content, detecting, via the one or more input devices, a user input; and in response to detecting the user input: modifying audio content that is playing while continuing to play visual content of the first aggregated content item.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: playing, via the display generation component, visual content of a first aggregated content item, wherein the first aggregated content item comprises an ordered sequence of a first plurality of content items that are selected from a set of content items based on a first set of selection criteria; while playing the visual content of the first aggregated content item, playing audio content that is separate from the content items; while playing the visual content of the first aggregated content item and the audio content, detecting, via the one or more input devices, a user input; and in response to detecting the user input: modifying audio content that is playing while continuing to play visual content of the first aggregated content item.

In accordance with some embodiments, a computer system is described. The computer system is configured to communicate with a display generation component and one or more input devices, and comprises: one or more processors; and memory storing one or more programs configured to be executed by the one or more processors, the one or more programs including instructions for: playing, via the display generation component, visual content of a first aggregated content item, wherein the first aggregated content item comprises an ordered sequence of a first plurality of content items that are selected from a set of content items based on a first set of selection criteria; while playing the visual content of the first aggregated content item, playing audio content that is separate from the content items; while playing the visual content of the first aggregated content item and the audio content, detecting, via the one or more input devices, a user input; and in response to detecting the user input: modifying audio content that is playing while continuing to play visual content of the first aggregated content item.

In accordance with some embodiments, a method is described. The method comprises: at a computer system that is in communication with a display generation component and one or more input devices: playing, via the display generation component, visual content of a first aggregated content item, wherein the first aggregated content item comprises an ordered sequence of a first plurality of content items that are selected from a media library that includes photos and/or videos taken by a user of the computer system, wherein the first plurality of content items is selected based on a first set of selection criteria; while playing the visual content of the first aggregated content item, playing audio content; after playing at least a portion of the visual content of the first aggregated content item, detecting that playback of the visual content of the first aggregated content item meets one or more termination criteria; and subsequent to detecting that playback of the visual content of the first aggregated content item meets one or more termination criteria: in accordance with a determination that a playback condition of a first set of one or more playback conditions is met, playing visual content of a second aggregated content item different from the first aggregated content item, wherein the second aggregated content item comprises an ordered sequence of a second plurality of content items different from the first plurality of content items, and further wherein the second plurality of content items is selected from the media library that includes photos and/or videos taken by a user of the computer system, wherein the second plurality of content items is selected based on a second set of selection criteria.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: playing, via the display generation component, visual content of a first aggregated content item, wherein the first aggregated content item comprises an ordered sequence of a first plurality of content items that are selected from a media library that includes photos and/or videos taken by a user of the computer system, wherein the first plurality of content items is selected based on a first set of selection criteria; while playing the visual content of the first aggregated content item, playing audio content; after playing at least a portion of the visual content of the first aggregated content item, detecting that playback of the visual content of the first aggregated content item meets one or more termination criteria; and subsequent to detecting that playback of the visual content of the first aggregated content item meets one or more termination criteria: in accordance with a determination that a playback condition of a first set of one or more playback conditions is met, playing visual content of a second aggregated content item different from the first aggregated content item, wherein the second aggregated content item comprises an ordered sequence of a second plurality of content items different from the first plurality of content items, and further wherein the second plurality of content items is selected from the media library that includes photos and/or videos taken by a user of the computer system, wherein the second plurality of content items is selected based on a second set of selection criteria.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: playing, via the display generation component, visual content of a first aggregated content item, wherein the first aggregated content item comprises an ordered sequence of a first plurality of content items that are selected from a media library that includes photos and/or videos taken by a user of the computer system, wherein the first plurality of content items is selected based on a first set of selection criteria; while playing the visual content of the first aggregated content item, playing audio content; after playing at least a portion of the visual content of the first aggregated content item, detecting that playback of the visual content of the first aggregated content item meets one or more termination criteria; and subsequent to detecting that playback of the visual content of the first aggregated content item meets one or more termination criteria: in accordance with a determination that a playback condition of a first set of one or more playback conditions is met, playing visual content of a second aggregated content item different from the first aggregated content item, wherein the second aggregated content item comprises an ordered sequence of a second plurality of content items different from the first plurality of content items, and further wherein the second plurality of content items is selected from the media library that includes photos and/or videos taken by a user of the computer system, wherein the second plurality of content items is selected based on a second set of selection criteria.

In accordance with some embodiments, a computer system is described. The computer system is configured to communicate with a display generation component and one or more input devices, and comprises: one or more processors; and memory storing one or more programs configured to be executed by the one or more processors, the one or more programs including instructions for: playing, via the display generation component, visual content of a first aggregated content item, wherein the first aggregated content item comprises an ordered sequence of a first plurality of content items that are selected from a media library that includes photos and/or videos taken by a user of the computer system, wherein the first plurality of content items is selected based on a first set of selection criteria; while playing the visual content of the first aggregated content item, playing audio content; after playing at least a portion of the visual content of the first aggregated content item, detecting that playback of the visual content of the first aggregated content item meets one or more termination criteria; and subsequent to detecting that playback of the visual content of the first aggregated content item meets one or more termination criteria: in accordance with a determination that a playback condition of a first set of one or more playback conditions is met, playing visual content of a second aggregated content item different from the first aggregated content item, wherein the second aggregated content item comprises an ordered sequence of a second plurality of content items different from the first plurality of content items, and further wherein the second plurality of content items is selected from the media library that includes photos and/or videos taken by a user of the computer system, wherein the second plurality of content items is selected based on a second set of selection criteria.

In accordance with some embodiments, a method is described. The method comprises: at a computer system that is in communication with a display generation component and one or more input devices: playing, via the display generation component, visual content of a first aggregated content item, wherein the first aggregated content item comprises an ordered sequence of a first plurality of content items that are selected from a set of content items based on a first set of selection criteria; while playing the visual content of the first aggregated content item, detecting, via the one or more input devices, a user input; and in response to detecting the user input: pausing playback of the visual content of the first aggregated content item; and displaying, via the display generation component, a user interface, wherein displaying the user interface includes concurrently displaying a plurality of representations of content items in the first plurality of content items, including: a first representation of a first content item of the first plurality of content items, and a second representation of a second content item of the first plurality of content items.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: playing, via the display generation component, visual content of a first aggregated content item, wherein the first aggregated content item comprises an ordered sequence of a first plurality of content items that are selected from a set of content items based on a first set of selection criteria; while playing the visual content of the first aggregated content item, detecting, via the one or more input devices, a user input; and in response to detecting the user input: pausing playback of the visual content of the first aggregated content item; and displaying, via the display generation component, a user interface, wherein displaying the user interface includes concurrently displaying a plurality of representations of content items in the first plurality of content items, including: a first representation of a first content item of the first plurality of content items, and a second representation of a second content item of the first plurality of content items.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: playing, via the display generation component, visual content of a first aggregated content item, wherein the first aggregated content item comprises an ordered sequence of a first plurality of content items that are selected from a set of content items based on a first set of selection criteria; while playing the visual content of the first aggregated content item, detecting, via the one or more input devices, a user input; and in response to detecting the user input: pausing playback of the visual content of the first aggregated content item; and displaying, via the display generation component, a user interface, wherein displaying the user interface includes concurrently displaying a plurality of representations of content items in the first plurality of content items, including: a first representation of a first content item of the first plurality of content items, and a second representation of a second content item of the first plurality of content items.

In accordance with some embodiments, a computer system is described. The computer system is configured to communicate with a display generation component and one or more input devices, and comprises: one or more processors; and memory storing one or more programs configured to be executed by the one or more processors, the one or more programs including instructions for: playing, via the display generation component, visual content of a first aggregated content item, wherein the first aggregated content item comprises an ordered sequence of a first plurality of content items that are selected from a set of content items based on a first set of selection criteria; while playing the visual content of the first aggregated content item, detecting, via the one or more input devices, a user input; and in response to detecting the user input: pausing playback of the visual content of the first aggregated content item; and displaying, via the display generation component, a user interface, wherein displaying the user interface includes concurrently displaying a plurality of representations of content items in the first plurality of content items, including: a first representation of a first content item of the first plurality of content items, and a second representation of a second content item of the first plurality of content items.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for navigating, viewing, and editing media items, thereby increasing the effectiveness, efficiency, and user satisfaction with such devices. Such methods and interfaces may complement or replace other methods for navigating, viewing, and editing media items.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AG illustrate exemplary user interfaces for viewing and modifying content items while continuing to play visual content in accordance with some embodiments.

FIG. 7 illustrates a flow diagram depicting a method for modifying content items while continuing to play visual content in accordance with some embodiments.

FIGS. 8A-8L illustrate exemplary user interfaces for managing playing of content after playing content items in accordance with some embodiments.

FIG. 9 illustrates a flow diagram depicting a method for managing playing of content after playing content items in accordance with some embodiments.

FIGS. 10A-10S illustrate exemplary user interfaces for viewing representations of content items in accordance with some embodiments.

FIG. 11 illustrates a flow diagram depicting a method for viewing representations of content items in accordance with some embodiments.

FIGS. 12A-12W illustrate exemplary user interfaces for viewing, navigating, and editing content items in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for navigating, viewing, and editing content items (e.g., media items (e.g., photos and/or videos)). For example, there is a need for techniques that eliminate extensive manual effort by a user to retrieve media content that is related to a current context, and/or techniques that eliminate extensive manual effort by a user to modify content items, such as aggregated content items. Such techniques can reduce the cognitive burden on a user who navigates, views, and/or edits content items, thereby enhancing productivity. Further, such techniques can reduce processor and battery power otherwise wasted on redundant user inputs.

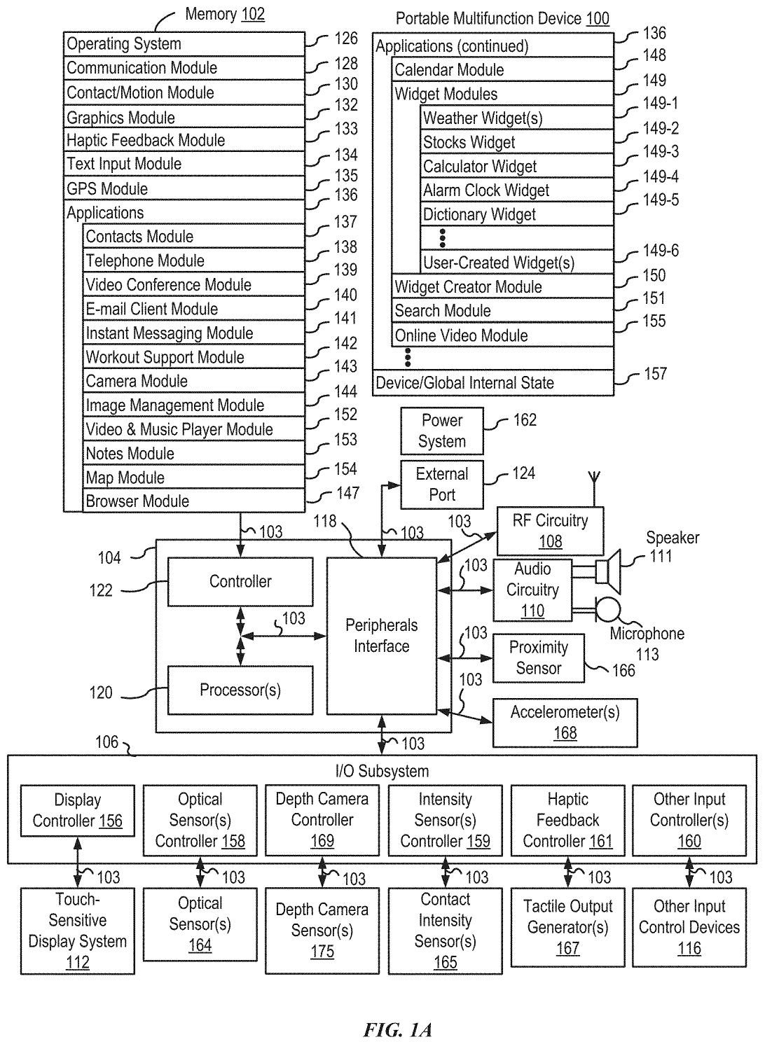

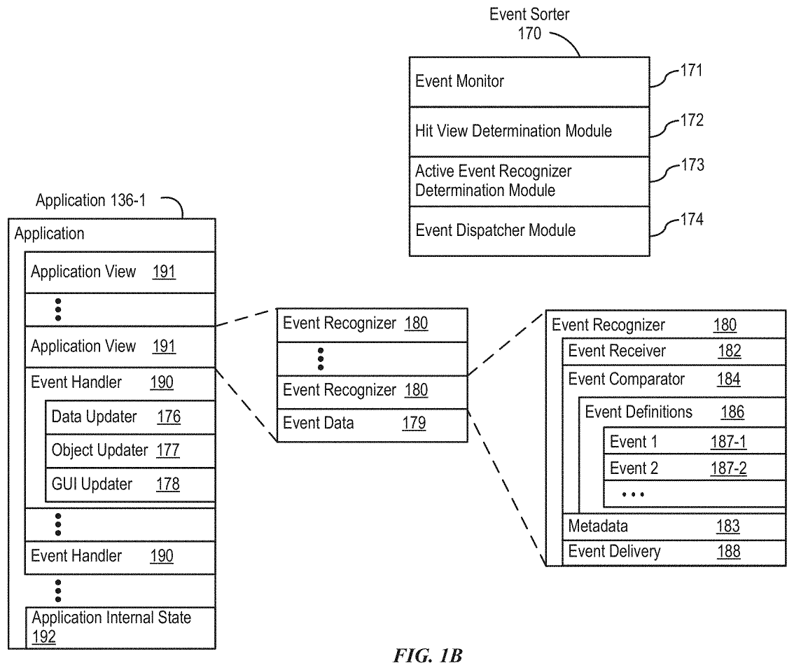

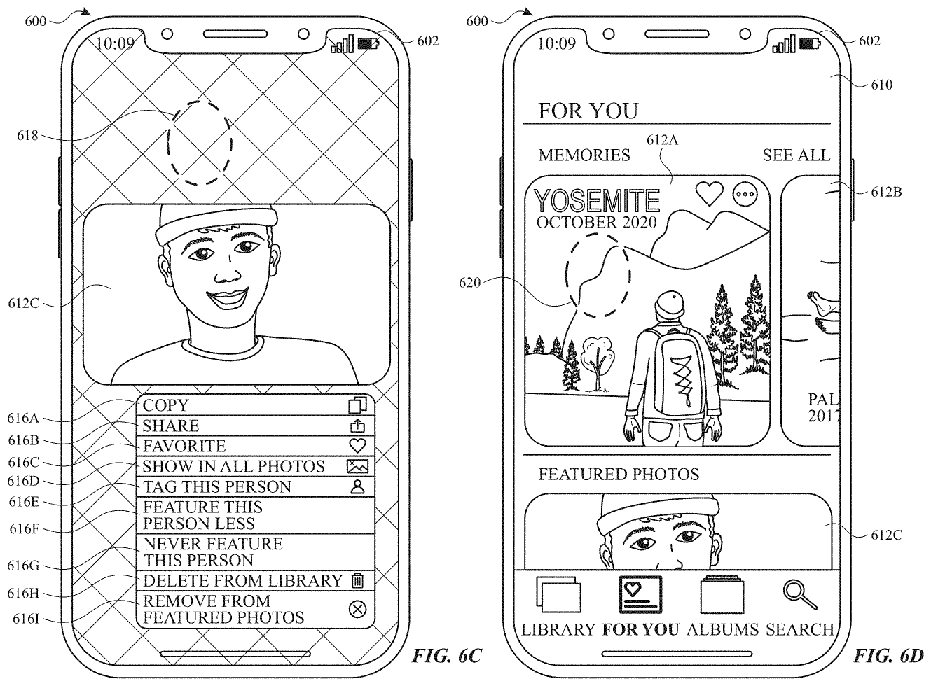

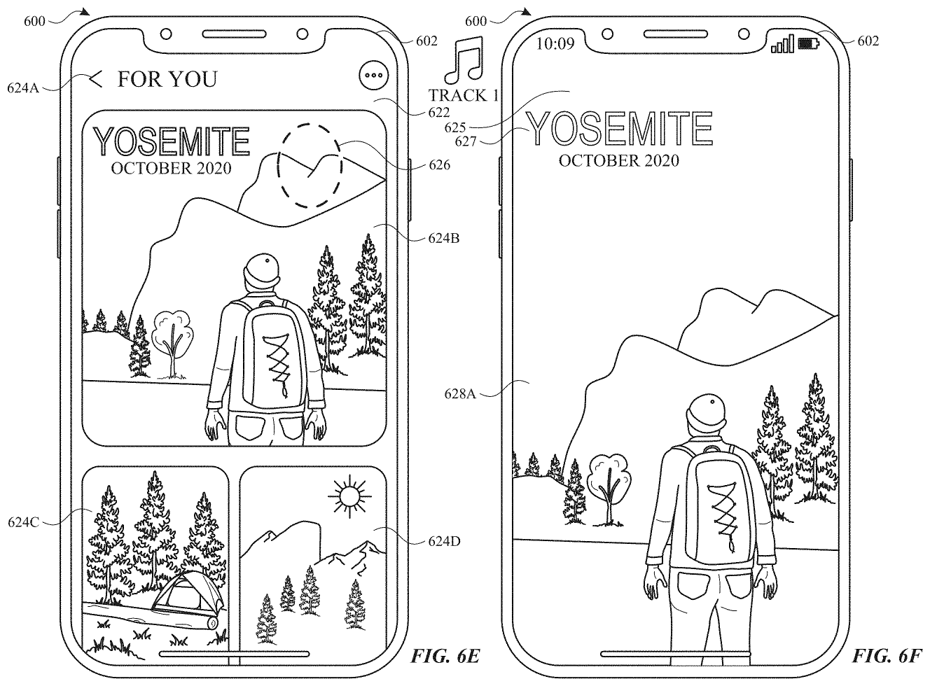

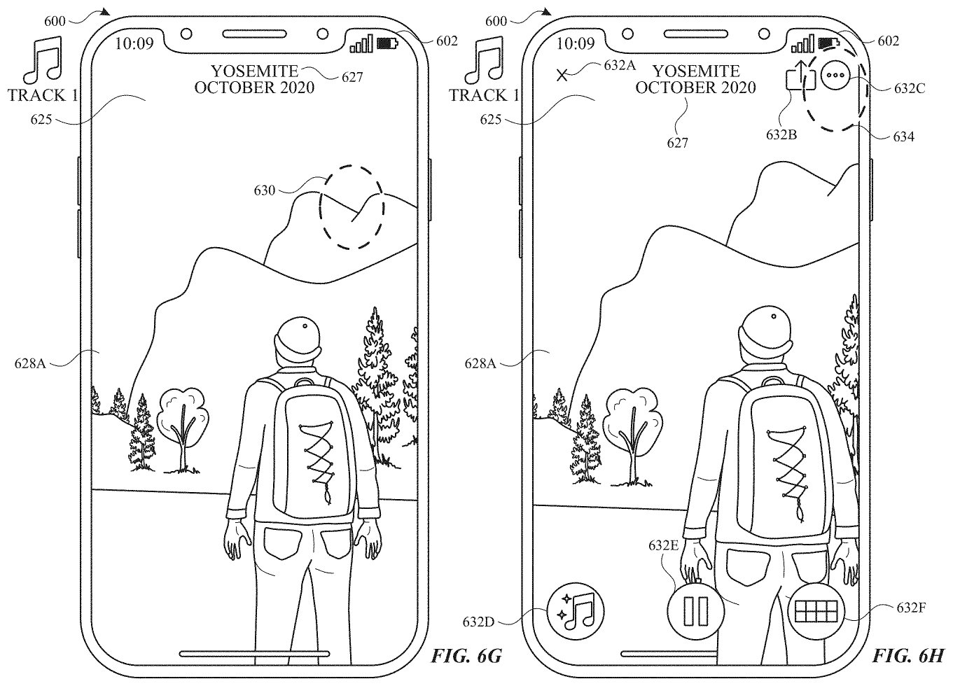

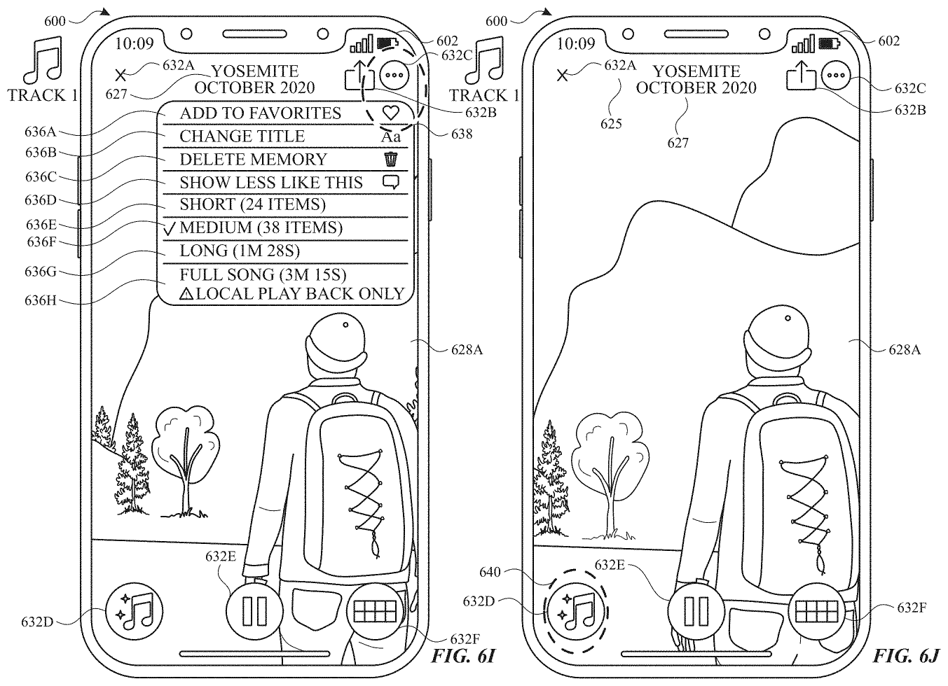

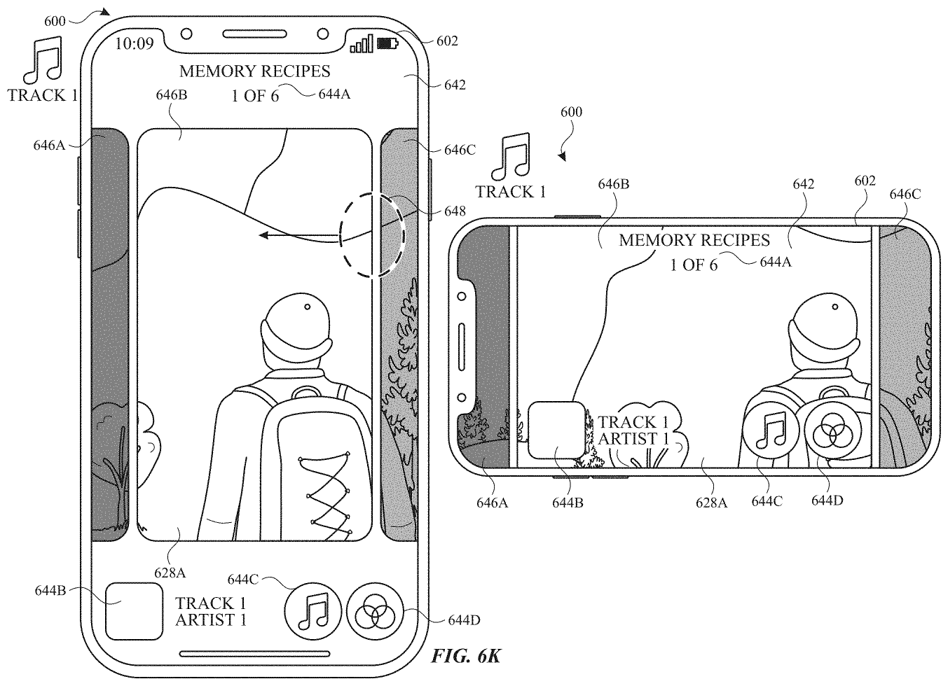

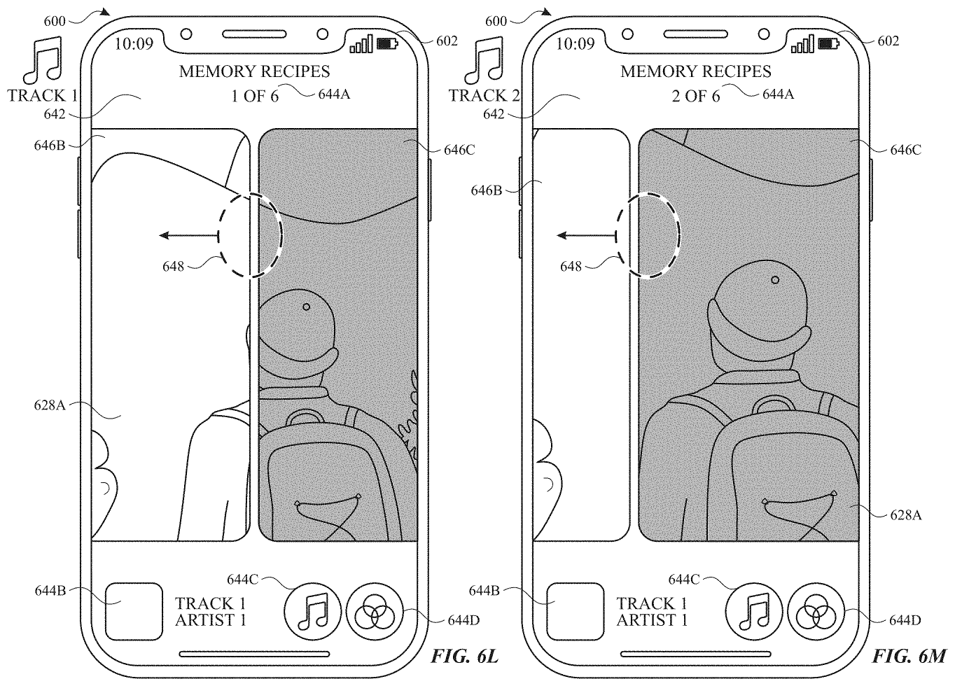

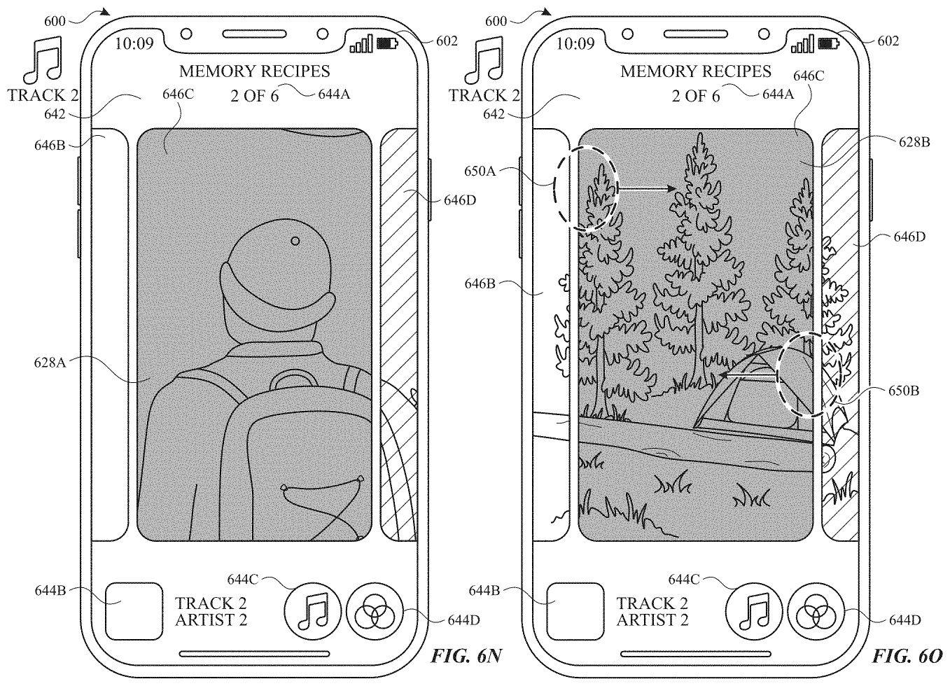

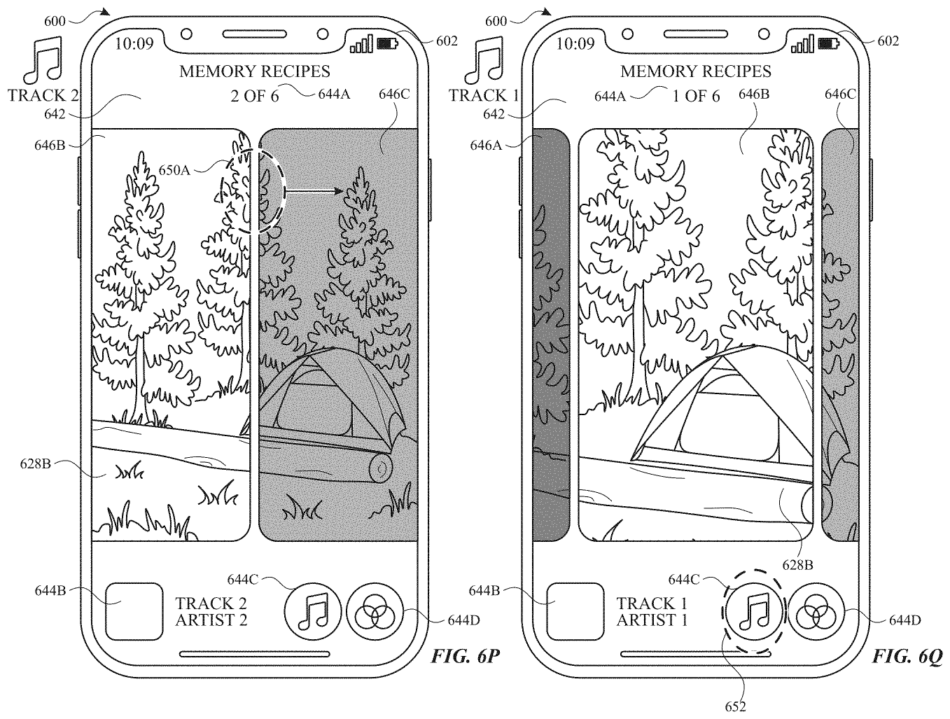

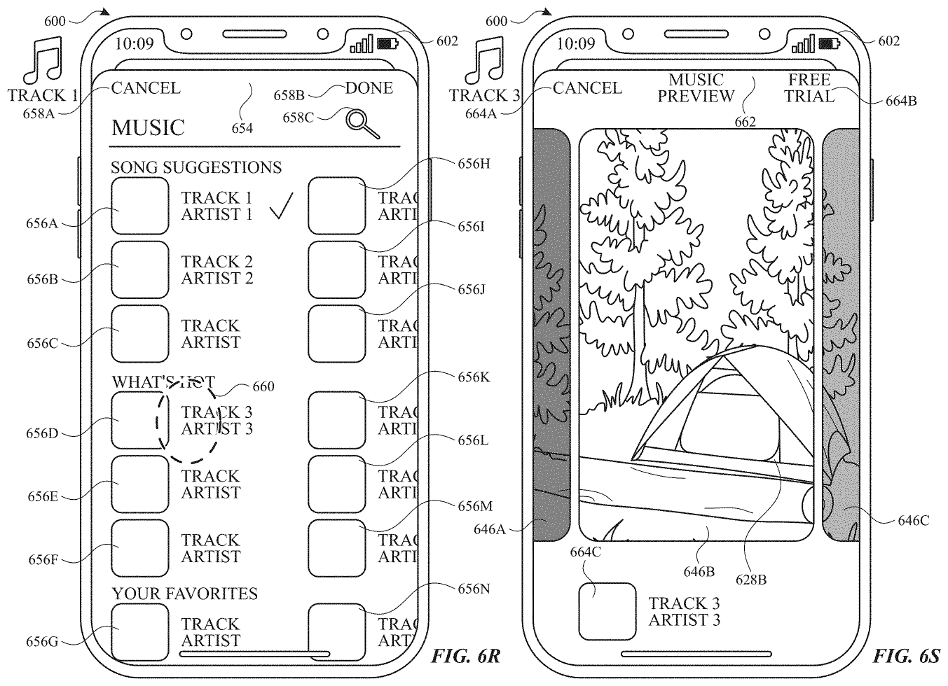

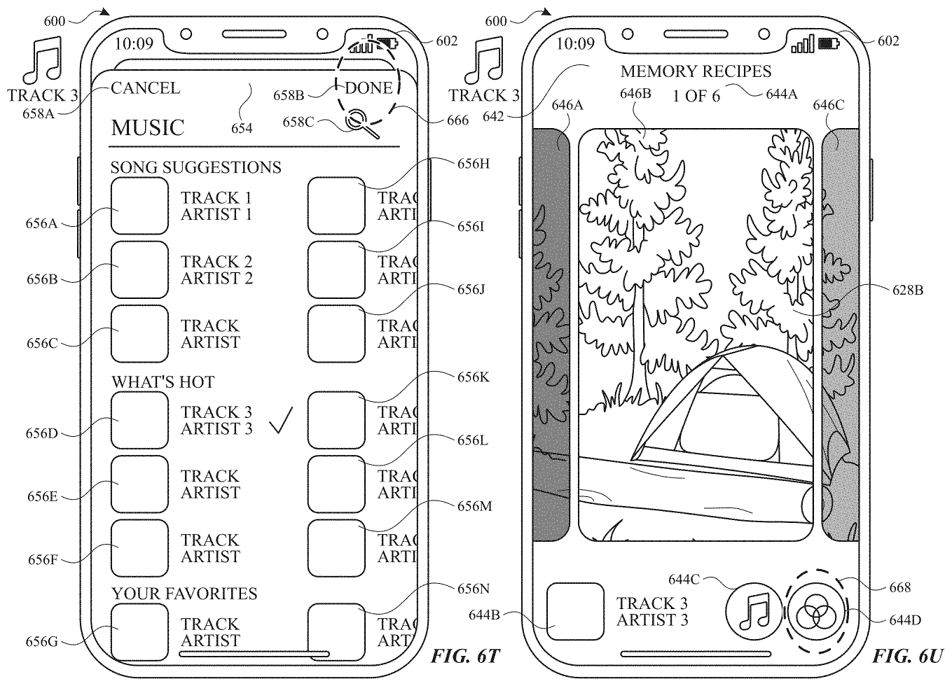

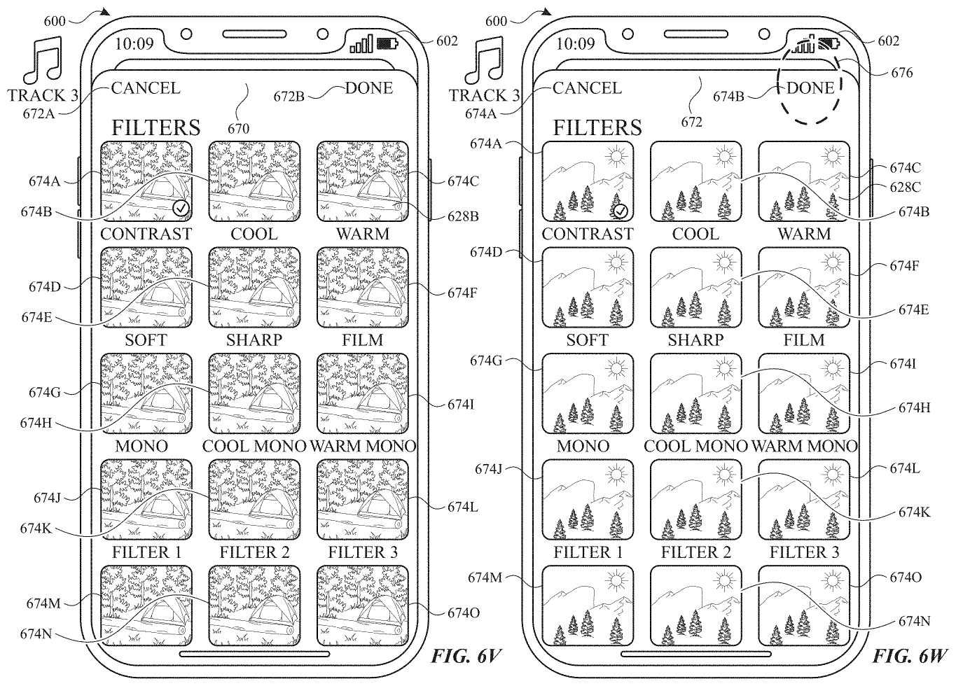

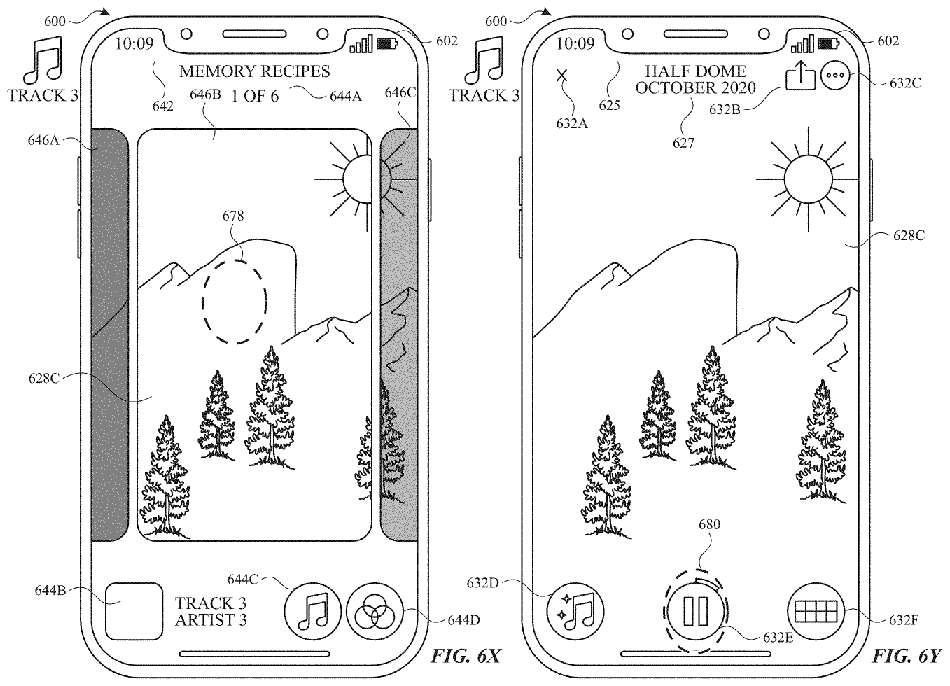

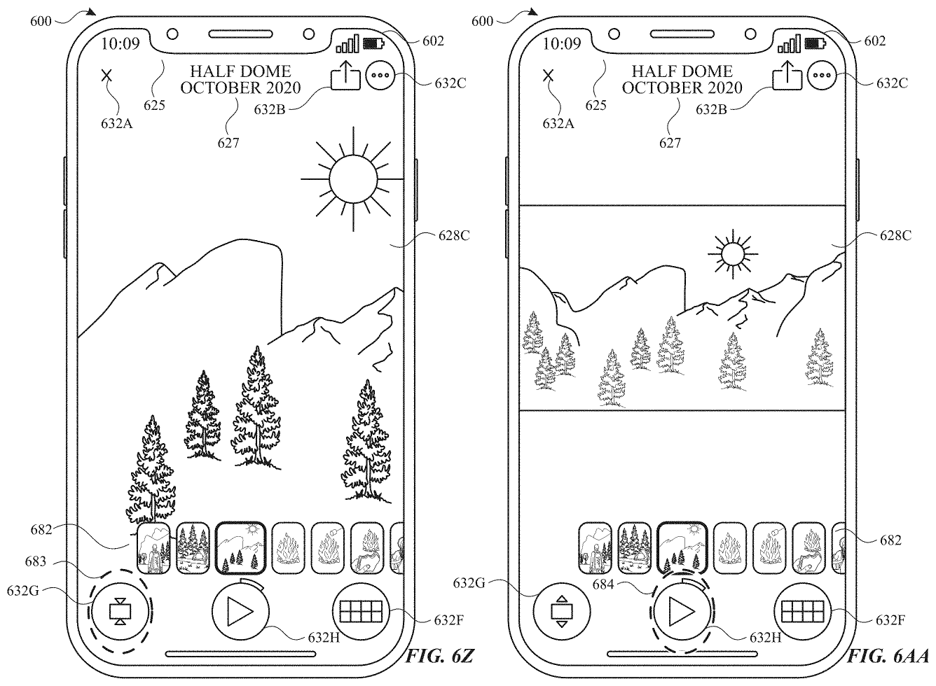

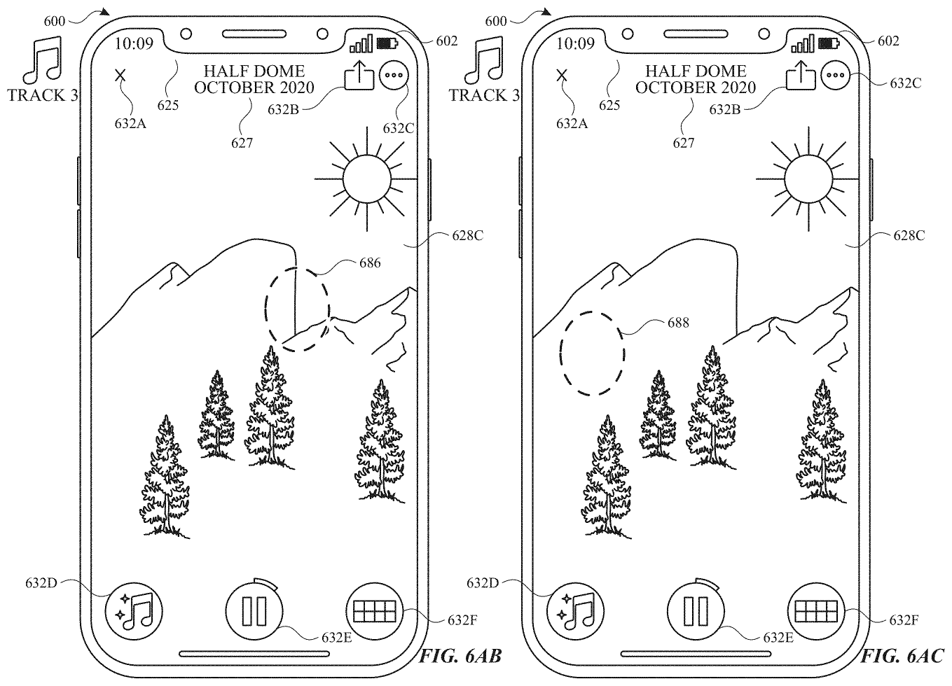

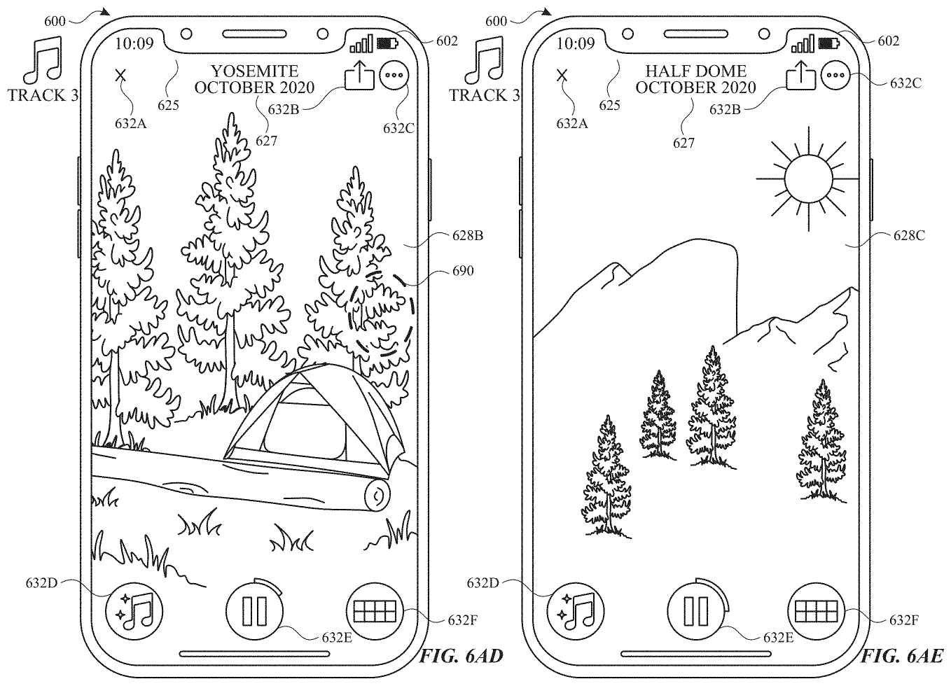

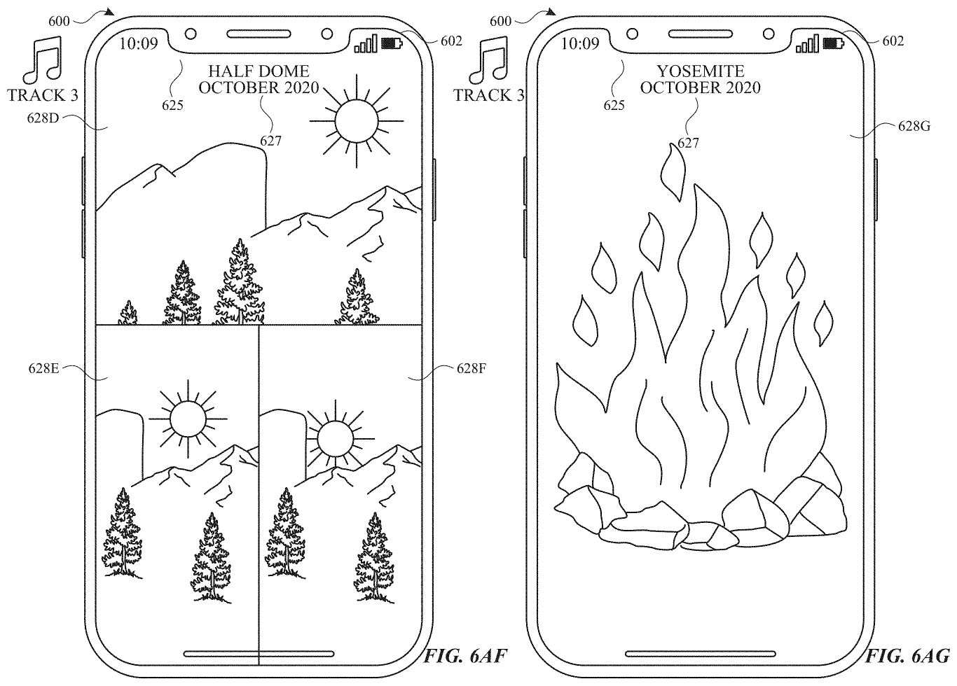

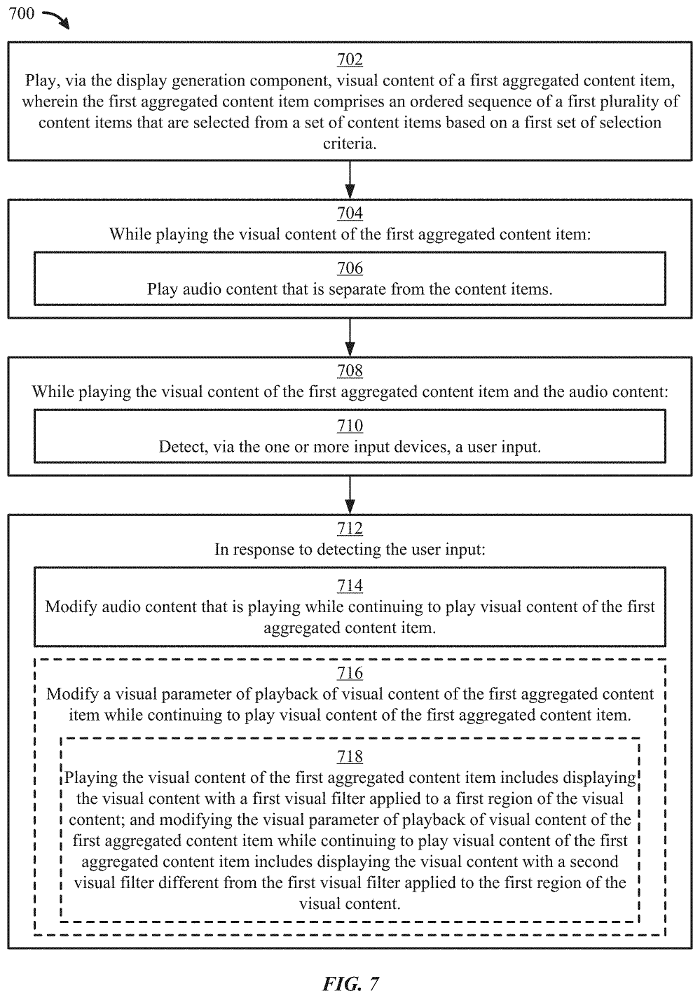

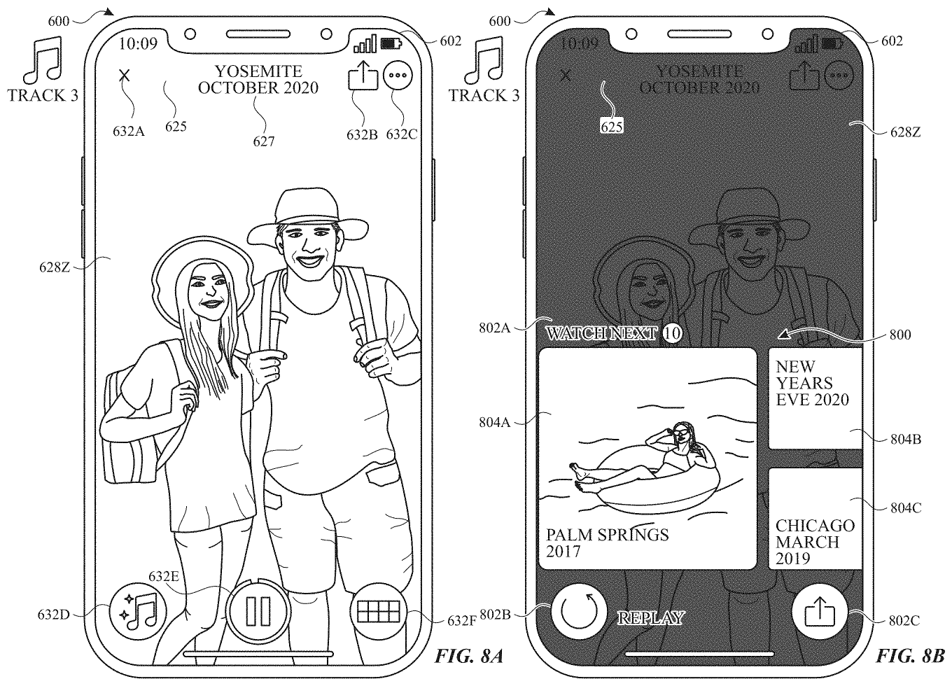

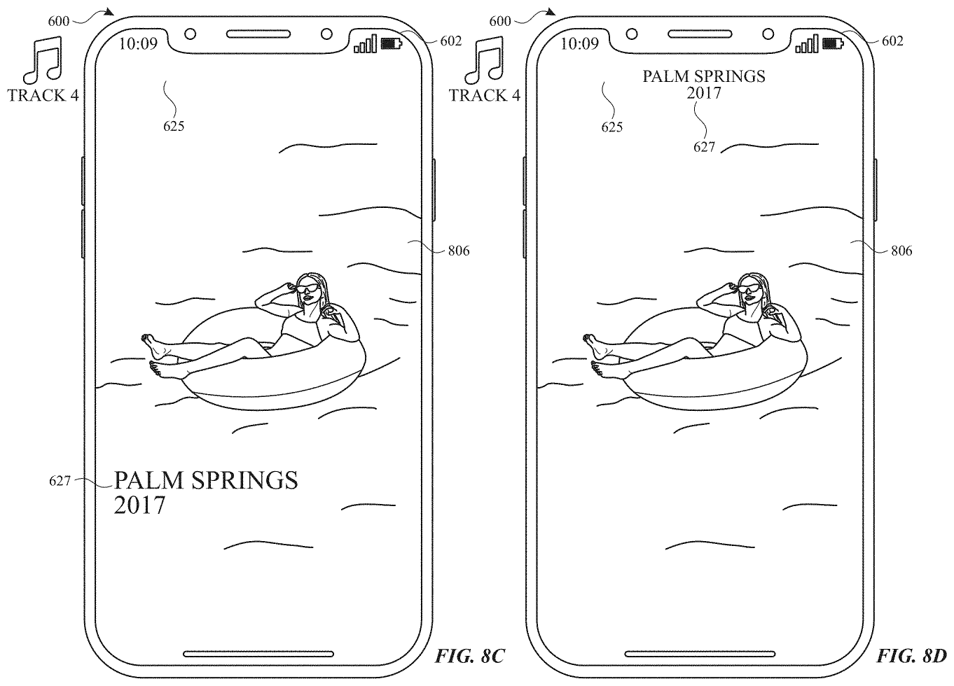

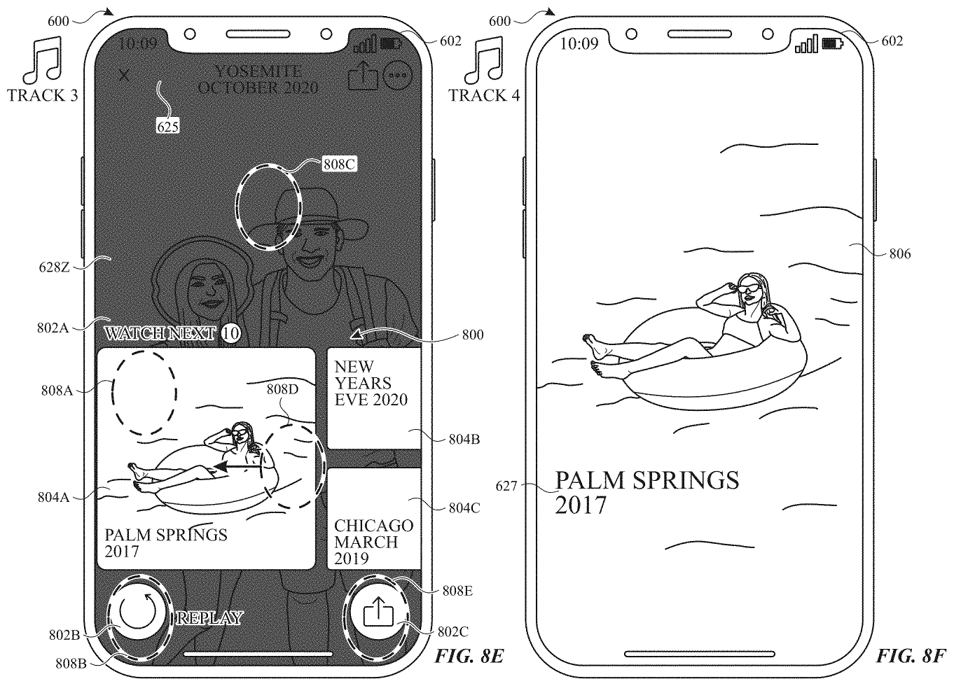

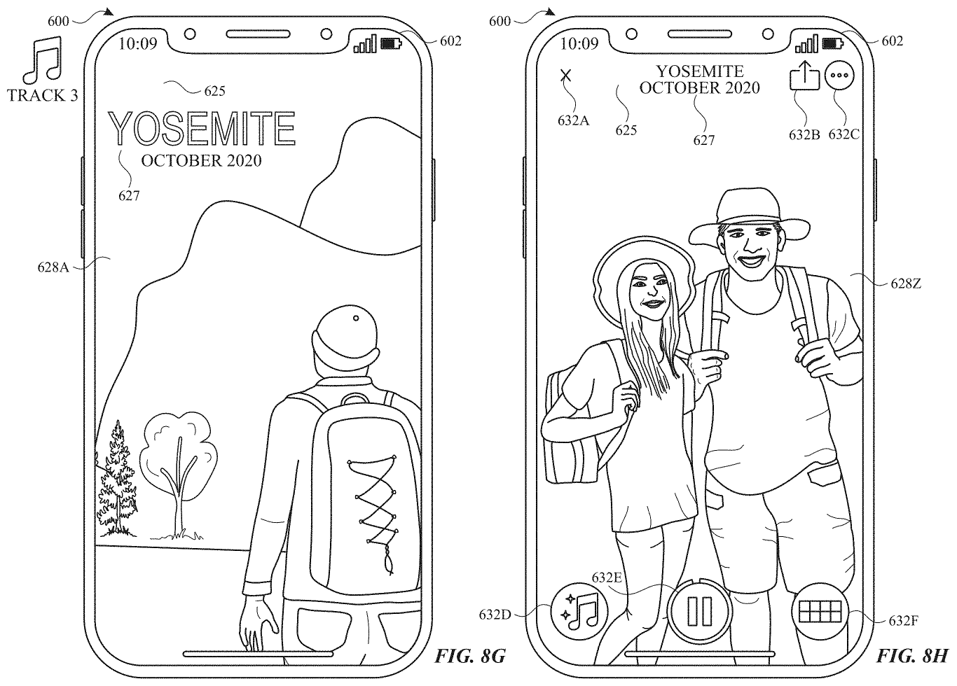

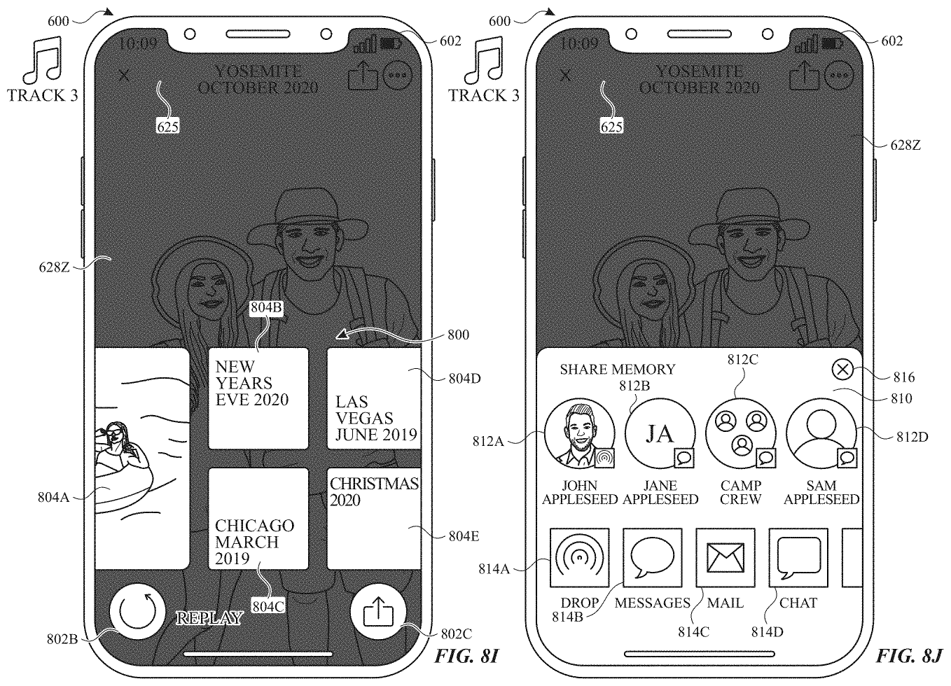

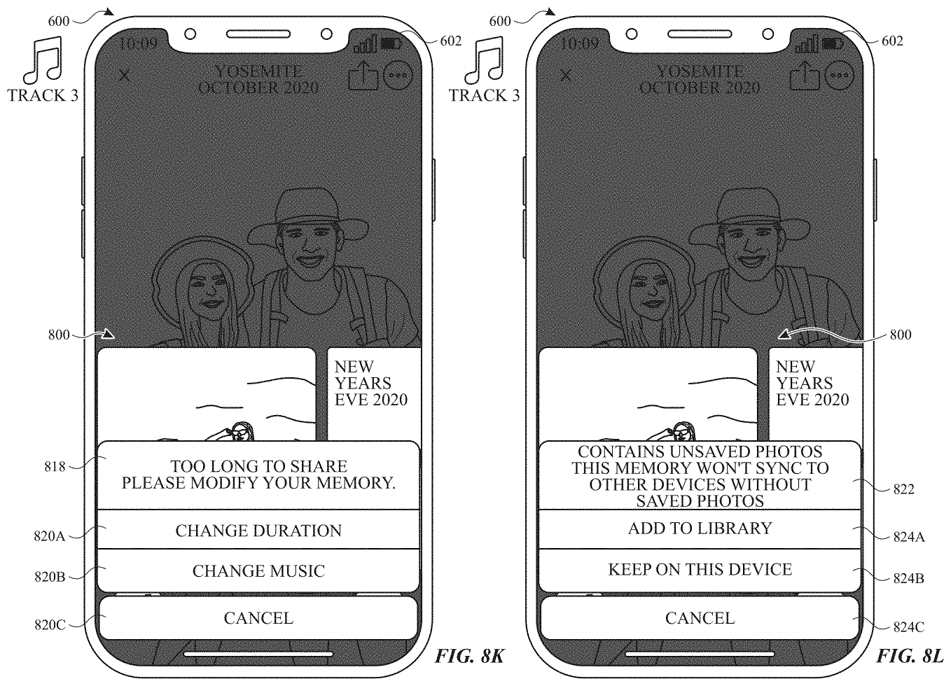

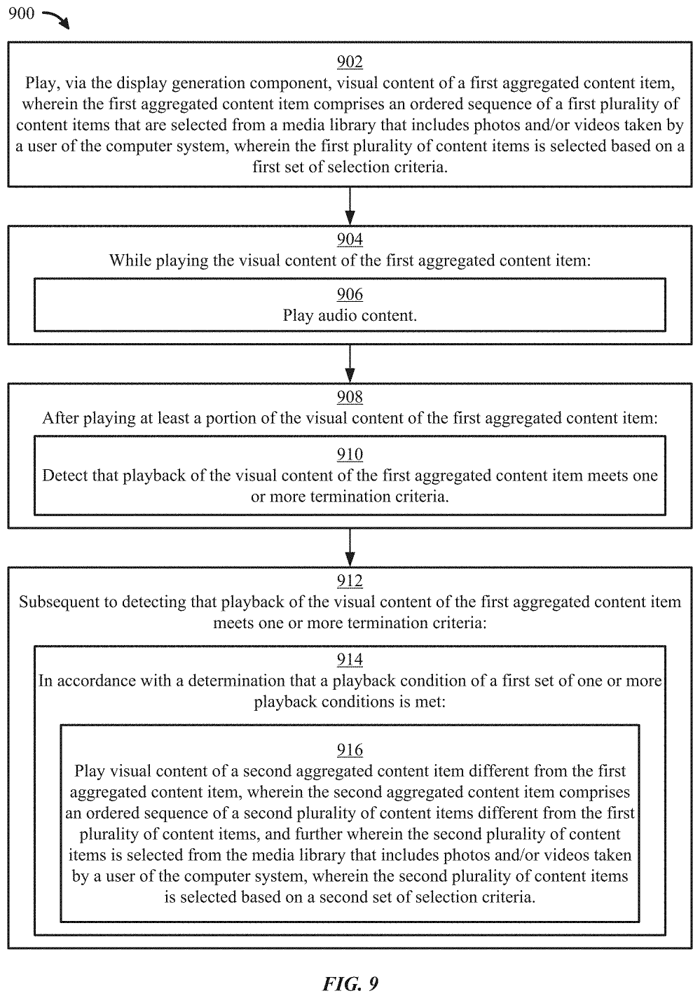

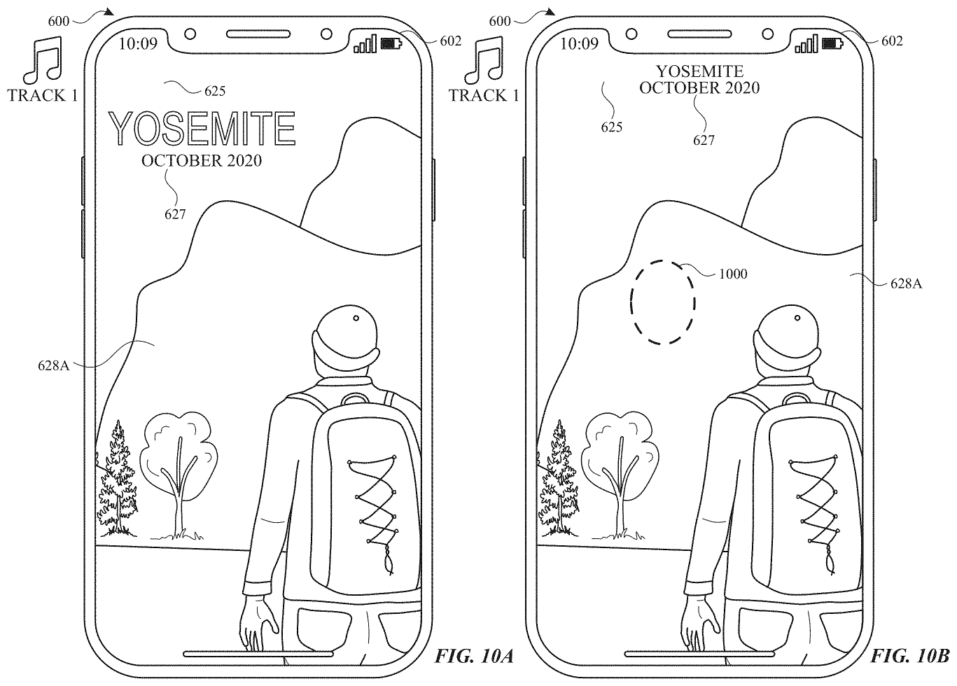

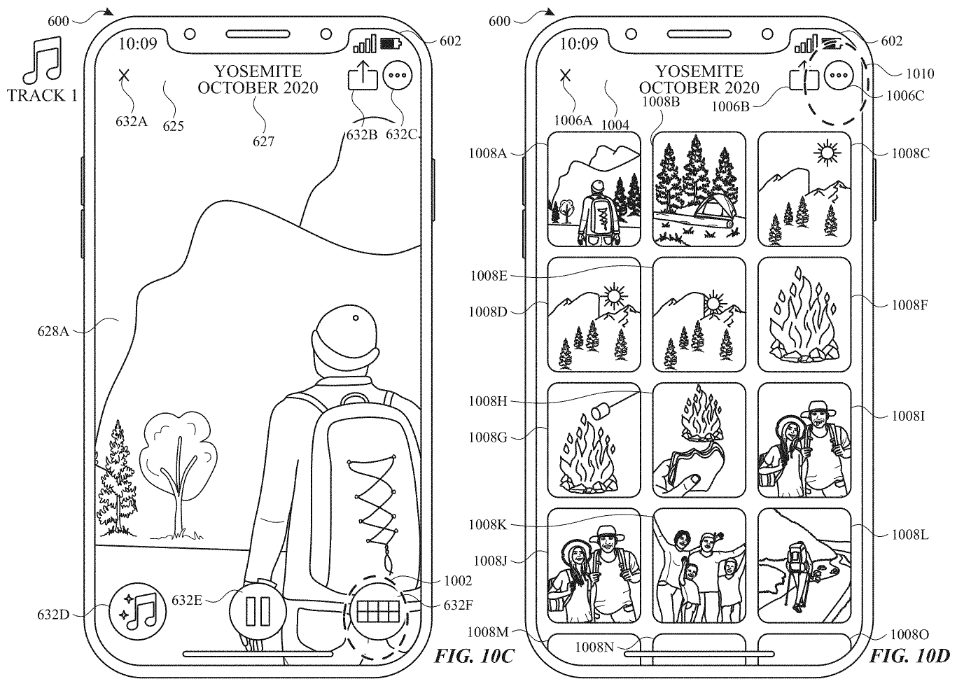

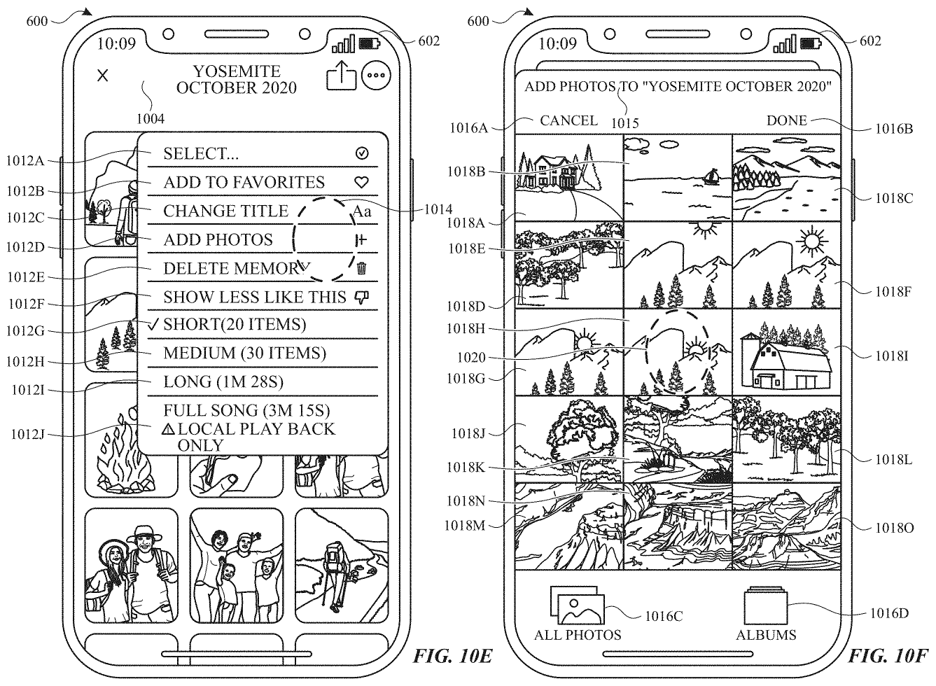

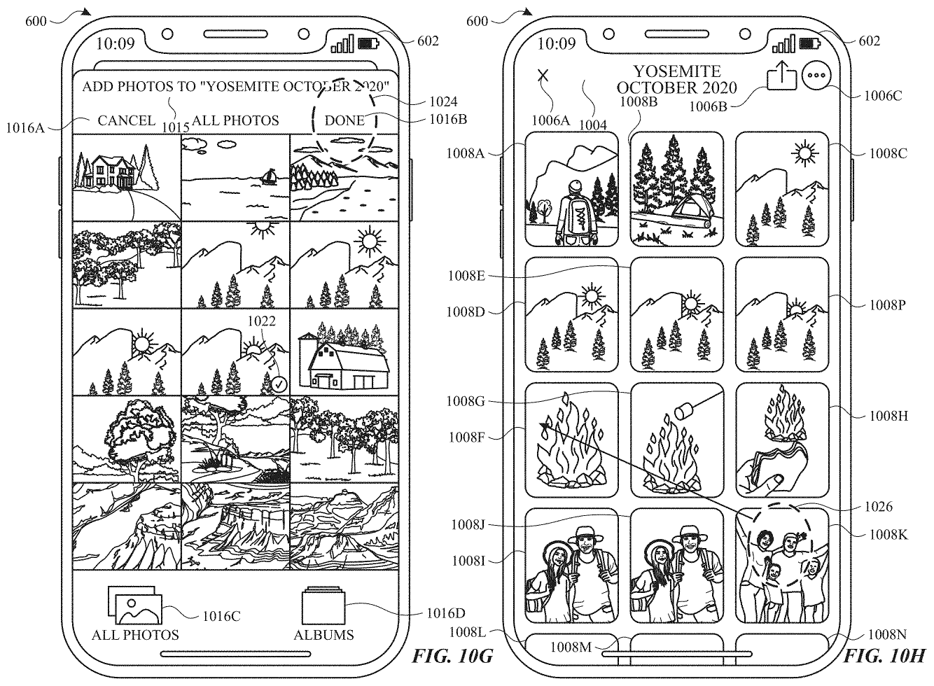

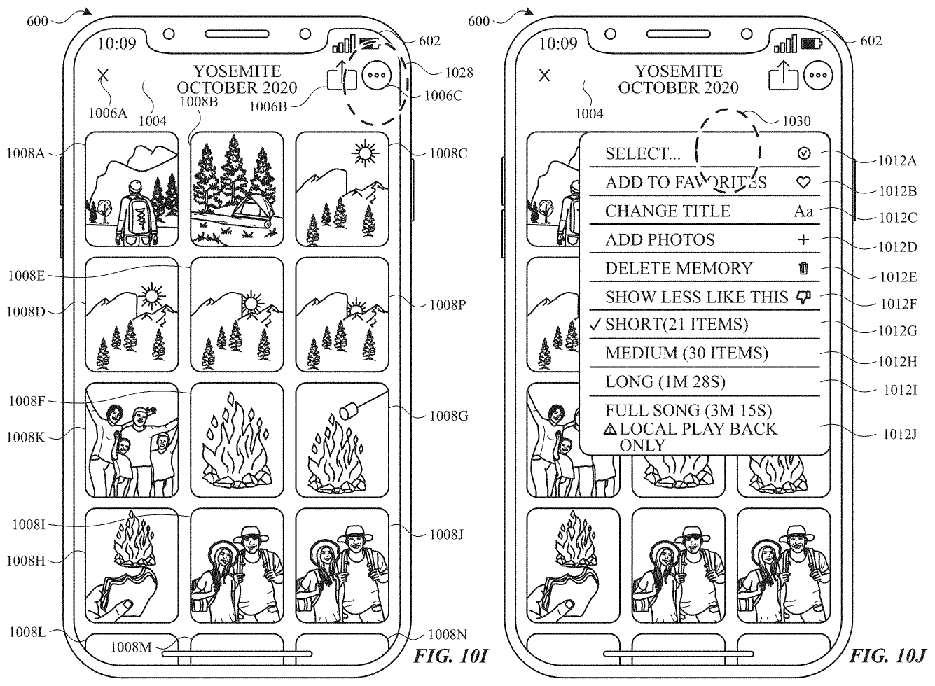

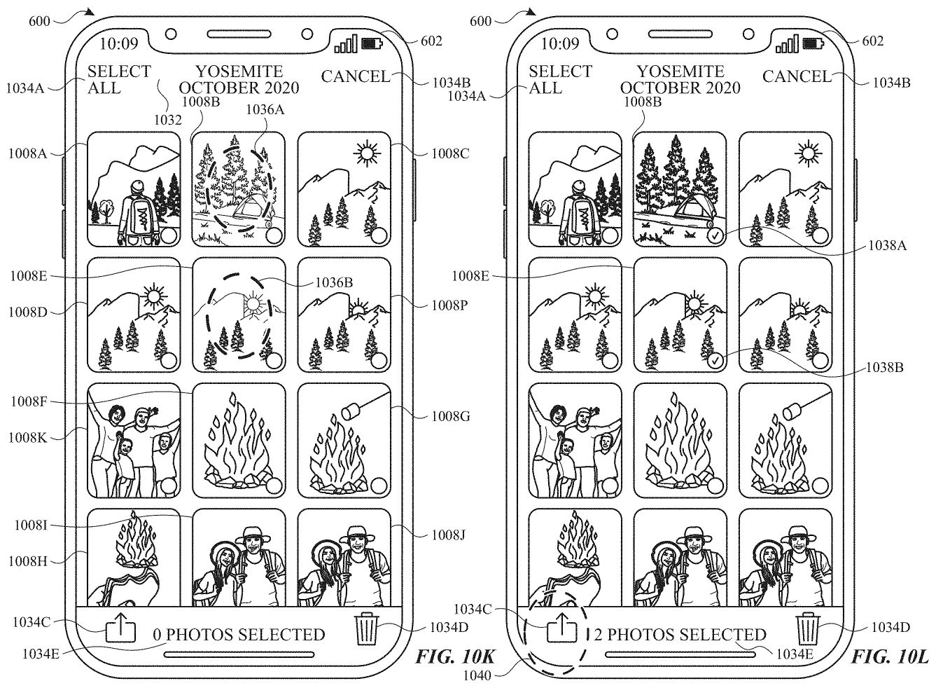

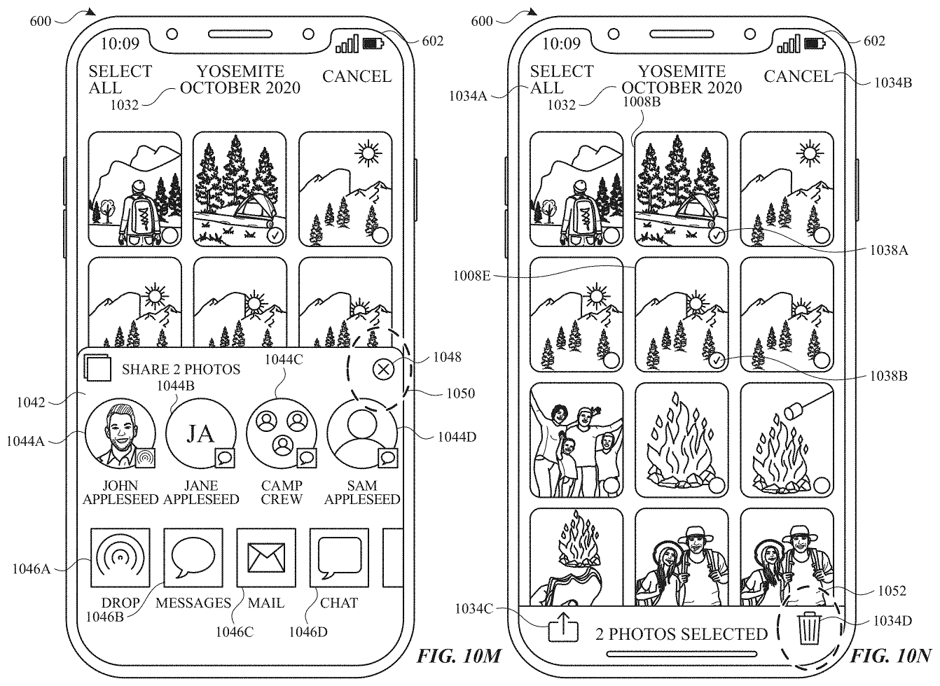

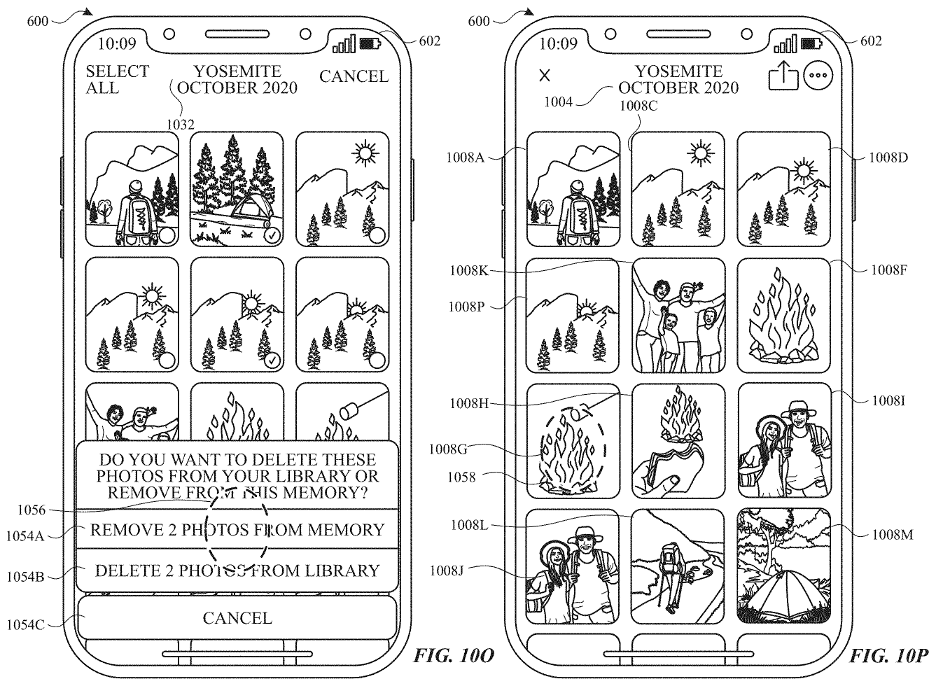

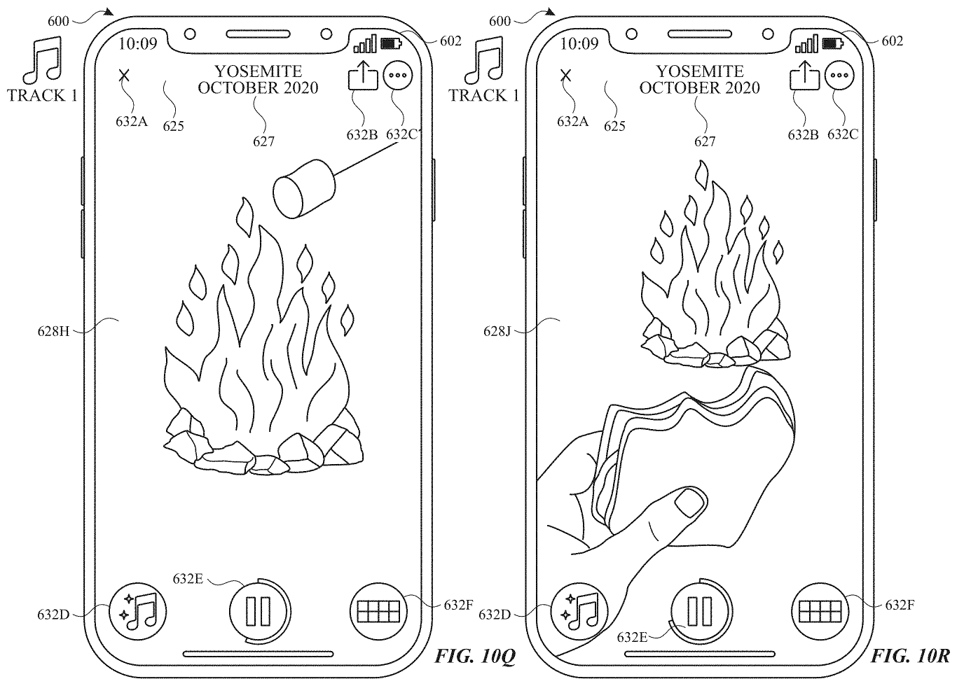

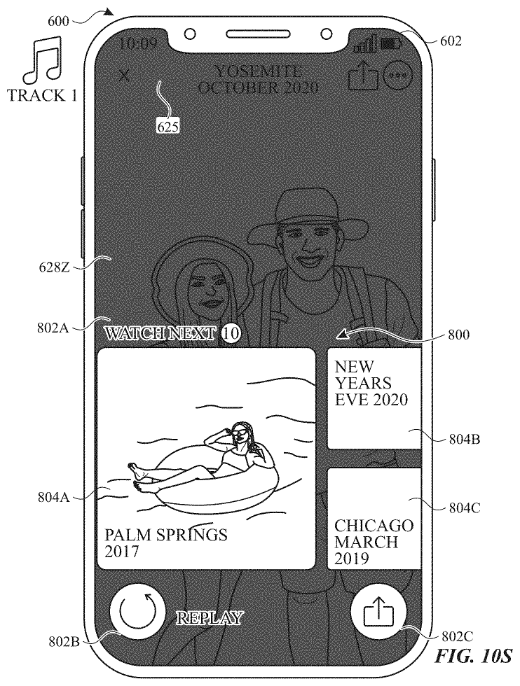

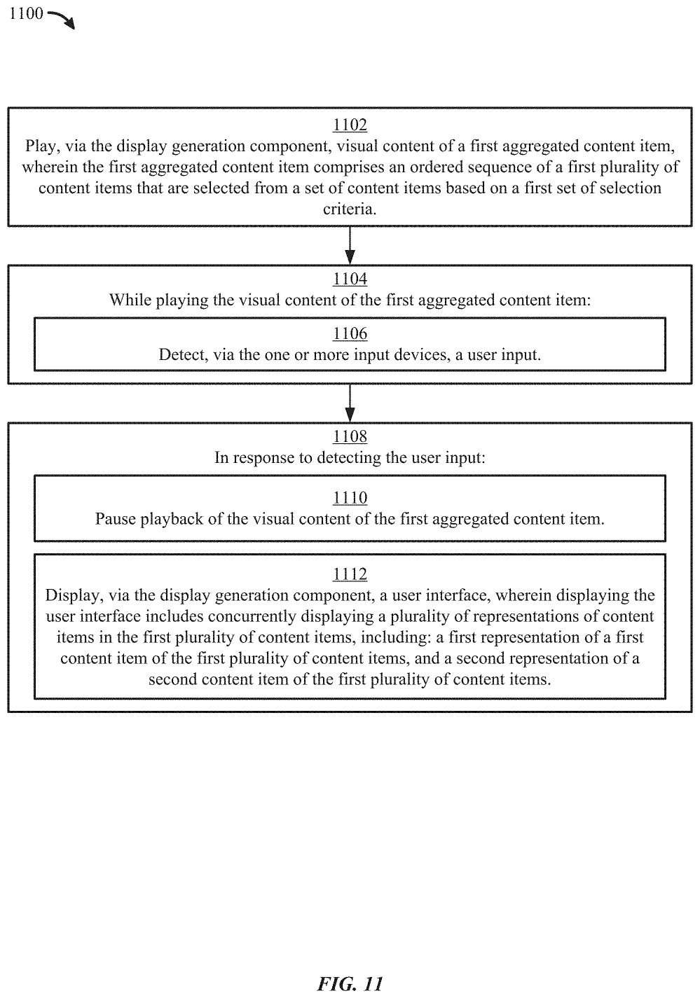

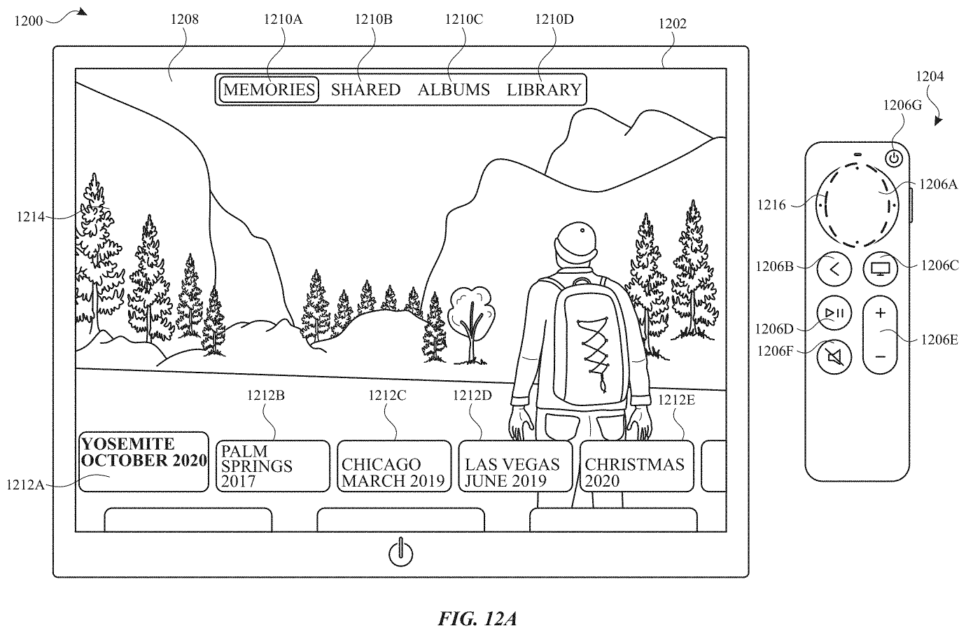

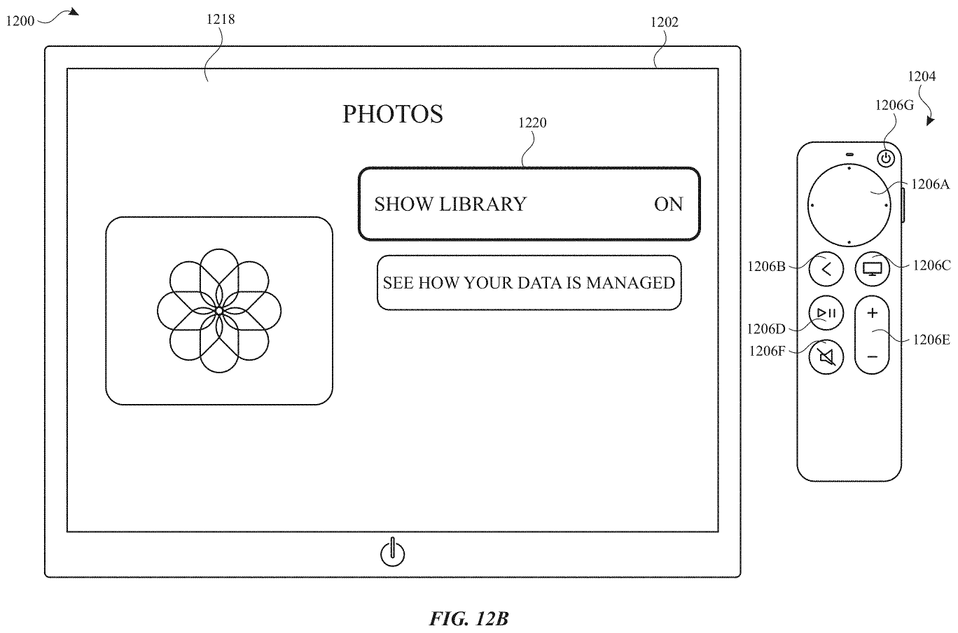

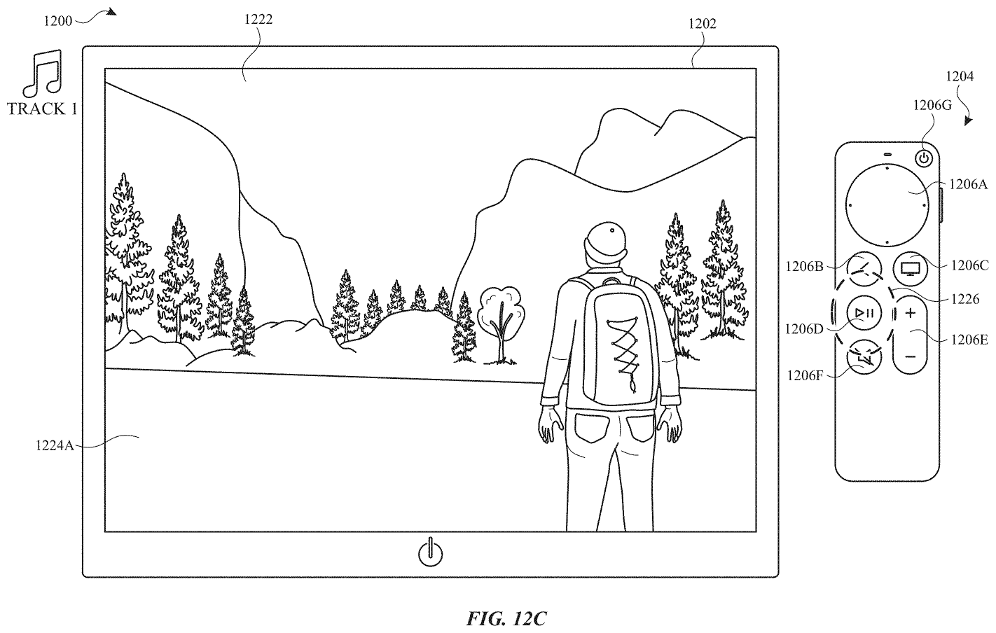

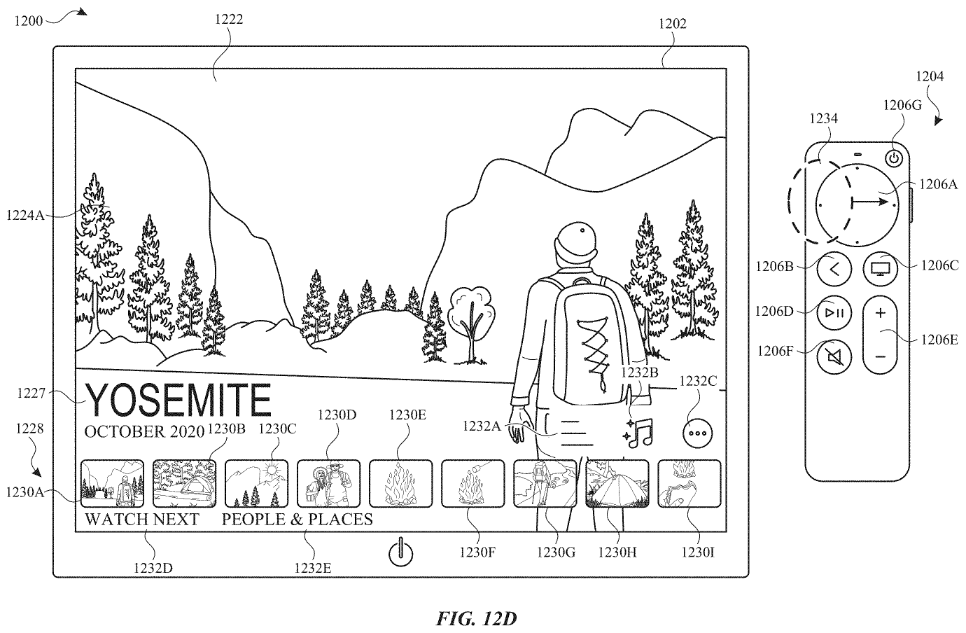

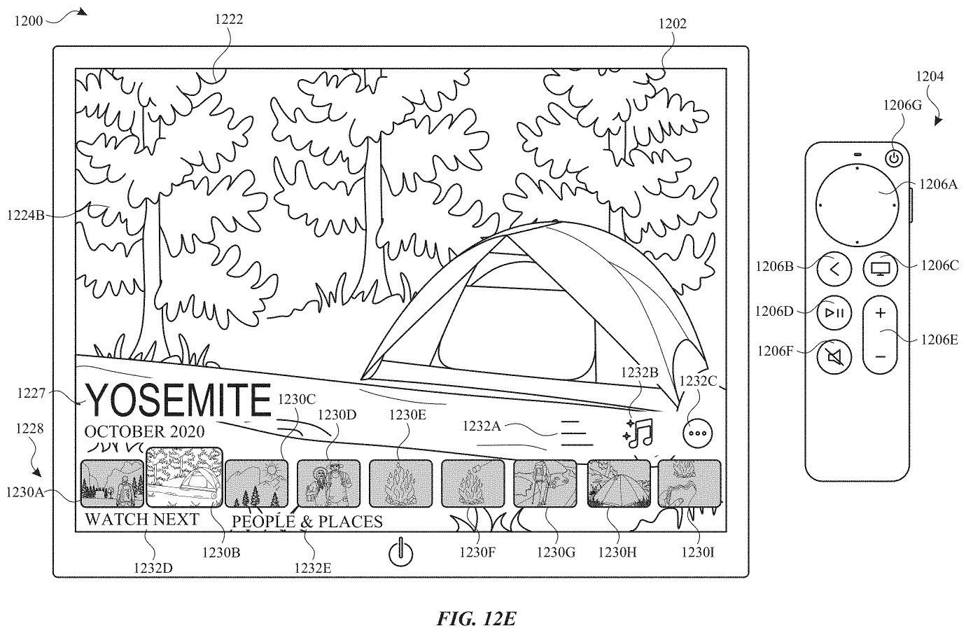

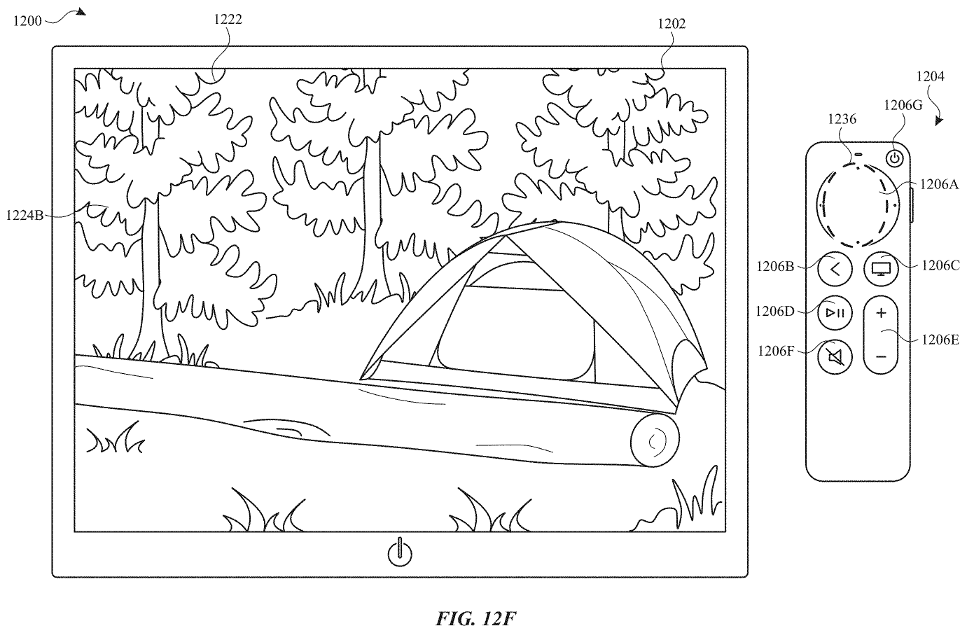

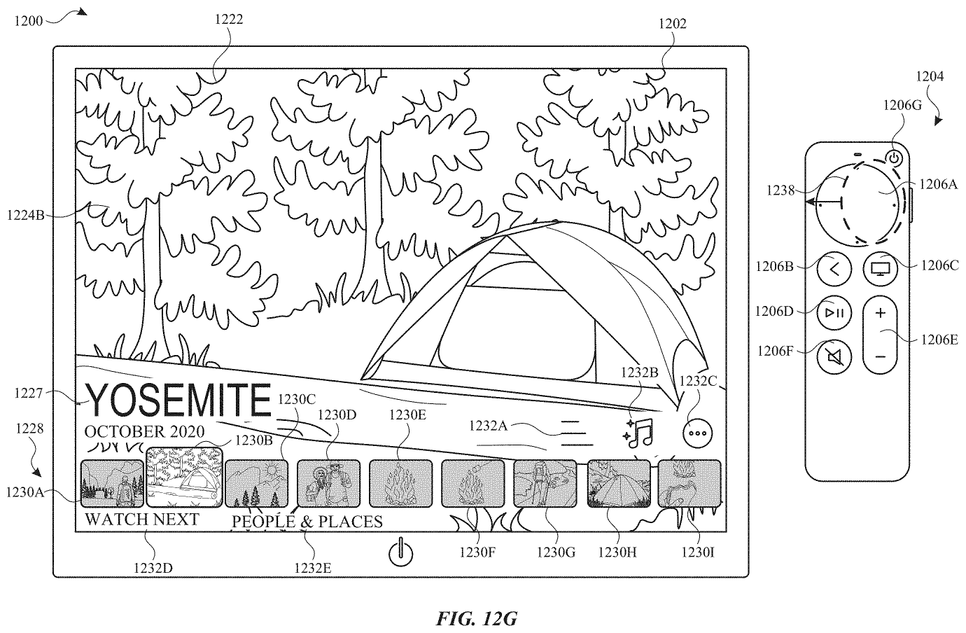

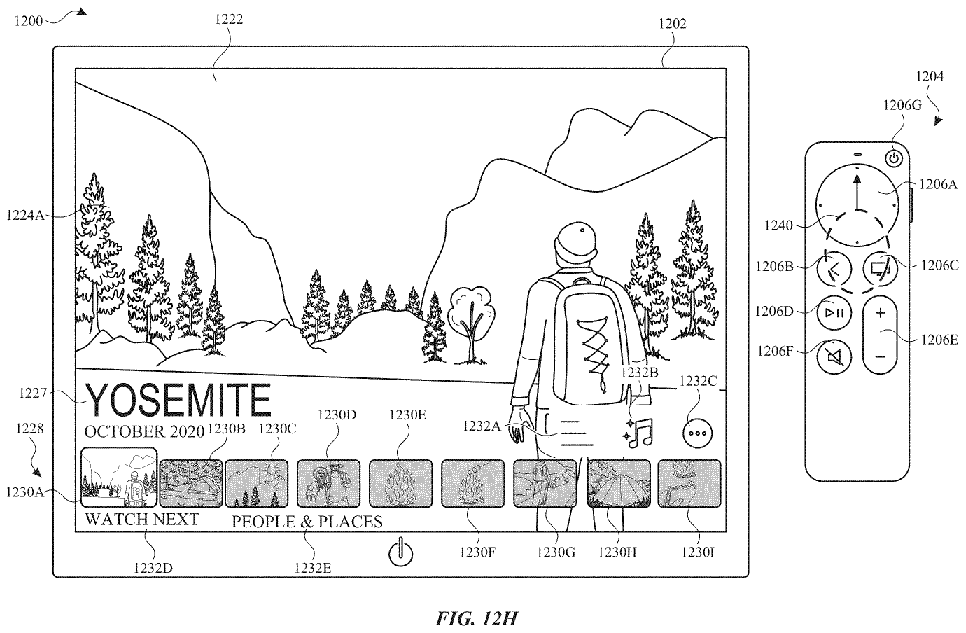

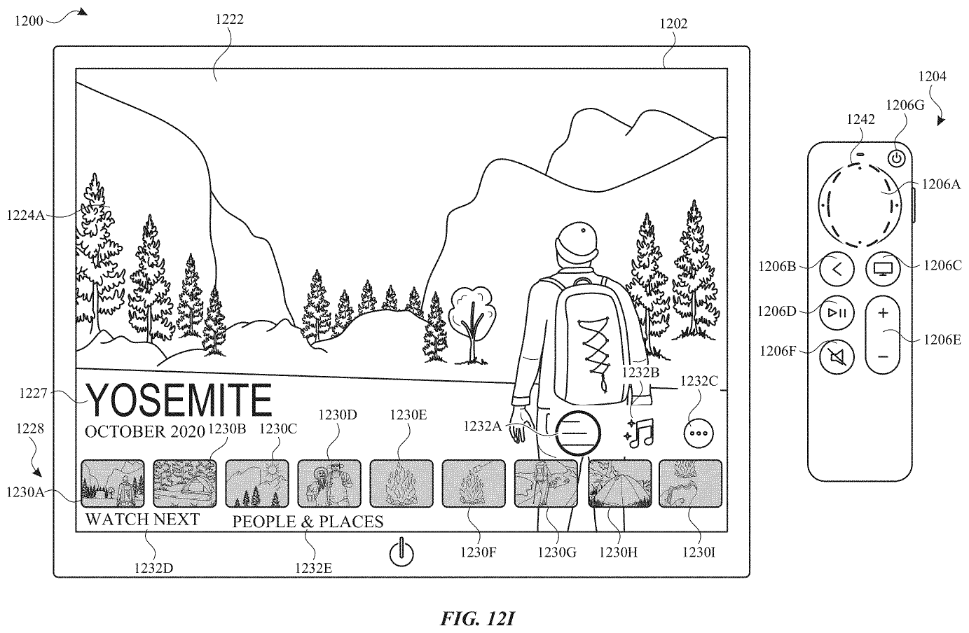

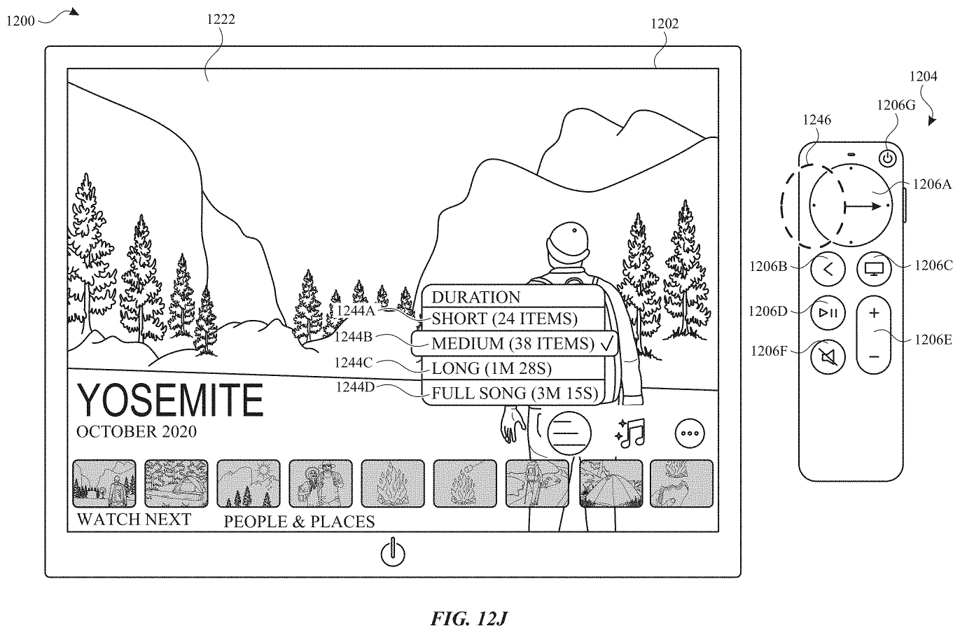

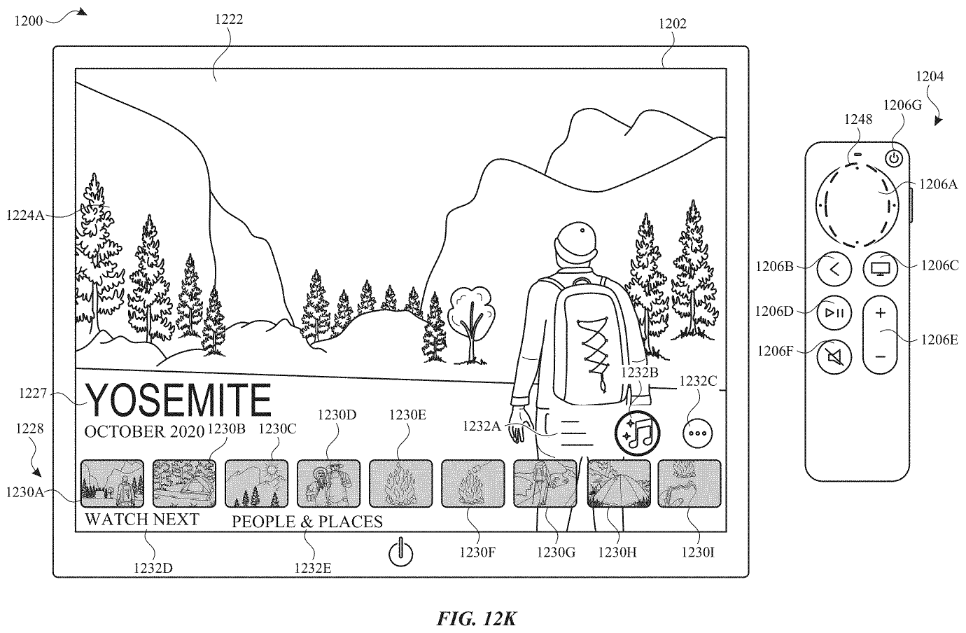

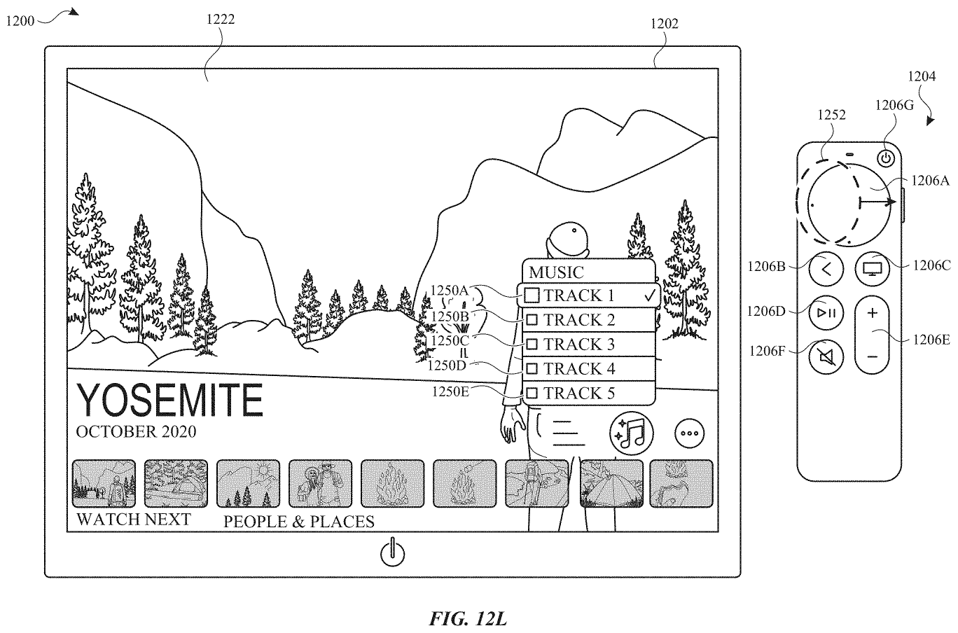

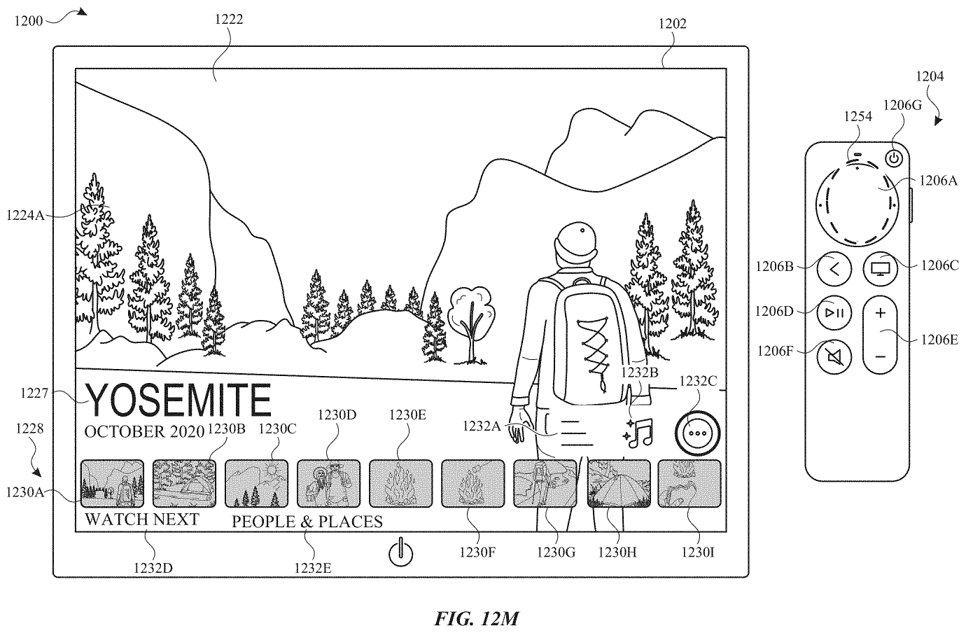

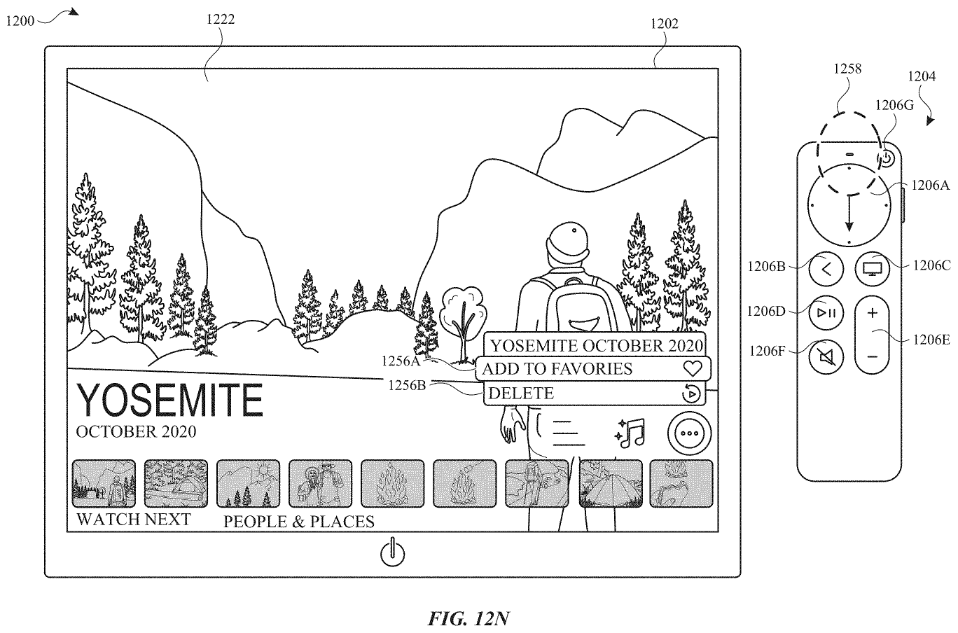

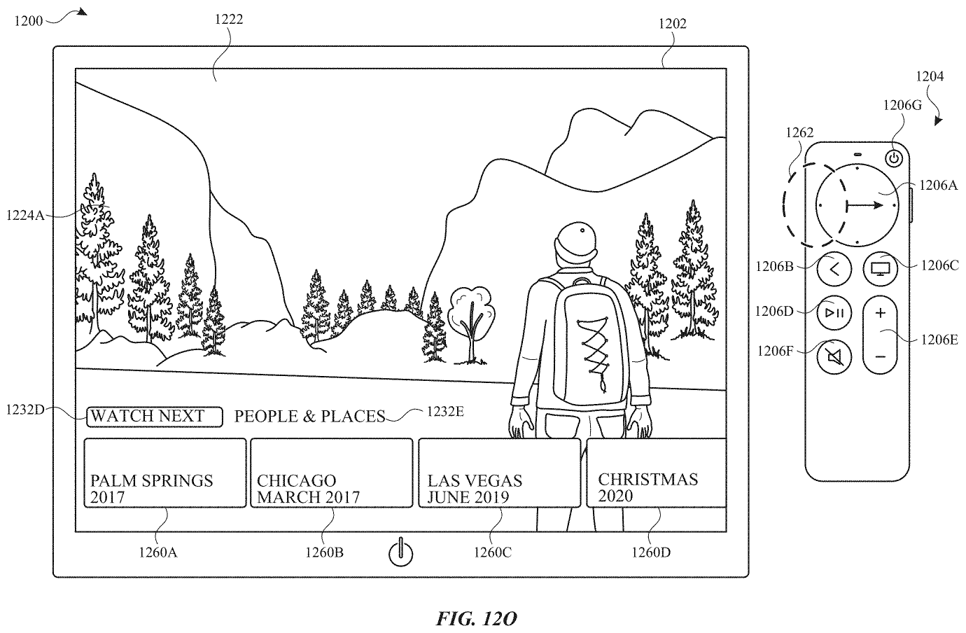

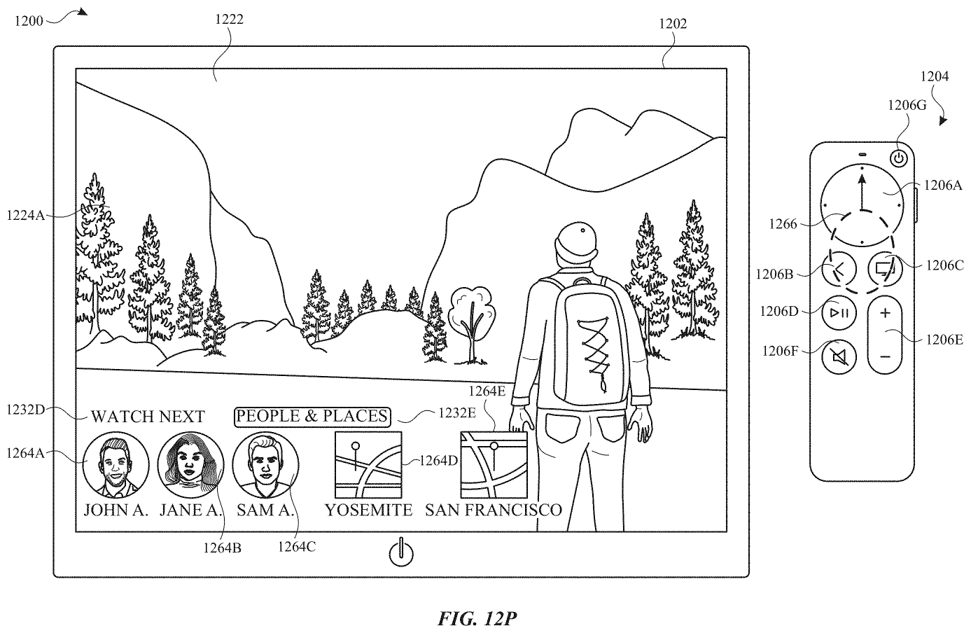

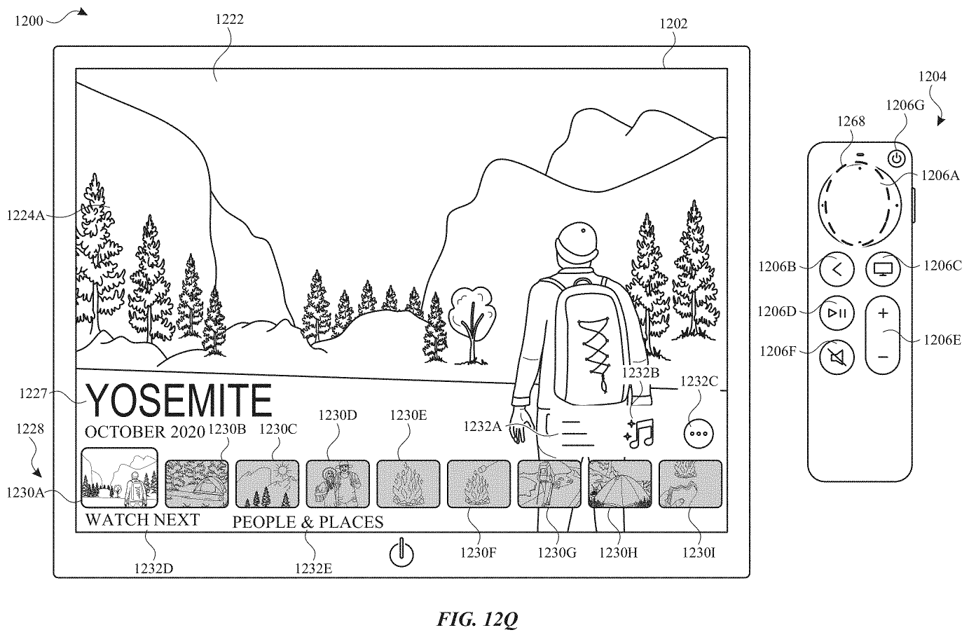

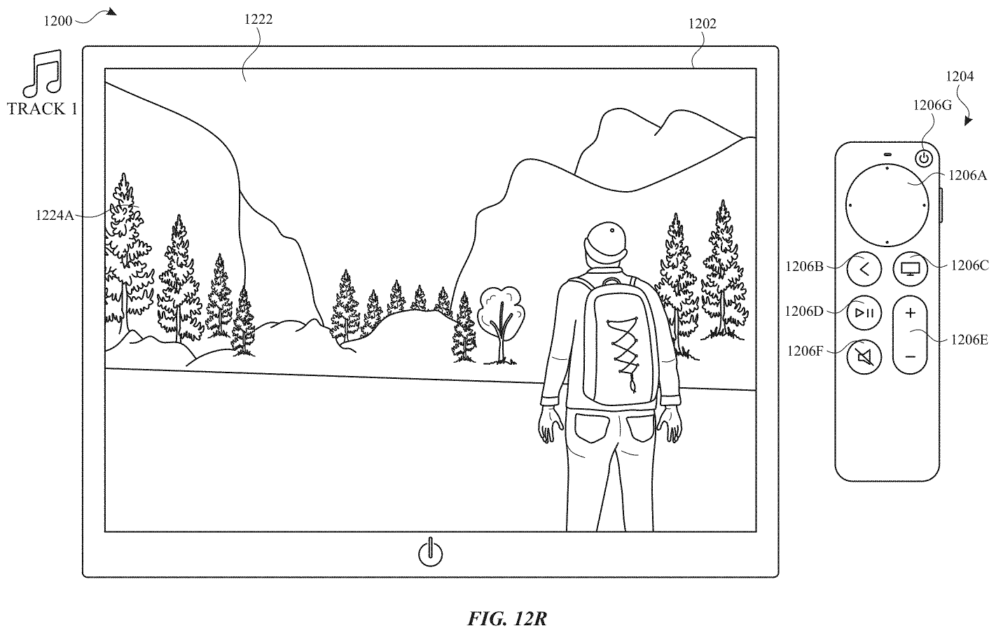

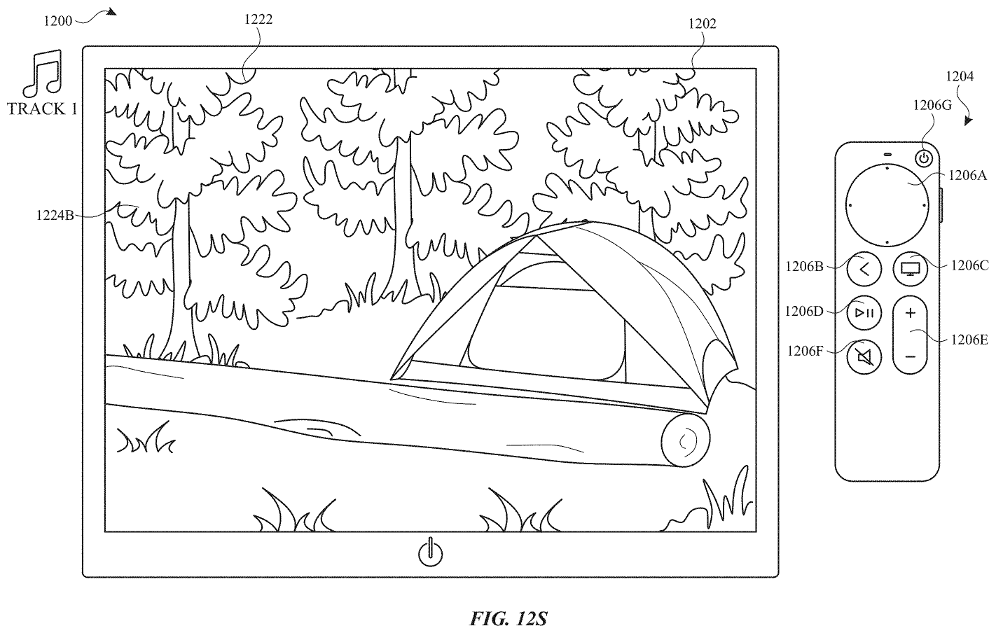

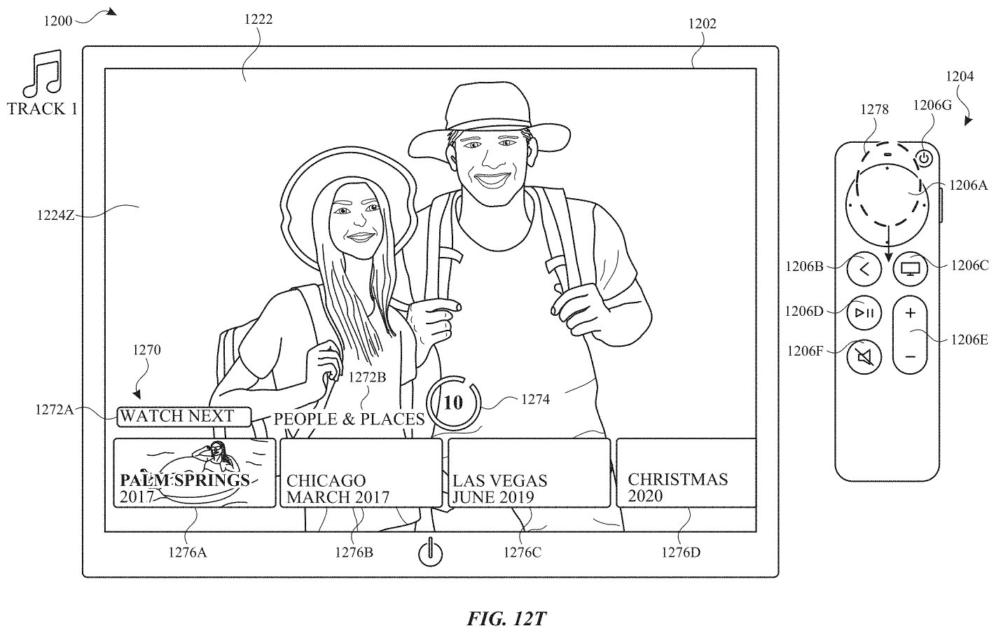

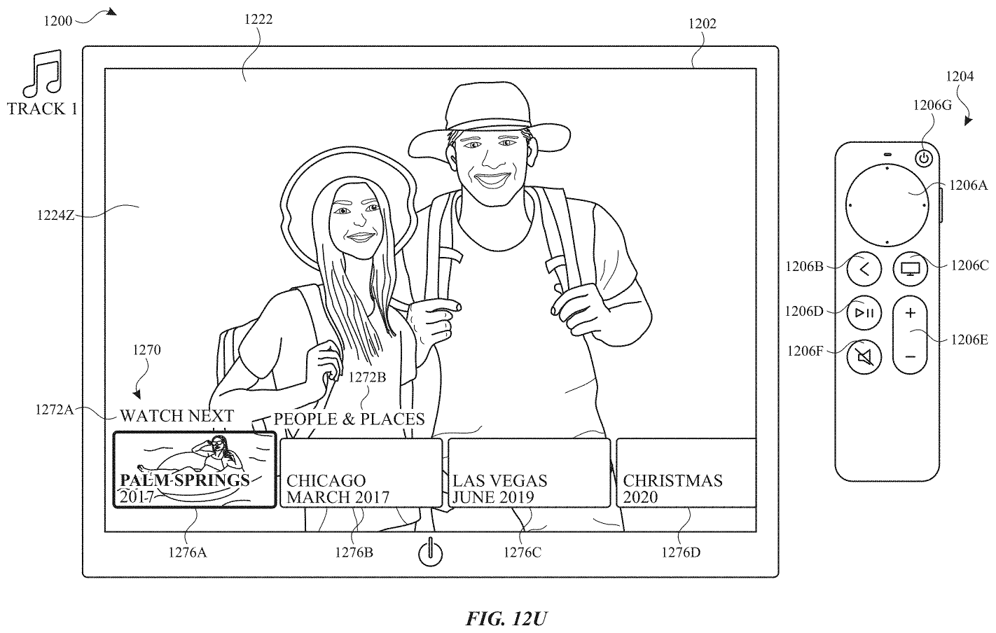

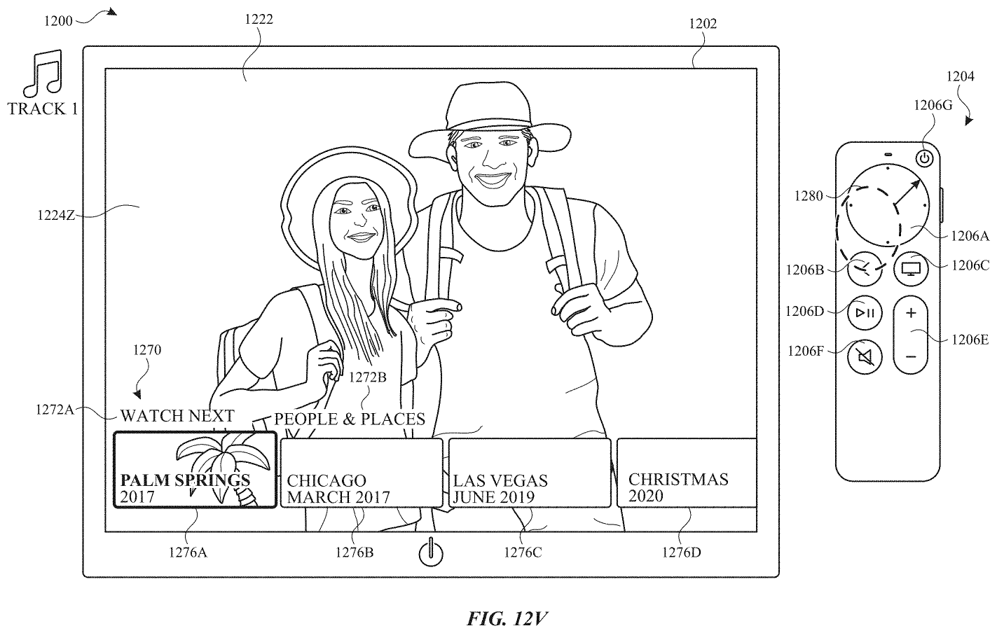

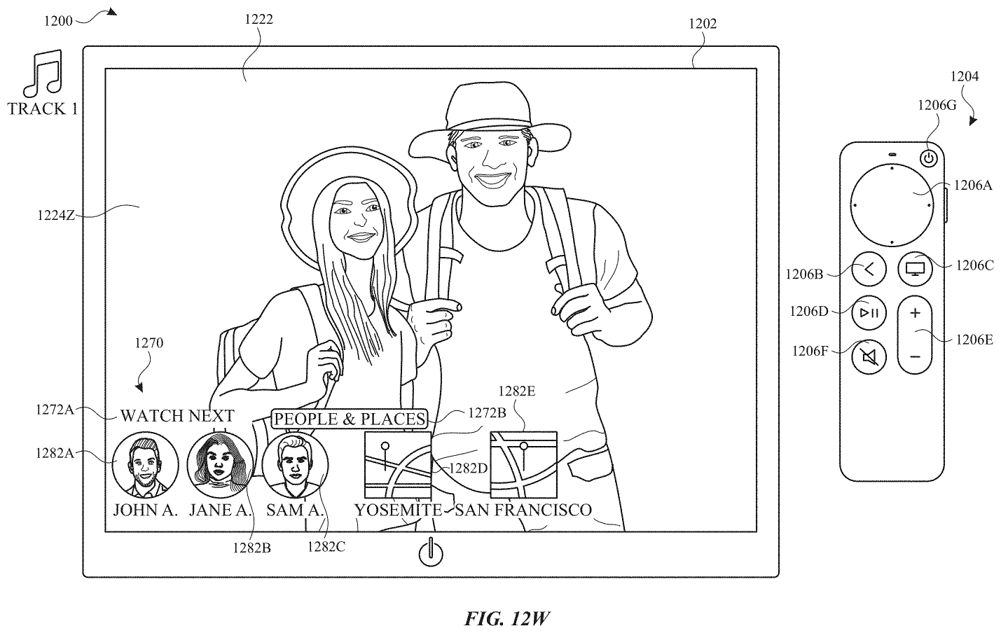

Below, FIGS. 1A-1B, 2, 3, 4A-4B, and 5A-5B provide a description of exemplary devices for performing techniques for viewing, navigating, and editing content items. FIGS. 6A-6AG illustrate exemplary user interfaces for viewing and modifying content items while continuing to play visual content. FIG. 7 is a flow diagram illustrating methods of modifying content items while continuing to play visual content in accordance with some embodiments. The user interfaces in FIGS. 6A-6AG are used to illustrate the processes described below, including the processes in FIG. 7. FIGS. 8A-8L illustrate exemplary user interfaces for managing playing of content after playing content items. FIG. 9 is a flow diagram illustrating methods of managing playing of content after playing content items in accordance with some embodiments. The user interfaces in FIGS. 8A-8L are used to illustrate the processes described below, including the processes in FIG. 9. FIGS. 10A-10S illustrate exemplary user interfaces for viewing representations of content items. FIG. 11 is a flow diagram illustrating methods of viewing representations of content items in accordance with some embodiments. The user interfaces in FIGS. 10A-10S are used to illustrate the processes described below, including the processes in FIG. 11. FIGS. 12A-12W illustrate exemplary user interfaces for viewing, navigating, and editing content items. The user interfaces in FIGS. 12A-12W are used to illustrate the processes described below, including the processes in FIGS. 7, 9, and 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.1 in, and/or IEEE 802.11 ac), voice over Internet Protocol (VoTP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

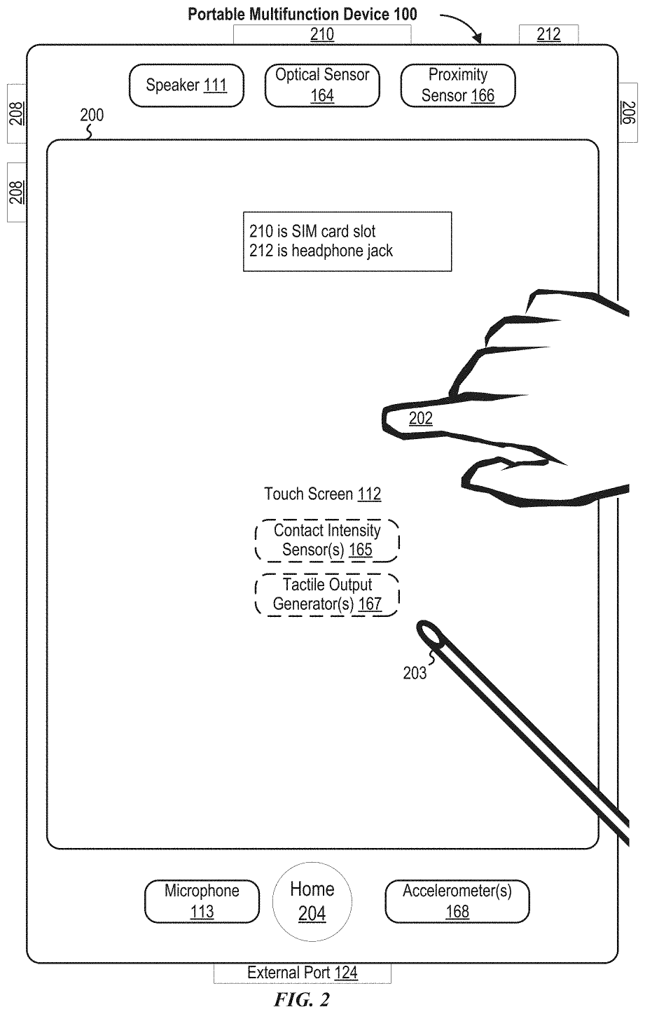

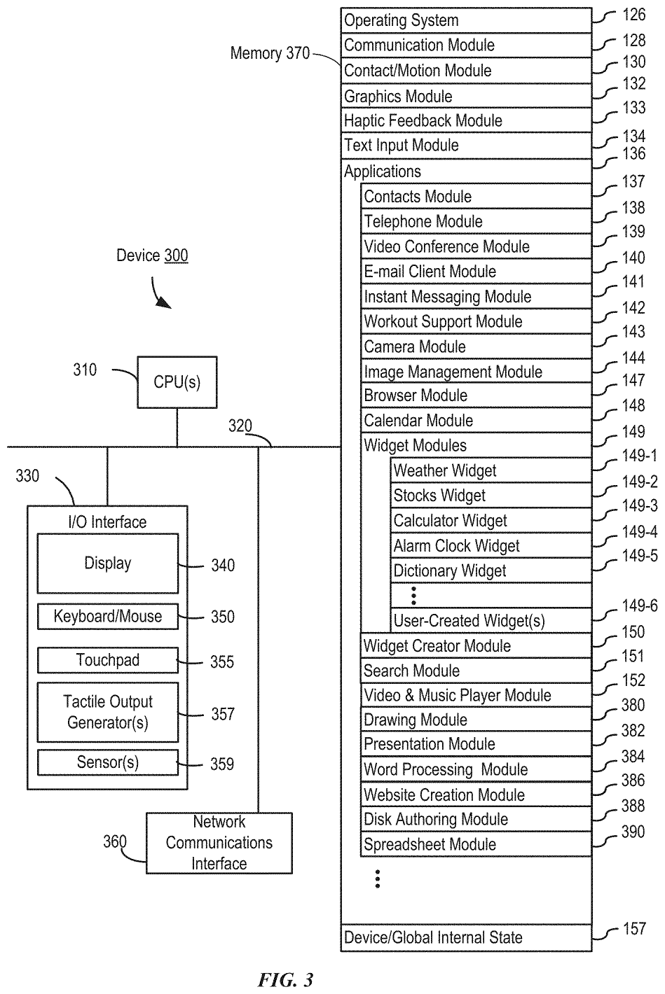

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures) as input. In some embodiments, the one or more input devices are integrated with the computer system. In some embodiments, the one or more input devices are separate from the computer system.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

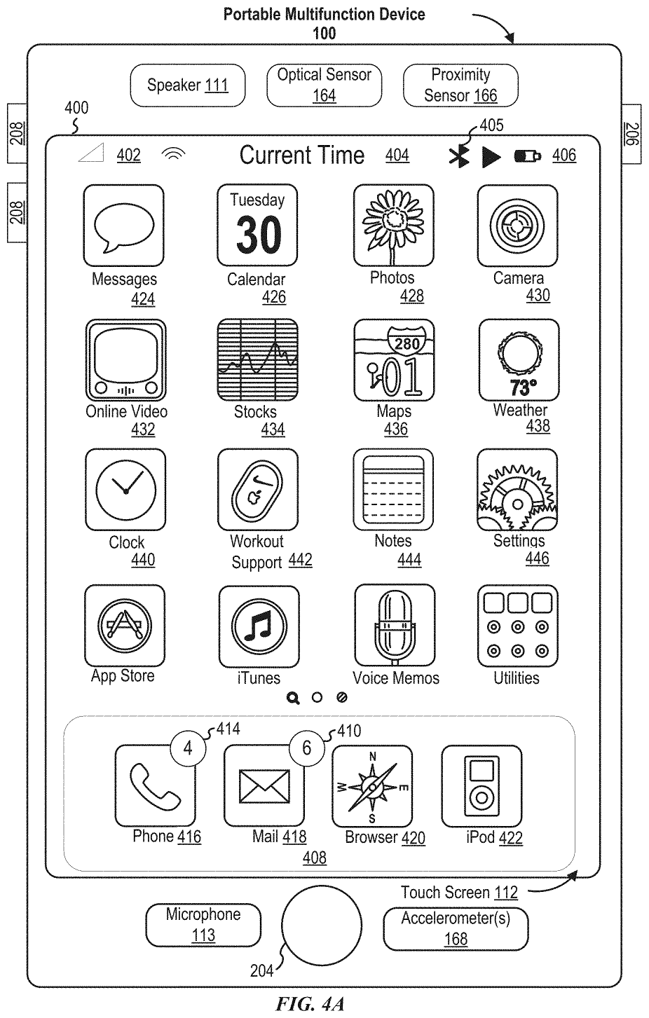

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

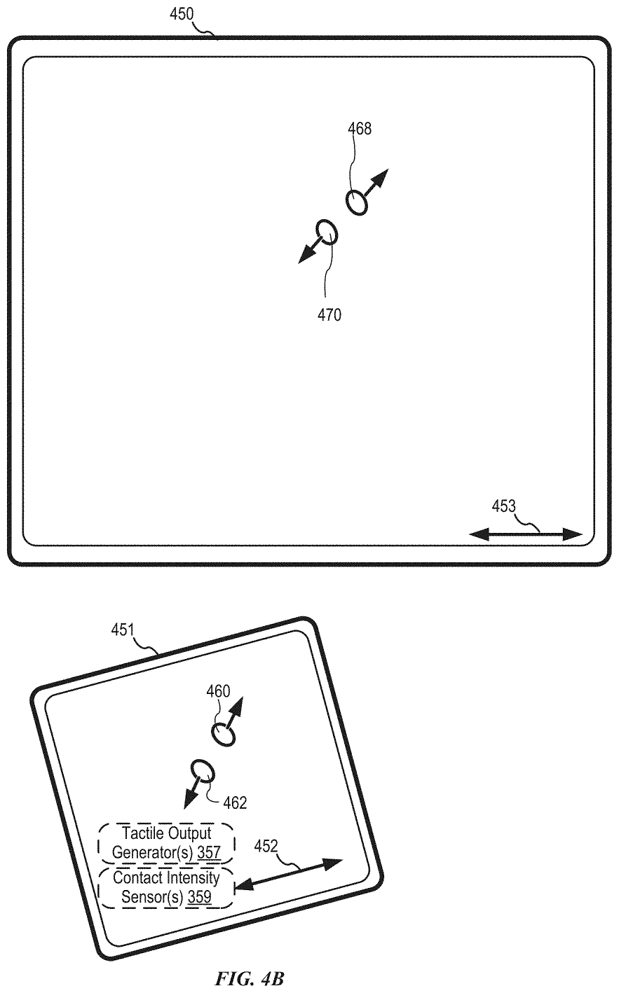

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

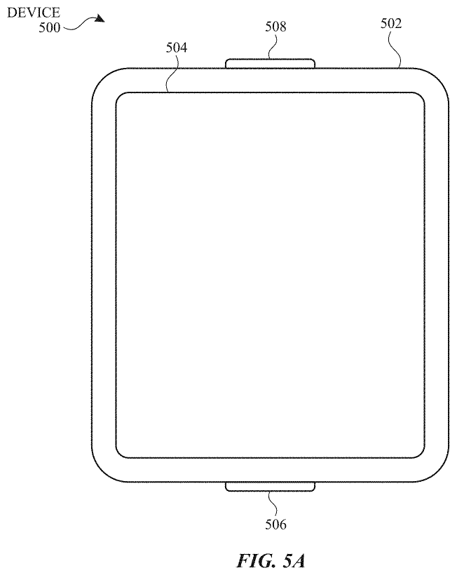

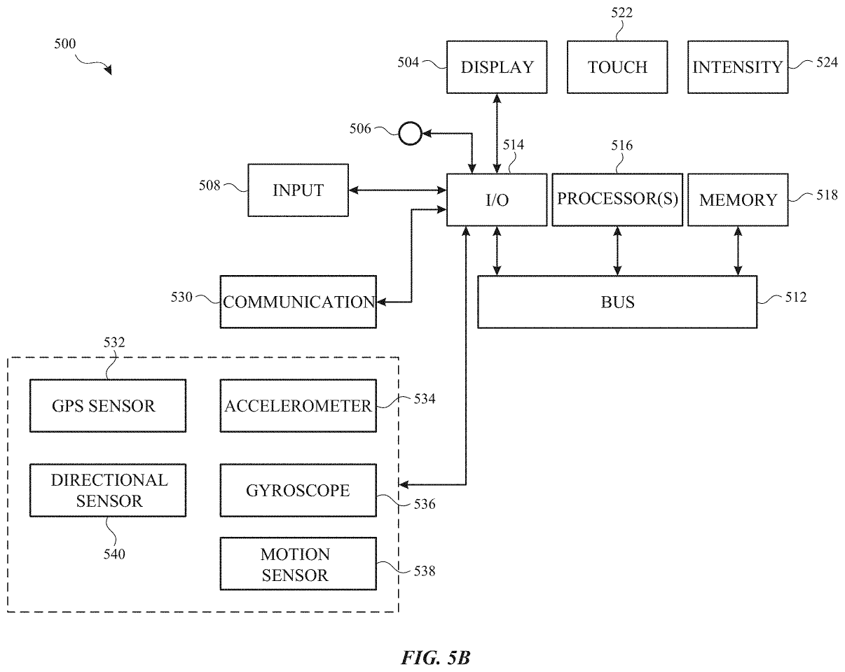

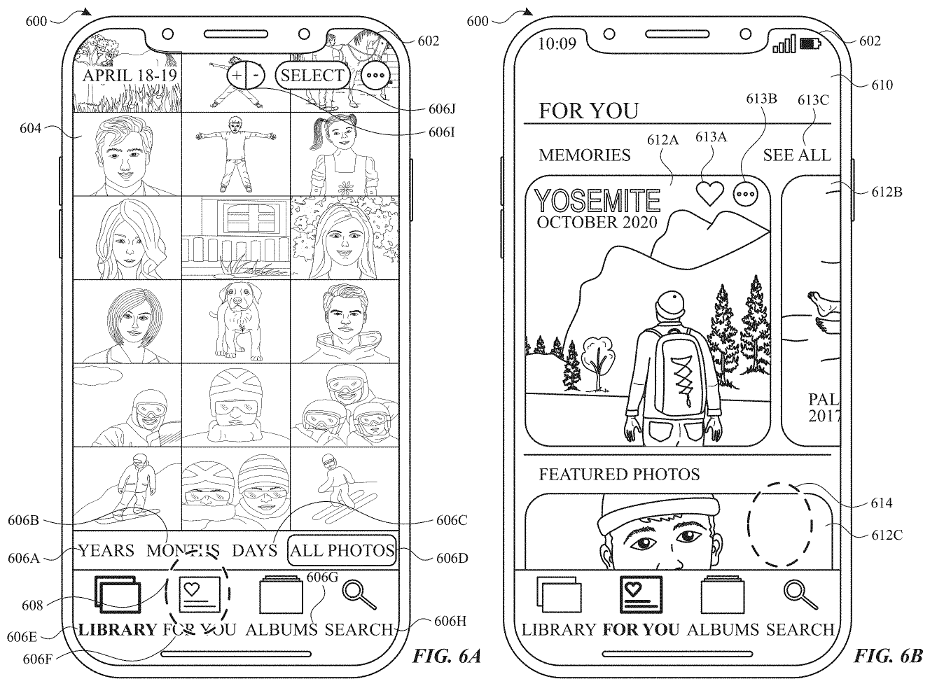

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700-1100 (FIGS. 7, 9, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6AG illustrate exemplary user interfaces for viewing and modifying content items, including aggregated content items, while continuing to play visual content, in accordance with some embodiments. The user interfaces in these figures are used to illustrate the processes described below, including the processes in FIG. 7.

FIG. 6A depicts electronic device 600, which is a smartphone with touch-sensitive display 602. In some embodiments, electronic device 600 includes one or more features of devices 100, 300, and/or 500. Electronic device 600 depicts media library user interface 604. Media library user interface 604 includes a plurality of tiles representative of a plurality of media items (e.g., photos and/or videos) that are part of a media library stored on electronic device 600 and/or otherwise associated with electronic device 600. Media library user interface 604 includes selectable options 606A-606D. Option 606A is selectable to present media items in groups based on the calendar year in which they were captured. Option 606B is selectable to present media items in groups based on the calendar month in which they were captured. Option 606C is selectable to present media items in groups based on the calendar date in which they were captured. Option 606D, which is currently selected in FIG. 6A, is selectable to present all media items in the media library (e.g., sorted based on capture date).

Media library user interface 604 also includes selectable options 606I and 606J. Option 606I is selectable to toggle the aspect ratios at which media items are presented in media library user interface 604. In FIG. 6A, all media items are presented in media library user interface 604 in a square aspect ratio. In some embodiments, if a user selects option 606I, electronic device 600 displays all media items in the media library user interface 604 at a native aspect ratio. Option 606J is selectable to allow a user to select one or more media items presented in media library user interface 604 so that the user can perform one or more operations on the selected media items (e.g., share and/or delete the selected media items).

Media library user interface 604 also includes selectable options 606E-606H. Option 606E is selectable to display media library user interface 604. Option 606F is selectable to display a curated content user interface presenting the user with one or more media items that have been selected and/or curated for the user based on selection criteria. Option 606G is selectable to display one or more collections of media items (e.g., one or more albums). The one or more collections, in various embodiments, include one or more user-defined collections and/or one or more automatically generated collections. Option 606H is selectable to allow a user to search for media items in the media library (e.g., perform a keyword search for media items).

In FIG. 6A, electronic device 600 detects user input 608 corresponding to selection of option 606F. In FIG. 6B, in response to detecting user input 608, electronic device 600 displays curated content user interface 610. Curated content user interface 610 presents one or more media items that have been selected and/or curated for the user based on selection criteria. In the depicted embodiment, curated content user interface 610 includes a plurality of tiles 612A, 612B representative of a plurality of aggregated content items. In some embodiments, an aggregated content item is an automatically generated content item that comprises a plurality of media items (e.g., a plurality of photos and/or videos) that have been selected (e.g., by electronic device 600) from a user's media library based on selection criteria. For example, the plurality of media items chosen for an aggregated content item can include media items that were captured within a particular timeframe and are associated with a particular geographic location (e.g., Yosemite October 2020 in FIG. 6B). In some embodiments, an aggregated content item is initially automatically generated, but can be revised and/or edited by a user and the revised aggregated content item can be saved and stored (as will be described in greater detail herein). In FIG. 6B, aggregated content item tile 612A includes favorite option 613A that is selectable to add the corresponding aggregated content item to a favorites folder, and option 613B that is selectable to display additional options for aggregated content item tile 612A. In some embodiments, tiles 612A, 612B representative of aggregated content items are animated and/or display a preview (e.g., an animated preview, a moving preview, and/or a video preview) of the associated aggregated content item (e.g., playing a preview of a media item with multiple frames or panning and/or zooming a still media item).

Curated content user interface 610 also includes one or more featured media items, including featured media item 612C. Featured media items are media items (e.g., photos and/or videos) from a user's media library that have been selected (e.g., automatically selected) for presentation to the user based on one or more selection criteria. In some embodiments, featured media items presented in curated content user interface 610 change over time (e.g., change from one day to the next, or from one week to the next). In FIG. 6B, while displaying curated content user interface 610, electronic device 600 detects user input 614 (e.g., a tap input or a long press input) corresponding to selection of featured media item 612C.

In FIG. 6C, in response to detecting user input 614, electronic device 600 displays featured media item 612C with a plurality of selectable options 616A-616I. Option 616A is selectable to copy featured media item 612C. Option 616B is selectable to initiate a process for sharing featured media item 612C via one or more communications mediums (e.g., email, text message, NFC, Bluetooth, and/or uploading to a content sharing platform). Option 616C is selectable to favorite featured media item 612C (e.g., add featured media item 612C to a favorites album). Option 616D is selectable to show featured media item 612C within media library user interface 604. Option 616E is selectable to initiate a process for tagging one or more people depicted in featured media item 612C. Option 616F is selectable to cause electronic device 600 to decrease the frequency with which media items depicting the person depicted in featured media item 612C are selected as featured media items (e.g., in curated content user interface 610) and/or decrease the frequency with which media items depicting the person depicted in featured media item 612C are selected for inclusion in aggregated content items. Option 616G is selectable to cause electronic device 600 to cease selecting media items as featured media items (e.g., cease selecting media items for inclusion in curated content user interface 610, and/or cease selecting media items for inclusion in aggregated content items) if the media items depict the person depicted in featured media item 612C. Option 616H is selectable to delete featured media item 612C from the media library. Option 616I is selectable to de-select featured media item 612C as a featured media item (e.g., remove featured media item from curated content user interface 610). In FIG. 6C, electronic device 600 detects user input 618 (e.g., a tap input and/or a non-tap input).

In FIG. 6D, in response to user input 618, electronic device 600 re-displays curated content user interface 610. In FIG. 6D, while displaying curated content user interface 610, electronic device 600 detects user input 620 (e.g., a tap input) corresponding to selection of tile 612A representative of a first aggregated content item (e.g., a Yosemite October 2020 aggregated content item). In the depicted embodiment, the first aggregated content item includes a collection of media items selected from the user's media library that correspond to a particular geographic location (e.g., Yosemite) and a particular time period (e.g., October 2020).

In FIG. 6E, in response to detecting user input 620, electronic device 600 displays aggregated content user interface 622, which corresponds to (e.g., corresponds uniquely to) the first aggregated content item. Aggregated content user interface 622 includes option 624A that is selectable to return to curated content user interface 610. Aggregated content user interface 622 also includes tile 624B that is representative of the first aggregated content item, and is selectable to initiate playback of visual and/or audio content of the first aggregated content item. Aggregated content user interface 622 also includes a plurality of tiles 624C, 624D that are representative of media items that are contained in the first aggregated content item. Tiles 624C, 624D are selectable to view the corresponding individual media item (e.g., without playing the full visual content of the first aggregated content item), and media items contained in the first aggregated content item are represented by respective tiles in the aggregated content user interface 622. In this way, aggregated content user interface 622 allows a user to play the first aggregated content item (e.g., via tile 624B), and also allows a user to view the constituent media items that make up the first aggregated content item. In FIG. 6E, while displaying aggregated content user interface 622, electronic device 600 detects user input 626 (e.g., a tap input) corresponding to selection of tile 624B.

In FIG. 6F, in response to detecting user input 626, electronic device 600 displays playback user interface 625 and initiates playback of the first aggregated content item. In the depicted embodiment, initiating playback of the first aggregated content item includes displaying a first media item in the first aggregated content item, media item 628A, as well as title information 627 corresponding to the first aggregated content item. In the depicted embodiment, initiating playback of the first aggregated content item also includes playing audio content (e.g., an audio track and/or one or more audio tracks). In FIG. 6F, electronic device 600 begins playing audio track 1.

In FIG. 6G, electronic device 600 continues to play the first aggregated content item. Title information 627 has moved from a first position in FIG. 6F to a second position in FIG. 6G, and has changed in one or more other visual characteristics (e.g., changed in size, font, and color). Furthermore, playback of the first aggregated content item from FIG. 6F to FIG. 6G includes zooming in on media item 628A. While displaying playback user interface 625, including media item 628A, and playing audio track 1, electronic device 600 detects user input 630 (e.g., a tap input and/or a non-tap input).

In FIG. 6H, in response to detecting user input 630, electronic device 600 displays a plurality of playback controls and options while continuing to play visual content and audio content of the first aggregated content item. Close option 632A is selectable to cease display of playback user interface 625, and cease playback of visual content and/or audio content of the first aggregated content item (e.g., selectable to re-display aggregated content user interface 622). Share option 632B is selectable to initiate a process for sharing the first aggregated content item via one or more communications mediums. Menu option 632C is selectable to display one or more options, as will be described below. Recipes option 632D is selectable to display a recipes user interface in which a user can modify one or more visual and/or audio characteristics of the first aggregated content item, as will be described in greater detail below. Pause option 632E is selectable to pause playback (e.g., pause visual and/or audio playback) of the first aggregated content item. Grid option 632F is selectable to display a content grid user interface, as will be described in greater detail below with reference to FIGS. 10A-10S. In FIG. 6H, electronic device 600 detects user input 634 corresponding to selection of option 632C.

In FIG. 6I, in response to detecting user input 634, electronic device 600 displays a plurality of options 636A-636H while maintaining playback (e.g., maintaining audio and visual playback) of the first aggregated content item. Option 636A is selectable to add the first aggregated content item to a user's favorite media items (e.g., add the first aggregated content item to a favorites album). Option 636B is selectable to initiate a process for changing title information for the first aggregated content item (e.g., to allow a user to enter a new title for the first aggregated content item). Option 636C is selectable to delete the first aggregated content item. Option 636D is selectable to cause electronic device 600 to modify its selection criteria for generating aggregated content items in the future so that fewer aggregated content items are generated that are similar to the first aggregated content item.

Options 636E-636H correspond to different duration options for the first aggregated content item, and are selectable to modify and/or specify a duration of the first aggregated content item. For example, the first aggregated content item currently has a duration corresponding to option 636F (e.g., a medium duration), and the specified duration is a duration of 38 media items. Option 636E is selectable to shorten the duration of the first aggregated content item by decreasing the number of media items in the first aggregated content item (e.g., from 38 media items to 24 media items). Option 636G is selectable to increase the duration of the first aggregated content item by increasing the number of media items in the first aggregated content item. In the depicted embodiment, option 636G corresponds to a specific time duration (e.g., 1 minute 28 seconds), and the time duration corresponds to a maximum time duration that is allowable for sharing the first aggregated content item. Option 636H is selectable to increase the duration of the first aggregated content item to match a duration of the audio track that has been applied to the first aggregated content item. In FIG. 6I, audio track 1 has been applied to the first aggregated content item, and has a duration of 3 minutes and 15 seconds. Accordingly, selection of option 636H in FIG. 6I will cause the first aggregated content item to be modified (e.g., by adding and/or removing one or more media items, and/or modifying display durations for the media items in the first aggregated content item) to have a total duration of (e.g., approximately) 3 minutes and 15 seconds. However, because this duration is longer than 1 minute and 28 seconds, selection of option 636H would prohibit the first aggregated content item from being shared with other users and/or devices.

In FIG. 6I, electronic device 600 detects user input 638 (e.g., a tap input) corresponding to selection of option 632C. In FIG. 6J, in response to detecting user input 638, electronic device 600 ceases display of options 636A-636H while maintaining playback (e.g., audio and visual playback) of the first aggregated content item. In FIG. 6J, while playing the first aggregated content item, electronic device 600 detects user input 640 (e.g., a tap input) corresponding to selection of recipes option 632D.

In FIG. 6K, in response to detecting user input 640, electronic device 600 displays recipes user interface 642 while maintaining playback (e.g., audio and visual playback) of the first aggregated content item. FIG. 6K depicts electronic device 600 displaying recipes user interface 642 while oriented in both a vertical orientation (left) and a horizontal orientation (right). In recipes user interface 642, playback (e.g., visual and audio playback) of the first aggregated content item is maintained, while allowing a user to apply different combinations of visual characteristics and audio characteristics to the first aggregated content item. For example, in the depicted embodiment, each “recipe” includes a combination of a visual filter and an audio track, and recipes user interface 642 allows a user to switch between these different combinations of visual filters and audio tracks while playback of the first aggregated content item is maintained. In FIG. 6K, there are six different “recipes” or combinations of visual filters and audio tracks that the user can apply to the first aggregated content item. In FIG. 6K, the first aggregated content item is shown with first visual filter 646B and a first audio track (audio track 1) applied. The first visual filter 646B and the first audio track define the first predefined combination (e.g., the first “recipe”). In FIG. 6K, the right side of the first aggregated content item is shown with second visual filter 646C (and not first or third visual filter) applied, to indicate that a user can provide a user input (e.g., a tap input on the right side and/or a swipe left input) to see the first aggregated content item with the second visual filter 646C applied. Similarly, the left side of the first aggregated content item is shown with a third visual filter 646A (and not the first or second visual filter) applied, to indicate that a user can provide a user input (e.g., a tap input on the left side and/or a swipe right input) to see the first aggregated content item with the third visual filter 646A applied.

Recipes user interface 642 includes recipe indication 644A which, in FIG. 6K, indicates that a first visual filter/audio track combination out of six visual filter/audio track combinations is currently applied to the first aggregated content item. Recipe user interface 642 also includes audio track indication 644B indicating that audio track 1 (by artist 1) is currently applied to the first aggregated content item. Recipe user interface 642 also includes audio track selection option 644C, that is selectable to display an audio track selection user interface, and a visual filter option 644D, that is selectable to display a visual filter selection user interface. In FIG. 6K, electronic device 600 detects user input 648, which is a swipe left gesture.

In FIG. 6L, in response to detecting user input 648, electronic device 600 shifts visual filters 646A, 646B, 646C to the left based on user input 648 (e.g., translating at a speed and for a translation distance that corresponds to the speed and translation distance of the user input). Accordingly, in FIG. 6L, visual filter 646A is no longer visible, visual filter 646B is shown applied to a left side of media item 628A, and visual filter 646C is shown applied to a right side of media item 628A. During this user input, playback of the first aggregated content item is maintained by electronic device 600 (e.g., electronic device 600 continues to play visual content of the first aggregated content item, and continues to play audio track 1). In FIG. 6L, electronic device 600 continues to detect the swipe left gesture of user input 648.

In FIG. 6M, in response to the continuation of user input 648, electronic device 600 continues to shift visual filters 646B and 646C, such that visual filter 646B now occupies a small portion of the left side of media item 628A, and visual filter 646C is applied to the majority of media item 628A. In FIG. 6M, in response to user input 648 surpassing a threshold translation distance, electronic device 600 updates recipe indication 644A to indicate that a second recipe (e.g., a second visual filter/audio track combination) has been applied to the first aggregated content item. Furthermore, in response to user input 648 surpassing the threshold translation distance, electronic device 600 ceases playing audio track 1 (which was part of the first recipe (e.g., the first predefined visual filter/audio track combination)), and begins playing audio track 2 (which is part of the second recipe (e.g., the second predefined visual filter/audio track combination)). In some embodiments, when switching between different visual filter/audio track combinations, electronic device 600 does not begin playing audio track 2 from the beginning of audio track 2, but rather from a playback position corresponding to the playback progress of the first aggregated content item. For example, in FIG. 6M, if the first aggregated content item has been playing for 40 seconds, electronic device 600 can begin playing audio track 2 from the 40 second mark. In FIG. 6M, electronic device 600 continues to detect the swipe left gesture of user input 648.

In FIG. 6N, in response to the continuation of user input 648, electronic device 600 continues to shift visual filters 646B and 646C. In FIG. 6N, visual filter 646B is applied to a leftmost region of the visual content of the first aggregated content item (e.g., currently displaying media item 628A), visual filter 646C is applied to a central region of the visual content of the first aggregated content item, and a fourth visual filter 646D (corresponding to a third visual filter/audio track combination) is applied to a rightmost region of the visual content of the first aggregated content item. Electronic device 600 continues to maintain playback (e.g., visual and/or audio playback) of the first aggregated content item.

In FIG. 6O, due to the continued playback of the first aggregated content item, electronic device 600 no longer displays media item 628A, and now displays a second media item 628B of the first aggregated content item while continuing to play audio track 2. In FIG. 6O, electronic device 600 is depicted as detecting (at separate times and/or non-concurrently) two different user inputs 650A, 650B. User input 650B, a swipe left gesture, would cause electronic device 600 to apply a third recipe (e.g., a third pre-defined combination of visual filter 646D and a third audio track) to the first aggregated content item. User input 650A, a swipe right gesture, would cause electronic device to re-apply the first recipe of the first audio track and visual filter 646B.

In FIG. 6P, in response to detecting user input 650A, electronic device 600 shifts visual filters 646D, 646C, and 646B to the right based on user input 650A (e.g., translating at a speed and for a translation distance that corresponds to the speed and translation distance of the user input). In FIG. 6P, electronic device 600 continues to detect swipe right gesture user input 650A.

In FIG. 6Q, in response to the continuation of user input 650A, electronic device 600 continues to shift visual filters 646B and 646C. In FIG. 6Q, based on a determination that user input 650A has surpassed a threshold translation distance, electronic device 600 updates recipe indication 644A to indicate that a first recipe has been applied to the first aggregated content item, ceases playing audio track 2, and again plays audio track 1. As discussed above, in some embodiments, audio track 1 is not played from the beginning of audio track 1 (e.g., is played from a playback position corresponding to a playback position of the first aggregated content item).

As discussed above, and demonstrated in the figures, when a user swipes between different recipes in the recipe user interface 642, a user can switch between combinations of visual filters and audio tracks to be applied to the first aggregated content item. In some embodiments, in addition to changing the visual filter and the audio track that is applied to the first aggregated content item, when a user swipes between different recipes (e.g., different combinations of visual filters and audio tracks), electronic device 600 also changes other audio and/or visual characteristics of playback of the first aggregated content item, such as the types of visual transitions that are applied between media items presented during playback of the first aggregated content item. For example, a first recipe (e.g., a first visual filter/audio track combination) can utilize a first set of visual translations (e.g., fade in, fade out), while a second recipe can utilize a second set of visual translations different from the first set (e.g., swipe in, swipe out). In some embodiments, visual transitions applied between media items are selected based on audio characteristics of an audio track that is part of the applied visual filter/audio track combination. For example, higher energy or faster audio tracks (e.g., audio tracks with a beats-per-minute value that exceed a threshold) can utilize a first set of visual transitions, while lower energy or slower audio tracks (e.g., audio tracks with a beats-per-minute value below the threshold) can utilize a second set of visual transitions.

In FIG. 6Q, electronic device 600 detects user input 652 (e.g., a tap input) corresponding to selection of audio track selection option 644C. In FIG. 6R, in response to detecting user input 652, electronic device 600 displays audio track selection user interface 654. In some embodiments, while displaying audio track selection user interface 654, electronic device 600 maintains playback (e.g., visual and/or audio playback) of the first aggregated content item (e.g., in the background). In some embodiments, while displaying audio track selection user interface 654, electronic device 600 pauses playback (e.g., visual and/or audio playback) of the first aggregated content item. Audio track selection user interface 654 includes a cancel option 658A, that is selectable to return to recipes user interface 642 (e.g., without changing an audio track that is applied to the first aggregated content item), a done option 658B that is selectable to apply a selected audio track to the first aggregated content item, and a search option 658C that is selectable to search for audio tracks within a music catalog. Audio track selection user interface 654 also includes a plurality of selectable options 656A-656N corresponding to different audio tracks. A user can select a respective option to apply a respective corresponding audio track to the first aggregated content item (e.g., have the selected audio track play while visual content of the first aggregated content item is played). In some embodiments, selection of an option 656A-656N replaces the audio track in the recipe (e.g., the visual filter/audio track combination) that is currently applied to the first aggregated content item (e.g., that was applied to the first aggregated content item when user input 652 was detected) with the selected audio track. For example, in FIG. 6R, the first recipe is currently a combination of audio track 1 and visual filter 646B, but selection of a different audio track in audio track selection user interface 654 would modify the first recipe to be a combination of the selected audio track and visual filter 646B (e.g., without audio track 1). In FIG. 6R, audio track selection user interface indicates that Track 1 by Artist 1 is currently applied to the first aggregated content item. In FIG. 6R, electronic device 600 detects user input 660 corresponding to selection of option 656D, which corresponds to audio track 3 by Artist 3.

FIG. 6S illustrates a first example scenario, in which electronic device 600 is not authorized to apply the selected audio track to the first aggregated content item. For example, the user of electronic device 600 is not subscribed to a music subscription service, and does not have access rights to the selected audio track. In FIG. 6S, in response to detecting user input 660, and in accordance with a determination that electronic device 600 is not authorized to apply the selected audio track to the first aggregated content item (e.g., in accordance with a determination that the user is not subscribed to the music subscription service), electronic device 600 displays music preview user interface 662. Music preview user interface 662 provides a user with a preview of the selected audio track applied to the first aggregated content item, and displays visual playback of the first aggregated content item while the selected audio track plays. Music preview user interface 662 also allows a user to swipe between different visual filter options (e.g., 646A, 646B, 646C) while visual content of the first aggregated content item is played and the selected audio track is played. However, the user can only view the preview within the preview user interface 662, and the user cannot save and/or share the first aggregated content item (e.g., the user is not provided with options to save or share the first aggregated content item) with the selected audio track applied. The user can select either cancel option 664A, to cancel selection of the audio track and return to the audio track selection user interface 654, or free trial option 664B that is selectable to initiate a process for registering the user for a free trial of a music subscription service so that the user can apply the selected audio track to the first aggregated content item.

FIG. 6T illustrates a second example scenario, in which electronic device 600 is authorized to apply the selected audio track to the first aggregated content item. In FIG. 6T, audio track selection user interface 654 indicates that Track 3 has been selected, and electronic device 600 plays audio track 3. In some embodiments, whereas swiping through different recipes in recipes user interface 642 will cause various audio tracks to play from different playback positions based on a current playback position of the first aggregated content item (e.g., will cause various audio tracks to play from a playback position that is not a beginning of the audio tracks), selection of an audio track in audio track selection user interface 654 causes the selected audio track to play from the beginning. In FIG. 6T, electronic device 600 detects user input 666 corresponding to selection of done option 658B.

In FIG. 6U, in response to detecting user input 666, electronic device 600 re-displays recipes user interface 642. As was the case in FIG. 6Q, recipes user interface 642 displays playback of the first aggregated content item with a first recipe applied to the first aggregated content item (e.g., recipe indicator 644A indicates “Recipe 1 of 6”, and visual filter 646B is applied to the first aggregated content item). However, due to the user's selection of audio track 3 in audio track selection user interface 654, audio track 1 has been replaced by audio track 3 in the first recipe (e.g., in the first visual filter/audio track combination), such that audio track 3 is applied to the first aggregated content item while visual content of the first aggregated content item is played with visual filter 646B applied. In FIG. 6U, electronic device 600 detects user input 668 (e.g., a tap input) corresponding to selection of visual filter selection option 644D.

In FIG. 6V, in response to detecting user input 668, electronic device 600 displays visual filter selection user interface 670. Visual filter selection user interface 670 includes a plurality of tiles 674A-6740, with different tiles corresponding to different visual filters. Furthermore, the different tiles display continued playback of visual content of the first aggregated content item with respective visual filters applied to the visual content of the first aggregated content item. Visual filter selection user interface 670 also includes cancel option 672A, that is selectable to return to recipes user interface 642 (e.g., without applying a different visual filter), and done option 672B that is selectable to apply a selected visual filter to the first aggregated content item. In some embodiments, selection and/or application of a different visual filter within visual filter selection user interface 670 causes a visual filter in a currently applied recipe to be replaced with the selected visual filter.

As noted above, while displaying visual filter selection user interface 670, electronic device 600 maintains playback (e.g., audio and visual playback) of the first aggregated content item, and different ones of tiles 674A-6740 depict playback of the visual content of the first aggregated content item with a different visual filter applied. In FIG. 6W, visual content of the first aggregated content item continues to play, such that visual content of the first aggregated content transitions from displaying media item 628B in FIG. 6V to displaying media item 628C in FIG. 6W. In FIG. 6W, electronic device 600 detects user input 676 (e.g., tap input) corresponding to selection of done option 674B.

In FIG. 6X, in response to detecting user input 676, electronic device 600 ceases displaying visual filter selection user interface 672, and re-displays recipes user interface 642, while maintaining playback (e.g., audio and/or visual playback) of the first aggregated content item. As noted above, while displaying visual filter selection user interface 672, playback of the visual content of the first aggregated content item transitioned from media item 628B to media item 628C. Accordingly, electronic device 600 now displays media item 628C within recipes user interface 642. In FIG. 6X, electronic device 600 detects user input 678 (e.g., a tap input) corresponding to selection of the first recipe (e.g., the first visual filter/audio track combination) that is currently applied to the first aggregated content item in FIG. 6X.

In FIG. 6Y, in response to detecting user input 678, electronic device 600 ceases display of recipes user interface 642, and displays continued playback of the first aggregated content item within playback user interface 625. Furthermore, in FIG. 6Y, electronic device 600 updates title information 627 to present title information that corresponds to the currently presented media item 628C (e.g., changing the title information from “YELLOWSTONE OCTOBER 2020” to “HALF DOME OCTOBER 2020”). At FIG. 6Y, electronic device 600 detects user input 680 (e.g., a tap input) corresponding to selection of pause option 632E.

In FIG. 6Z, in response to detecting user input 680, electronic device 600 pauses playback (e.g., pauses audio and/or visual playback) of the first aggregated content item. In response to detecting user input 680, electronic device 600 also displays navigation object 682 (e.g., a scrubber). Navigation object 682 comprises representations of different media items in the aggregated content item, arranged in the order they will be presented in the aggregated content item, so that a user can navigate through the various media items while playback of the aggregated content item is paused. In FIG. 6Z, navigation object 682 indicates that electronic device 600 is currently displaying a third media item in the first aggregated content item. Furthermore, in response to user input 680, electronic device 600 replaces pause option 632E with play option 632H, and replaces recipes option 632D with aspect ratio option 632G. Play option 632H is selectable to resume playback (e.g., resume audio and/or visual playback of the first aggregated content item). Aspect ratio option 632G is selectable to switch display of a displayed media item between a full screen aspect ratio and a native aspect ratio. In FIG. 6Z, electronic device 600 detects user input 683 (e.g., a tap input) corresponding to selection of aspect ratio option 632G.

In FIG. 6AA, in response to detecting user input 683, electronic device 600 ceases displaying media item 628C in a full screen aspect ratio, and now displays media item 628C in a native aspect ratio. In FIG. 6AA, playback of the first aggregated content item remains paused. In FIG. 6AA, electronic device 600 detects user input 684 (e.g., a tap input) corresponding to selection of play option 632H.

In FIG. 6AB, in response to detecting user input 684, electronic device 600 reverts display of media item 628C to the full screen aspect ratio, and resumes playback of the first aggregated content item. Furthermore, in response to user input 684, electronic device replaces aspect ratio option 632G with recipes option 632D, and play option 632H with pause option 632E. In FIG. 6AB, while playing visual content of the aggregated content item and playing audio track 3, electronic device 600 detects tap and hold input 686, which is a sustained tap input (e.g., tap and hold input for a duration of time). In FIGS. 6AB and 6AC, in response to detecting tap and hold input 686 (and while continuing to detect tap and hold input 686), electronic device 600 maintains display (e.g., maintains continued display and/or pauses visual playback while maintaining display) of media item 628C while continuing to play audio track 3. In the depicted scenario, without any user input, electronic device would have moved onto displaying a subsequent media item as part of playback of the first aggregated content item, but tap and hold input 686 causes electronic device 600 to maintain display of media item 628C while continuing to play audio track 3 (e.g., for as long as tap and hold input 686 is detected).

In FIG. 6AC, after termination of tap and hold input 686 (e.g., detecting liftoff of the input from the touch-sensitive surface of the display), electronic device detects user input 688, which is a tap input on a left side of display 602. In the depicted embodiment, a tap input on the left side of display 602 (e.g., in a predefined region proximate the left edge of display 602) causes navigation to a previous media item in the first aggregated content item (e.g., while continuing to play and/or progress playback of the first aggregated content item and/or maintaining playback of the audio track), and a tap input on the right side of display 602 (e.g., in a predefined region proximate the right edge of display 602) causes navigation to a subsequent media item in the first aggregated content item (e.g., while maintaining playback of the first aggregated content item and/or maintaining playback of the audio track). In some embodiments, user input 688 is a swipe input (e.g., swipe right) rather than a tap input.

In FIG. 6AD, in response to detecting user input 688, electronic device 600 ceases displaying media item 628C, and displays previous media item 628B. In FIG. 6AD, while displaying media item 628B, and while maintaining playback of the first aggregated content item and playback of audio track 3, electronic device 600 detects user input 690, which is a tap input on the right side of display 602. In some embodiments, input 690 is a swipe input (e.g., swipe left) rather than a tap input.

In FIG. 6AE, in response to detecting user input 690, electronic device 600 ceases displaying media item 628B, and displays subsequent media item 628C. The user inputs depicted in FIGS. 6AB, 6AC, and 6AD disrupted normal playback of the first aggregated content item. While the first aggregated content item continued to played through each of these figures (and audio track 3 continued to be played through each of these figures), user inputs 686, 688, 690 caused playback of the visual content of the first aggregated content item to be altered in some way (e.g., maintaining display on a current media item for longer than would normally have been the case, navigating to a previous or to a subsequent media item). In some embodiments, in response to these user inputs, electronic device 600 speeds up or slows down playback of the first aggregated content item to account for the changes to playback of the visual content of the first aggregated content item caused by the user inputs. For example, in response to user input 686 (which caused media item 628C to be displayed for longer than would normally have been the case), electronic device 600 speeds up playback of subsequent media items so that playback of the first aggregated content item maintains a target playback duration. Similarly, in response to user input 688 (navigating backwards), electronic device 600 speeds up playback of subsequent media items, and in response to user input 690 (navigating forwards), electronic device 600 slows down playback of subsequent media items, in order to maintain a target playback duration for the first aggregated content item.

In FIG. 6AF, playback of the first aggregated content item continues from FIG. 6AE. In FIG. 6AF, playback of visual content of the first aggregated content item includes displaying three media items 628D, 628E, 628F in a predefined arrangement. In some embodiments, media items 628D, 628E, 628F are selected for presentation together in the predefined arrangement based on similarities in the content depicted in the media items. Furthermore, in FIG. 6AF, based on a determination that a user input has not been received for a threshold duration of time, electronic device 600 ceases display of options 632A-632F.

In FIG. 6AG, playback of the first aggregated content item continues from FIG. 6AF, and electronic device 600 replaces display of media items 628D, 628E, and 628F with display of media item 628G, while continuing to play audio track 3.

FIG. 7 is a flow diagram illustrating a method for viewing and editing content items using a computer system in accordance with some embodiments. Method 700 is performed at a computer system (e.g., 100, 300, 500) (e.g., a smart phone, a smart watch, a tablet, a digital media player; a computer set top entertainment box; a smart TV; and/or a computer system controlling an external display) that is in communication with a display generation component (e.g., a display controller; a touch-sensitive display system; and/or a display (e.g., integrated and/or connected)) and one or more input devices (e.g., a touch-sensitive surface (e.g., a touch-sensitive display); a mouse; a keyboard; and/or a remote control). Some operations in method 700 are, optionally, combined, the orders of some operations are, optionally, changed, and some operations are, optionally, omitted.

As described below, method 700 provides an intuitive way for viewing and editing content items. The method reduces the cognitive burden on a user for viewing and editing content items, thereby creating a more efficient human-machine interface. For battery-operated computing devices, enabling a user to view and edit content items faster and more efficiently conserves power and increases the time between battery charges.

The computer system plays (702), via the display generation component, visual content of a first aggregated content item (e.g., media item 628A in FIG. 6K) (e.g., displays, via the display generation component, visual content of the first aggregated content item) (e.g., a video and/or a content item automatically generated from a plurality of content items) (in some embodiments, the computer system plays visual content and audio content of the first aggregated content item), wherein the first aggregated content item comprises an ordered sequence of a first plurality of content items that are selected (e.g., automatically and/or without user input) from a set of content items based on a first set of selection criteria (e.g., the first aggregated content item depicts an ordered sequence of a plurality of photos and/or videos and/or an automatically generated collection of photos and/or videos (e.g., a collection of photos and/or videos that are automatically aggregated and/or selected from the set of content items based on one or more shared characteristics)). In some embodiments, the plurality of photos and/or videos that make up the first plurality of content items are selected from a set of photos and/or videos that are associated with the computer system (e.g., stored on the computer system, associated with a user of the computer system, and/or associated with a user account associated with (e.g., signed into) the computer system).

While playing the visual content of the first aggregated content item (704) (e.g., media item 628A in FIG. 6K), the computer system plays (706) audio content that is separate from the content items (e.g., playing audio track 1 in FIG. 6K) (e.g., outputting and/or causing output (e.g., via one or more speakers, one or more headphones, and/or one or more earphones) of a song or media asset that is separate from the content items while the visual content of the first aggregated content item is being displayed via the display generation component). In some embodiments, the computer system also plays audio content that corresponds to and/or is part of the first aggregated content item (e.g., audio from one or more videos incorporated into the aggregated content item) (e.g., an audio track that is overlaid on the first aggregated content item and/or played while visual content of the first aggregated content item is played and/or displayed).

While playing the visual content of the first aggregated content item and the audio content (708), the computer system detects (710), via the one or more input devices, a user input (e.g., 648) (e.g., a gesture (e.g., via a touch-sensitive display and/or a touch-sensitive surface) (e.g., a tap gesture, a swipe gesture) and/or a voice input).

In response to detecting the user input (712), the computer system modifies (714) audio content that is playing (e.g., a non-volume audio parameter (e.g., an audio parameter different from volume)) (e.g., changes the audio content from a first audio track to a second audio track different from the first audio track (e.g., from a first music track to a second music track different from the first music track)) while continuing to play visual content of the first aggregated content item (e.g., FIGS. 6K-6N, changing audio track 1 to audio track 2, while continuing to play visual content of the first aggregated content item (e.g., displaying media item 628A)) (e.g., without ceasing, pausing, and/or otherwise disrupting playing of the visual content of the first aggregated content item). Modifying audio content in response to detecting a user input while continuing to play visual content of a first aggregated content item enables a user to quickly modify audio content that is applied to visual content, thereby reducing the number of inputs needed for modifying audio content that is applied to visual content. Modifying audio content in response to detecting a user input provides the user with feedback about the current state of the device (e.g., that the device has detected the user input).

In some embodiments, in response to detecting the user input (e.g., 648), the computer system modifies (716) a visual parameter of playback of visual content of the first aggregated content item (e.g., FIGS. 6K-6N, changing a visual filter that is applied to media item 628A in response to user input 648) (e.g., brightness, saturation, hue, contrast, color, visual transitions between content items of the first plurality of content items, display duration for each content item of the first plurality of content items, one or more visual transitions that are used in the first aggregated content item (e.g., between content items presented within the first aggregated content item)) (e.g., changing a visual filter applied to the first aggregated content item (e.g., from a first visual filter to a second visual filter different from the first visual filter)) while continuing to play visual content of the first aggregated content item (e.g., without ceasing, pausing, and/or otherwise disrupting playing of the visual content of the first aggregated content item) (e.g., without changing an order of the ordered sequence of a first plurality of content items). Modifying audio content and a visual parameter of visual content of the first aggregated content item in response to detecting a user input while continuing to play visual content of a first aggregated content item enables a user to quickly modify audio content and a visual parameter that are applied to visual content, thereby reducing the number of inputs needed for modifying audio content and a visual parameter that is applied to visual content. Modifying a visual parameter in response to detecting a user input provides the user with feedback about the current state of the device (e.g., that the device has detected the user input).

In some embodiments, playing the visual content of the first aggregated content item (e.g., prior to detecting the user input) includes displaying the visual content with a first visual filter applied to a first region (e.g., a first display region) of the visual content (e.g., FIG. 6K, visual filter 646B applied to first region of media item 628A) (e.g., the entire display region of the visual content, and/or a portion of the display region of the visual content). In some embodiments, playing the visual content of the first aggregated content item (e.g., prior to detecting the user input) includes displaying the visual content with a second visual filter different from the first visual filter applied to a second region (e.g., a second display region) of the visual content different from the first region (e.g., while concurrently displaying the first visual filter applied to the first region).

In some embodiments, modifying the visual parameter of playback of visual content of the first aggregated content item while continuing to play visual content of the first aggregated content item includes displaying the visual content with a second visual filter different from the first visual filter applied to the first region of the visual content (e.g., FIG. 6N, visual filter 646C applied to first region of media item 628A). In some embodiments, modifying the visual parameter includes replacing display of the visual content with the first visual filter applied to the first region with display of the visual content with the second visual filter applied to the first region. In some embodiments, modifying the visual parameter includes replacing display of a second region of the visual content with the second visual filter applied with display of the second region of the visual content with a third visual filter different from the first and second visual filters applied to the second region. In some embodiments, a visual filter includes a collection of two or more of: a predefined exposure setting (e.g., a predefined exposure value and/or a predefined exposure adjustment); a predefined contrast setting (e.g., a predefined contrast value and/or a predefined contrast adjustment); a predefined highlight setting (e.g., a predefined highlight value and/or a predefined highlight adjustment); a predefined shadow setting (e.g., a predefined shadow value and/or a predefined shadow adjustment); a predefined brightness setting (e.g., a predefined brightness value and/or a predefined brightness adjustment); a predefined saturation setting (e.g., a predefined saturation value and/or a predefined saturation adjustment); a predefined warmth setting (e.g., a predefined warmth value and/or a predefined warmth adjustment); and/or a predefined tint setting (e.g., a predefined tint value and/or a predefined tint adjustment). Modifying a visual filter applied to the visual content of the first aggregated content item in response to detecting a user input enables a user to quickly modify a visual filter applied to the visual content of the first aggregated content item, thereby reducing the number of inputs needed for modifying a visual filter that is applied to the visual content. Modifying a visual filter applied to the visual content of the first aggregated content item in response to detecting a user input provides the user with feedback about the current state of the device (e.g., that the device has detected the user input).

In some embodiments, playing audio content that is separate from the content items while playing the visual content of the first aggregated content item includes playing a first audio track separate from the content items while playing the visual content of the first aggregated content item (e.g., FIG. 6K, playing audio track 1 while displaying media item 628A).

In some embodiments, while playing the first audio track (e.g., audio track 1 in FIG. 6K), the visual content of the first aggregated content item is displayed with the first visual filter (e.g., 646B) applied to the first region of the visual content (e.g., 628A) (e.g., the entire display region of the visual content, and/or a portion of the display region of the visual content). In some embodiments, the first audio track (e.g., audio track 1, FIG. 6K) is part of (e.g., forms and/or defines) a first predefined combination with the first visual filter (e.g., 646B). In some embodiments, the first predefined combination does not include any other audio tracks or visual filters.

In some embodiments, modifying audio content that is playing while continuing to play visual content of the first aggregated content item includes playing a second audio track separate from the content items and different from the first audio track (e.g., audio track 2, FIG. 6N) while continuing to play visual content of the first aggregated content item. In some embodiments, in response to detecting the user input, the computer system ceases to play the first audio track.

In some embodiments, while playing the second audio track (e.g., FIG. 6N, audio track 2), the visual content of the first aggregated content item (e.g., 628A) is displayed with the second filter (e.g., 646C) applied to the first region of the visual content. In some embodiments, in response to detecting the user input, the computer system replaces display of the first region of the visual content with the first visual filter applied with display of the first region of the visual content with the second visual filter applied. In some embodiments, while the first visual filter is applied to the first region of the visual content, the second visual filter is applied to a second region of the visual content different from the first region; and in response to detecting the user input, the second visual filter is applied to the first region of the visual content and the first visual filter ceases to be applied to the first region of the visual content.

In some embodiments, the second audio track (e.g., FIG. 6N, audio track 2) is part of (e.g., forms and/or defines) a second predefined combination with the second visual filter (e.g., 646C). In some embodiments, the second predefined combination does not include any other audio tracks or visual filters.

In some embodiments, the first predefined combination (e.g., MEMORY RECIPE 1 OF 6 of FIG. 6K) and the second predefined combination (e.g., MEMORY RECIPE 2 OF 6 of FIG. 6N) are part of a plurality of predefined combinations of filters and audio tracks. The plurality of predefined combinations of filters and audio tracks are arranged in an order (e.g., memory recipes 1 through 6). The second predefined combination is selected to be adjacent to the first predefined combination in the order (e.g., immediately before and/or immediately after the first predefined combination), and the first audio track (e.g., audio track 1 of FIG. 6K) is different from the second audio track (e.g., audio track 2 of FIG. 6N). Sequentially ordering a first predefined combination that includes a first visual filter and a first audio track to be adjacent to a second predefined combination that includes a second visual filter and a second audio track different from the first visual filter and the first audio track provides the user with improved feedback by making it clear to the user that both the audio content and a visual parameter are modified in response to the user input.

In some embodiments, the computer system applies the first predefined combination to the first aggregated content item (e.g., playing the first audio track and displaying the visual content of the first aggregated content item with the first visual filter applied to the first region); while the first predefined combination is applied to the first aggregated content item, the computer system detects the user input; and in response to detecting the user input, the computer system applies the second predefined combination to the first aggregated content item (e.g., playing the second audio track and displaying the visual content of the first aggregated content item with the second visual filter applied to the first region). In some embodiments, in response to detecting the user input, the computer system ceases to apply the first predefined combination (e.g., ceasing playing the first audio track, and ceasing applying the first visual filter to the first region). In some embodiments, the second predefined combination is applied in response to the user input based on the second predefined combination being adjacent to the first predefined combination in the order (e.g., in accordance with a determination that the second predefined combination is adjacent to the first predefined combination in the order). In some embodiments, the user input comprises a direction, and the direction of the user input is indicative of a request to apply a next predefined combination in the order, and the second predefined combination is applied in response to the user input based on the second predefined combination being immediately subsequent to the first predefined combination in the order. In some embodiments, the user input comprises a (e.g., different) direction, and the direction of the user input is indicative of a request to apply a previous predefined combination in the order, and the second predefined combination is applied in response to the user input based on the second predefined combination being immediately before the first predefined combination in the order.

In some embodiments the first visual filter (e.g., 646B) is selected to be part of the first predefined combination with the first audio track (e.g., audio track 1) based on one or more audio characteristics of the first audio track (e.g., beats per minute and/or sound wave characteristics) and one or more visual characteristics of the first visual filter (e.g., exposure, brightness, saturation, hue, and/or contrast). In some embodiments, the second visual filter is selected to be part of the second predefined combination with the second audio track based on one more audio characteristics of the second audio track and one or more visual characteristics of the second visual filter. Selecting a first visual filter to pair with the first audio track based on one or more audio characteristics of the first audio track improves the quality of filter/audio track combinations provided to a user, thereby providing an improved means for selection by the user. Otherwise, additional inputs would be required to further locate the desired combination of visual filter and audio track.

In some embodiments, playing the visual content of the first aggregated content item (e.g., prior to detecting the user input) comprises: concurrently displaying, via the display generation component: the visual content (e.g., 628A) with the first visual filter (e.g., 646B) applied to the first region of the visual content (e.g., FIG. 6K), wherein the first region includes a center display portion of the visual content; and the visual content (e.g., 628A) with the second visual filter (e.g., 646C) applied to a second region of the visual content different from the first region (e.g., FIG. 6K) (e.g., a second region that does not overlap with the first region and/or a second region that is adjacent to the first region), wherein the second region includes a first edge of the visual content (e.g., a left edge, a right edge, a top edge, and/or a bottom edge). Concurrently displaying the visual content with the first visual filter applied to a first region of the visual content and the second visual filter applied to a second region of the visual content provides the user with feedback about the current state of the device (e.g., that the second visual filter is ordered adjacently to the first visual filter).

In some embodiments, playing the visual content of the first aggregated content item (e.g., prior to detecting the user input) further comprises: while concurrently displaying the visual content (e.g., 628A) with the first visual filter (e.g., 646B) applied to the first region and the second visual filter (e.g., 646C) applied to the second region, displaying, via the display generation component, the visual content with a third visual filter (e.g., 646A) different from the first visual filter and the second visual filter applied to a third region of the visual content different from the first region and the second region (e.g., FIG. 6K) (e.g., a third region that does not overlap with the first region or the second region) (e.g., a third region that is adjacent to the first region), wherein the third region includes a second edge of the visual content different from the first edge (e.g., a left edge, a right edge, a top edge, and/or a bottom edge) (e.g., an edge opposite the first edge). Concurrently displaying the visual content with the first visual filter applied to a first region of the visual content, the second visual filter applied to a second region of the visual content, and the third visual filter applied to a third region of the visual content, provides the user with feedback about the current state of the device (e.g., that the second and third visual filters are ordered adjacently to the first visual filter).

In some embodiments, playing the visual content of the first aggregated content item (e.g., 628A, 628B, 628C, 628D) (e.g., prior to detecting the user input) includes applying transitions of a first visual transition type (e.g., a crossfade, a fade to black, an exposure bleed, a pan, a scale, and/or a rotate) to the visual content of the first aggregated content item (e.g., applying a first type of visual transition between content items in the first aggregated content item), and modifying the visual parameter of playback of visual content of the first aggregated content item while continuing to play visual content of the first aggregated content item includes modifying the transitions to a second visual transition type different from the first visual transition type (e.g., applying a second type of visual transition between content items in the first aggregated content item). In some embodiments, playing the visual content of the first aggregated content item (e.g., prior to detecting the user input) includes: displaying a first content item of the first aggregated content item (e.g., a first image and/or a first video), displaying a transition from the first content item to a second content item of the first aggregated content item, wherein the transition is of the first visual transition type, and after displaying the transition from the first content item to the second content item, displaying the second content item. After detecting the user input and modifying the visual parameter of playback of visual content of the first aggregated content item (e.g., including modifying the first visual transition type to the second visual transition type): the computer system displays a third content item of the first aggregated content item, after displaying the third content item, the computer system displays a transition from the third content item to a fourth content item of the first aggregated content item, wherein the transition is of the second visual transition type different from the first visual transition type. Modifying visual transitions applied to visual content of the first aggregated content item in response to detecting a user input enables a user to quickly modify visual transitions applied to the visual content of the first aggregated content item, thereby reducing the number of inputs needed for modifying visual transitions that are applied to the visual content.

In some embodiments, the first visual transition type is selected from a plurality of visual transition types based on the audio content (e.g., track 1, FIG. 6K) that is played prior to detecting (e.g., prior to the start of the user input being detected) the user input (e.g., 648) (e.g., based on sound wave information and/or beats per minute information). In some embodiments, the second visual transition type is selected from the plurality of visual transition types based on audio content (e.g., track 2, FIG. 6N) that is played after detecting (e.g., after the end of the user input is detected) the user input (e.g., 648) (e.g., based on sound wave information and/or beats per minute information). Automatically selecting transition types based on audio content that is played improves the quality of visual transitions suggested to a user and allows for a user to apply those improved visual transitions without further user input.

In some embodiments, the first visual transition type is selected from a first set of visual transition types based on a tempo (e.g., beats per minute information) for the audio content (e.g., track 1, FIG. 6K) that is played prior to detecting the user input (e.g., 648); and the second visual transition type is selected from a second set of visual transition types different from the first set based on a tempo (e.g., beats per minute information) for the audio content (e.g., track 2, FIG. 6N) that is played after detecting the user input (e.g., 648) (e.g., a first set of visual transition types (e.g., exposure bleed, pan, scale, and/or rotate) for audio content that has a beats per minute value within a first range (e.g., “high energy” songs with high beats per minute (e.g., above a threshold value)) and a second set of visual transition types (e.g., crossfade and/or fade to black) for audio content that has a beats per minute within a second range (e.g., “low energy” songs with a lower beats per minute value (e.g., below a threshold value))). Automatically selecting transition types based on audio content that is played improves the quality of visual transitions suggested to a user and allows for a user to apply those improved visual transitions without further user input.

In some embodiments, playing the visual content (e.g., 628A, 628B, 628C, 628D) of the first aggregated content item (e.g., prior to detecting the user input) includes: displaying the visual content (e.g., 628A, FIG. 6K) with a first set of visual parameters (e.g., FIG. 6K, 646B) applied to a first region (e.g., a first display region) of the visual content; displaying the visual content with a second set of visual parameters (e.g., FIG. 6K, 646C) different from the first set of visual parameters applied to a second region of the visual content different from and adjacent to the first region (e.g., a second region that does not overlap with the first region) while concurrently displaying the visual content with the first visual filter applied to the first region; and displaying a divider (e.g., blank space between visual filters 646B, 646C in FIG. 6K) between the first region and the second region. In some embodiments, the divider is a visually distinct region between the first region and the second region. In some embodiments, the divider is a visual divider that is visible based on the visual parameters that are different from those applied to the first and second regions (e.g., the divider is not a distinct region between the first region and the second region) (e.g., the divider is a dividing line between the first region and the second region). Concurrently displaying the visual content with the first set of visual parameters applied to a first region of the visual content and the second set of visual parameters applied to a second region of the visual content provides the user with feedback about the current state of the device (e.g., that the first set of visual parameters are currently selected, and a user input will cause the second set of visual parameters to be selected).

In some embodiments, in response to detecting the user input (e.g., 648), the computer system shifts the divider in concurrence with the user input (e.g., shifting the blank space between visual filters 646B, 646C in FIGS. 6K-6N) (e.g., shifting the divider in a direction corresponding to a direction of the user input) while continuing to play the visual content of the first aggregated content item and without shifting the visual content of the first aggregated content item (e.g., 628A in FIGS. 6K-6N). In some embodiments, shifting the divider in concurrence with the user input includes changing a size of the first region and changing a size of the second region based on the user input and/or based on shifting the divider. In some embodiments, shifting the divider in concurrence with the user input includes increasing a size of the first region (e.g., by a first amount) and decreasing a size of the second region (e.g., by the first amount) based on the user input and/or based on shifting the divider. Shifting the divider in concurrence with the user input provides the user with feedback about the current state of the device (e.g., that the device detects the user input and/or that the user input is causing the first and/or second set of visual parameters to be applied).

In some embodiments, prior to detecting the user input (e.g., 648), the first aggregated content item is configured to display a first content item (e.g., 628A) of (or, optionally, each content item of) the first plurality of content items for a first duration of time (e.g., one second, or three seconds); and modifying the visual parameter of playback of visual content of the first aggregated content item comprises configuring the first aggregated content item to display the first content item (e.g., 628A) (or, optionally, each content item) for a second duration of time that is different from the first duration of time (e.g., two seconds, or four seconds). In some embodiments, prior to detecting the user input, the first aggregated content item is configured to display a second content item of the first plurality of content items for a third duration of time; and modifying the visual parameter of playback of visual content of the first aggregated content item comprises, in response to detecting the user input, configuring the first aggregated content item to display the second content item for a fourth duration of time that is different from the third duration of time. In some embodiments, the second duration of time is shorter than the first duration of time based on a determination that the user input causes playing of faster audio content (e.g., modifying the audio content includes playing new audio content that has a faster tempo (e.g., a greater beats per minute value) than the audio content). In some embodiments, the second duration of time is longer than the first duration of time based on a determination that the user input causes playing of slower audio content (e.g., modifying the audio content includes playing new audio content that has a slower tempo (e.g., a lower beats per minute value) than the audio content). Modifying the duration of time that content items are displayed in response to detecting a user input enables a user to quickly modify the duration of time that content items are displayed, thereby reducing the number of inputs needed for modifying display durations for content items.

In some embodiments, the user input (e.g., 648, 650A, 650B) comprises a gesture (e.g., via a touch-sensitive display and/or a touch sensitive surface) (e.g., a tap gesture, a swipe gesture, and/or a different gesture) (e.g., a touchscreen gesture and/or a non-touchscreen gesture such as a mouse click or hover gesture). Modifying audio content in response to detecting a gesture enables a user to quickly modify audio content that is applied to visual content, thereby reducing the number of inputs needed for modifying audio content that is applied to visual content. Modifying audio content in response to detecting a gesture provides the user with feedback about the current state of the device (e.g., that the device has detected the gesture).

In some embodiments, modifying audio content that is playing while continuing to play visual content of the first aggregated content item comprises changing the audio content from a first audio track (e.g., track 1, FIG. 6K) (e.g., a first music track and/or a first song) to a second audio track (e.g., track 2, FIG. 6N) (e.g., a second music track and/or a second song) different from the first audio track while continuing to play visual content (e.g., 628A) of the first aggregated content item. In some embodiments, playing audio content that is separate from the content items prior to detecting the user input comprises playing the first audio track; and modifying audio content that is playing while continuing to play visual content of the first aggregated content item comprises: ceasing playing the first audio track and playing the second audio track (e.g., replacing play of the first audio track with playing the second audio track) while continuing to play visual content of the first aggregated content item. Changing the audio content from a first audio track to a second audio track in response to detecting a user input enables a user to quickly modify the audio track that is applied to visual content, thereby reducing the number of inputs needed for modifying the audio track that is applied to visual content. Changing the audio content from a first audio track to a second audio track provides the user with feedback about the current state of the device (e.g., that the device has detected the user input).

In some embodiments, changing the audio content from the first audio track to the second audio track comprises: ceasing playing the first audio track at a first playback position of the first audio track (e.g., FIGS. 6K-6N, ceasing playing audio track 1), wherein the first playback position is not a beginning position of the first audio track (e.g., ceasing playing the first audio track during playback of the first audio track (e.g., in the middle of the first audio track)) (e.g., ceasing playing the first audio track at its current playback position when the user input is detected (e.g., if the user input is detected 37 seconds into the first audio track, ceasing playing the first audio track at the 37 second mark)); and initiating playing the second audio track (e.g., FIG. 6N, initiating playing audio track 2) at a second playback position of the second audio track, wherein the second playback position is not a beginning position of the second audio track (e.g., starting playback of the second audio track in the middle of the second audio track (e.g., from a playback position within the second audio track that is not the beginning of the second audio track)) (e.g., 37 seconds into the second audio track, 48 seconds into the second audio track)). In some embodiments, the second playback position corresponds to the first playback position (e.g., if the first playback position is 23 seconds into the first audio track (e.g., the user input is detected at the 23-second mark of the first audio track and/or the first audio track is stopped at the 23 second mark), the second playback position is 23 seconds into the second audio track (e.g., the second audio track begins playing from the 23 second mark). In some embodiments, the second playback position corresponds to a percentage of completion of the second audio track corresponding to a percentage of completion of the first playback position in the first audio track (e.g., the first playback position represents x % of the first audio track completed, the second playback position represents x % of the second audio track completed). In some embodiments, the second playback position is a playback position that is greater than a predetermined amount of time into the audio track (e.g., more than 5 seconds into the audio track, more than 10 seconds into the audio track, more than 20 seconds into the audio track, or more than 30 seconds into the audio track). Automatically initiating playing the second audio track at a second playback position of the second audio track that is not the beginning of the second audio track provides the user with a more accurate preview of what playback of the first aggregated content item would be like with the second audio track applied without requiring further user input.

In some embodiments, the computer system detects, via the one or more inputs devices, one or more duration setting inputs (e.g., one or more inputs selecting options 636E-636H) (e.g., one or more tap inputs and/or one or more non-tap inputs) (e.g., while playing the visual content of the first aggregated content item and the audio content). In response to detecting the one or more duration setting inputs, the computer system modifies a duration (e.g., length) of the first aggregated content item (e.g., a duration of the visual content of the first aggregated content item) (e.g., from a first duration to a second duration). In some embodiments, prior to detecting the one or more duration setting inputs, the rate at which content of the first aggregated content item is displayed would result in the computer system taking a first duration to play the first aggregated content and, after detecting the one or more duration setting inputs, the rate at which content of the first aggregated content item is displayed would result in the computer system taking a second duration (different from the first duration) to play the first aggregated content. Modifying the duration of the first aggregated content item in response to detecting a user input enables a user to quickly modify the duration of the first aggregated content item, thereby reducing the number of inputs needed for modifying the duration of the aggregated content item.

In some embodiments, modifying audio content that is playing while continuing to play visual content of the first aggregated content item comprises changing the audio content from a first audio track (e.g., a first music track and/or a first song) to a second audio track (e.g., a second music track and/or a second song) different from the first audio track while continuing to play visual content of the first aggregated content item, wherein the first audio track has a first duration (e.g., length), and the second audio track has a second duration (e.g., length) different from the first duration. In response to detecting the user input, the computer system modifies a duration (e.g., length) of the first aggregated content item (e.g., a duration of the visual content of the first aggregated content item) based on the second duration (e.g., option 636H “full song”) (e.g., modifying the duration of the first aggregated content item to the second duration (e.g., to equal the second duration)). In some embodiments, modifying the duration of the first aggregated content item includes modifying, for each content item of at least a subset of the first plurality of content items, a respective duration that the content item is configured to be displayed (e.g., modifying a duration a first content item is to be displayed, modifying a duration a second content item is to be displayed). In some embodiments, modifying the duration of the first aggregated content item includes modifying the number of content items to be displayed in the first aggregated content item (e.g., modifying the number of content items in the first plurality of content items). Automatically modifying the duration of the first aggregated content item based on the duration of the second audio track allows the user to quickly modify the duration of the first aggregated content item without further user inputs.

In some embodiments, while playing the audio content, the computer system detects, via the one or more inputs devices, one or more duration fitting inputs (e.g., one or more inputs selecting option 636H) (e.g., one or more tap inputs and/or one or more non-tap inputs) (e.g., while playing the visual content of the first aggregated content item and the audio content). In response to detecting the one or more duration fitting inputs, and in accordance with a determination that the audio content has a first duration, the computer system modifies a duration (e.g., length) of the first aggregated content item (e.g., a duration of the visual content of the first aggregated content item) from a second duration different from the first duration to the first duration (e.g., based on a determination that the audio content has the first duration). In some embodiments, in response to detecting the one or more duration fitting inputs, and in accordance with a determination that the audio content has a third duration different from the first duration and the second duration, the computer system modifies the duration of the first aggregated content item from the second duration to the third duration. Modifying the duration of the first aggregated content item in response to detecting a user input enables a user to quickly modify the duration of the first aggregated content item, thereby reducing the number of inputs needed for modifying the duration of the aggregated content item.

In some embodiments, while playing the visual content of the first aggregated content item (e.g., 628A, 628B, 628C, 628D) and the audio content that is separate from the content items (e.g., audio track 1, audio track 2, audio track 3 of FIGS. 6F-6AG), the computer system displays, via the display generation component, a first selectable object (e.g., 644D) that is selectable to display a plurality of visual filter options (e.g., corresponding to a plurality of visual filters) (e.g., each visual filter option corresponds to a respective visual filter). While displaying the first selectable object, the computer system detects, via the one or more input devices, a first selection input (e.g., 668) corresponding to selection of the first selectable object (e.g., a tap input and/or a non-tap input). In response to detecting the first selection input, the computer system displays a visual filter selection user interface (e.g., 670) while continuing to play visual content of the first aggregated content item (in some embodiments, while continuing to play the audio content that is separate from the content items). Displaying the visual filter selection user interface comprises concurrently displaying: a first user interface object (e.g., 674A) (e.g., a first user interface object corresponding to a first visual filter) that includes display of the continued playing of the visual content of the first aggregated content item with the first visual filter applied to the visual content; and a second user interface object (e.g., 674B) (e.g., a second user interface object corresponding to a second visual filter different from the first visual filter) that includes display of the continued playing of the visual content of the first aggregated content item with a second visual filter different from the first visual filter applied to the visual content. Concurrently displaying a plurality of visual filter options enables a user to quickly view and select a desired visual filter, thereby reducing the number of inputs needed for selecting a visual filter.

In some embodiments, the first user interface object is displayed in a first region of the visual filter selection user interface, and the second user interface object is displayed in a second region of the visual filter selection user interface that does not overlap the first region. In some embodiments, displaying the visual filter selection user interface comprises concurrently displaying, with the first user interface object and the second user interface object, a third user interface object (e.g., corresponding a third visual filter different from the first and second visual filters) displaying the continued playing of the visual content of the first aggregated content item with a third visual filter different from the first and second visual filters applied to the visual content. In some embodiments, the method further comprises: while displaying the visual filter selection user interface including the first user interface object and the second user interface object, detecting, via the one or more input devices, a user input corresponding to selection of the first user interface object; and in response to detecting the user input: ceasing display of the visual filter selection user interface (e.g., ceasing display of the second user interface object); and displaying continued playing of the visual content of the first aggregated content item with the first visual filter applied to the visual content. In some embodiments, selection of the first user interface object and/or selection of the second user interface object maintains continued playing of the audio content that is separate from the content items (e.g., selection of a user interface object in the visual filter selection user interface does not affect audio content that is playing). In some embodiments, selection of the first user interface object causes second audio content different from the audio content to play (e.g., selection of a user interface object in the visual filter selection user interface changes audio content that is playing and/or applied to the first aggregated content item).

In some embodiments, while playing the visual content of the first aggregated content item and the audio content that is separate from the content items, the computer system displays, via the display generation component, a second selectable object (e.g., 644C) that is selectable to display a plurality of audio track options (e.g., corresponding to a plurality of audio tracks) (e.g., each audio track option corresponds to a respective audio track). In some embodiments, while displaying the second selectable object, the computer system detects, via the one or more input devices, a second selection input (e.g., 652) corresponding to selection of the second selectable object (e.g., a tap input) (e.g., a non-tap input). In response to detecting the second selection input, the computer system displays an audio track selection user interface (e.g., 654) (in some embodiments, while continuing playing the visual content of the first aggregated content item) (in some embodiments, in response to detecting the second selection input, pausing playing of the visual content of the first aggregated content item). The audio track selection user interface comprises: a third user interface object (e.g., 656A) corresponding to a first audio track, wherein the third user interface object is selectable to initiate a process for applying the first audio track to the first aggregated content item (e.g., playing the first audio track while playing the visual content of the first aggregated content item); and a fourth user interface object (e.g., 656B) corresponding to a second audio track different from the first audio track, wherein the fourth user interface object is selectable to initiate a process for applying the second audio track to the first aggregated content item (e.g., playing the second audio track while playing the visual content of the first aggregated content item). Concurrently displaying the third user interface object corresponding to the first audio track and the fourth user interface object corresponding to the second audio track enables a user to quickly select a desired audio track, thereby reducing the number of inputs needed for selecting an audio track.

In some embodiments, the audio track selection user interface further comprises a fifth user interface object corresponding to a third audio track different from the first and second audio tracks, wherein the fifth user interface object is selectable to initiate a process for applying the third audio track to the first aggregated content item (e.g., playing the third audio track while playing the visual content of the first aggregated content item). In some embodiments, the second selection input is detected while the visual content of the first aggregated content item is displayed with a first visual filter applied, and selection of the third user interface object and/or selection of the fourth user interface object maintains application of the first visual filter to the visual content of the first aggregated content item (e.g., selection of a user interface object in the audio track selection user interface does not affect a visual filter that is applied to the visual content). In some embodiments, selection of the third user interface object causes a second visual filter different from the first visual filter to be applied to the visual content (e.g., selection of a user interface object in the audio track selection user interface changes a visual filter that is applied to the visual content of the first aggregated content item). In some embodiments, the first audio track and the second audio track are selected for inclusion in the audio track selection user interface based on visual content of the first aggregated content item (e.g., song suggestions are generated and/or provided based on visual content included in the first aggregated content item) (e.g., climbing related songs for a first aggregated content item about a climbing trip, or surfing related songs about a first aggregated content item about a surfing trip).

In some embodiments, the third user interface object (e.g., 656A) includes display of a track title (e.g., a song title) corresponding to the first audio track; and the fourth user interface object (e.g., 656B) includes display of a track title (e.g., a song title) corresponding to the second audio track. In some embodiments, the third user interface object further displays album art corresponding to the first audio track; and the fourth user interface object further displays album art corresponding to the second audio track. Displaying the third user interface object including the track title corresponding to the first audio track and the fourth user interface object including the track title corresponding to the second audio track enables a user to quickly select a desired audio track, thereby reducing the number of inputs needed for selecting an audio track.

In some embodiments, while displaying the audio track selection user interface (e.g., 654), including the third user interface object (e.g., 656A-656N) and the fourth user interface object (e.g., 656A-656N), the computer system detects, via the one or more input devices, a third selection input (e.g., 660) (e.g., a tap input and/or a non-tap input). In response to detecting the third selection input: in accordance with a determination that the third selection input corresponds to selection of the third user interface object, the computer system plays the first audio track from the beginning of the first audio track; and in accordance with a determination that the third selection input corresponds to selection of the fourth user interface object, the computer system plays the second audio track from the beginning of the second audio track. Playing the first audio track from the beginning of the first audio track or playing the second audio track from the beginning of the second audio track in response to the third selection input enables a user to quickly listen to and select a desired audio track, thereby reducing the number of inputs needed for selecting an audio track.

In some embodiments, playing the first audio track from the beginning of the first audio track and/or playing the second audio track from the beginning of the second audio track while playing the visual content of the first aggregated content item. In some embodiments, modifying audio content in response to the user input includes changing the audio content from a first audio track to a second audio track, and the second audio track is started from a playback position that is not a beginning position of the second audio track (e.g., a certain set of user inputs causes switching of the audio track mid-track (e.g., a user input corresponding to changing from a first predefined combination of a first visual filter and a first audio track to a second predefined combination of a second visual filter and a second audio track causes switching of the audio track mid-track) (e.g., causes the second audio track to start playing from a playback position that is not a beginning of the second audio track (e.g., greater than a threshold duration of time into the second audio track)), and, in contrast, selection of an audio track from the audio track selection user interface causes the selected audio track to play from the beginning of the audio track.

In some embodiments, while displaying the audio track selection user interface (e.g., 654), including the third user interface object (e.g., 656A-656N) and the fourth user interface object (e.g., 656A-656N), the computer system detects, via the one or more input devices, a fourth selection input (e.g., 660) corresponding to selection of the third user interface object (e.g., 656D). In response to detecting the fourth selection input, in accordance with a determination that a user of the computer system (e.g., a user account logged into the computer system) is not subscribed to an audio service (e.g., an audio service that provides access to the first audio track and/or a predefined audio service), the computer system initiates a process to display a prompt for the user to subscribe to the audio service (e.g., FIG. 6S, 664B). In some embodiments, the computer system initiates a process to display a notification indicating that the user is not subscribed to the audio service and/or initiates a process to display a notification prompting the user to sign up for a free trial of the audio service. In some embodiments, the computer system displays a selectable user interface object that is selectable to initiate a process to subscribe to the audio service. In some embodiments, in response to detecting the fourth selection input, in accordance with a determination that the user of the computer system is subscribed to the audio service, the computer system plays the first audio track (e.g., from the beginning of the first audio track) (in some embodiments, while playing the visual content of the first aggregated content item). In some embodiments, while displaying the prompt for the user to subscribe to the audio service, the computer system receives one or more user inputs corresponding to a request to subscribe to the audio service and, in response to receiving the one or more user inputs, initiates a process for subscribing the user to the audio service. In some embodiments, in response to receiving the one or more user inputs, the computer system requests authentication (e.g., displays a user interface for a user to enter a password and/or passcode and/or collects biometric information for biometric authentication) to subscribe the user to the audio service. Initiating a process to display a notification prompting a user to subscribe to an audio service in accordance with a determination that the user is not subscribed to the audio service provides the user with feedback about the current state of the device (e.g., that the device has determined that the user is not subscribed to the audio service).

In some embodiments, while displaying the audio track selection user interface (e.g., 654), including the third user interface object (e.g., 656A-656N) and the fourth user interface object (e.g., 656A-656N), the computer system detects, via the one or more input devices, a fifth selection input (e.g., 660) (e.g., a tap input and/or a non-tap input) corresponding to selection of the third user interface object (e.g., 656D). In response to detecting the fifth selection input, and in accordance with a determination that a user of the computer system (e.g., a user account logged into the computer system) is not subscribed to an audio service (e.g., an audio service that provides access to the first audio track), the computer system initiates a process to display a preview user interface (e.g., 662), wherein displaying the preview user interface includes playing a preview of the first aggregated content item in which the first audio track (e.g., track 3, FIG. 6S) is applied to the visual content of the first aggregated content item (e.g., 628B) (e.g., playing the preview of the first aggregated content item includes playing the first audio track while concurrently playing (e.g., displaying) visual content of the first aggregated content item), wherein the preview user interface does not permit (e.g., prevents and/or prohibits) the user from sharing the preview and/or saving the preview for later playback until the user subscribes to the audio service (e.g., the preview user interface does not include any selectable option or provide for any user input that allows the user to share the preview and/or save the preview for later playback). Initiating a process to display a preview user interface in accordance with a determination that the user is not subscribed to the audio service provides the user with feedback about the current state of the device (e.g., that the device has determined that the user is not subscribed to the audio service).

In some embodiments, while playing the visual content of the first aggregated content item and the audio content that is separate from the content items, the computer system displays a fifth user interface object (e.g., 632D) that is selectable to cause the computer system to enter an editing mode. In some embodiments, entering the editing mode includes displaying an editing user interface.

In some embodiments, subsequent to displaying the fifth user interface object (e.g., while displaying the fifth user interface object and/or after displaying and no longer displaying the fifth user interface object), the computer system detects, via the one or more input devices, a second user input (e.g., 648 (e.g., a swipe gesture)) (e.g., a gesture (e.g., via a touch-sensitive display and/or a touch-sensitive surface) (e.g., a tap gesture, a swipe gesture) and/or a voice input). In response to detecting the second user input, and in accordance with a determination that the computer system is in the editing mode (e.g., FIGS. 6K-6N), the computer system modifies the audio content that is playing while continuing to play visual content of the first aggregated content item. In some embodiments, the computer system also modifies a visual parameter of playback of visual content of the first aggregated content item. In some embodiments, in response to detecting the second user input, and in accordance with a determination that the computer system is not in the editing mode (e.g., FIG. 6J), the computer system forgoes modifying the audio content that is playing. In some embodiments, forgoing modifying the visual parameter of playback of visual content of the first aggregated content item. Modifying the audio content in response to the second user input and in accordance with a determination that the computer system is in the editing mode provides the user with feedback about the current state of the device (e.g., that the computer system is in the editing mode).

In some embodiments, while playing the visual content of the first aggregated content item (e.g., FIG. 6Y, 628C) and the audio content that is separate from the content items (e.g., FIG. 6Y, track 3), and while displaying the fifth user interface object (e.g., 632D) (e.g., prior to causing the computer system to enter the editing mode and/or while the computer system is not in the editing mode), displaying, via the display generation component, a sixth user interface object (e.g., 632E) that is selectable to pause playing of the visual content of the first aggregated content item. In some embodiments, selection of the sixth selectable user interface object also pauses playing of the audio content that is separate from the content items.

While displaying the sixth selectable user interface object, the computer system detects, via the one or more input devices, a sixth selection input (e.g., a tap input and/or a non-tap input) corresponding to selection of the sixth user interface object (e.g., 680). In response to detecting the sixth selection input, the computer system pauses playing of the visual content of the first aggregated content item (e.g., displaying the visual content of the first aggregated content item in a paused state). In some embodiments, the computer system also pauses playing of the audio content separate from the content items. In response to detecting the sixth selection input, the computer system replaces display of the fifth user interface object (e.g., 632D) (e.g., a “recipes” option) with a seventh user interface object (e.g., 632G) (e.g., an aspect ratio toggle option) that is selectable to modify an aspect ratio of the visual content of the first aggregated content item. While displaying the seventh user interface object (e.g., and while the visual content of the first aggregated content item is paused and/or while displaying visual content of the first aggregated content item in the paused state), the computer system detects, via the one or more input devices, a seventh selection input (e.g., 683) (e.g., a tap input and/or a non-tap input) corresponding to selection of the seventh user interface object. In response to detecting the seventh selection input, the computer system displays, via the display generation component, the visual content of the first aggregated content item (e.g., 628C, FIG. 6Z) transition from being displayed at a first aspect ratio to being displayed at a second aspect ratio different from the first aspect ratio (e.g., 628C, FIG. 6AA) (e.g., displaying the visual content of the first aggregated content item transition from being displayed at a full-screen aspect ratio (e.g., an aspect ratio that fills a display region and/or a display) to a native aspect ratio (e.g., a native aspect ratio for a content item that is being displayed)) (e.g., while maintaining display of the visual content of the first aggregated content item in the paused state). Pausing playing of the visual content of the first aggregated content item and replacing display of the fifth user interface object with the seventh user interface object in response to detecting the sixth selection input provides the user with feedback about the current state of the device (e.g., that the computer system has detected the sixth selection input).

In some embodiments, while playing of the visual content of the first aggregated content item is paused, while displaying the seventh user interface object, and while displaying the visual content of the first aggregated content item in the second aspect ratio, the computer system displays, via the display generation component, an eighth user interface object that is selectable to resume playing of the visual content of the first aggregated content item; while displaying the eight user interface object, the computer system displays an eighth selection input (e.g., a tap input and/or a non-tap input) corresponding to selection of the eight selectable user interface object; and in response to detecting the eighth selection input: the computer system displays, via the display generation component, the visual content of the first aggregated content item transition from being displayed at the second aspect ratio to being displayed at the first aspect ratio, and resumes playing of the visual content of the first aggregated content item (e.g., in the first aspect ratio) (in some embodiments, also resuming playing of the audio content that is separate from the content items).

In some embodiments, while playing the visual content of the first aggregated content item, the computer system detects, via the one or more input devices, a pause input (e.g., 680) (e.g., one or more tap inputs and/or one or more non-tap inputs) corresponding to a request to pause playing of the visual content of the first aggregated content item (e.g., a tap input selecting a pause option). In response to detecting the pause input, the computer system pauses playing of the visual content of the first aggregated content item (e.g., FIG. 6Z). In some embodiments, pausing playing of the visual content of the first aggregated content item comprises persistently displaying visual content that was displayed when the pause input was detected (e.g., persistently displaying until one or more further user inputs are received (e.g., one or more user inputs to resume playing visual content of the first aggregated content item)). In some embodiments, in response to detecting the pause input, the computer system displays, via the display generation component, a video navigation user interface element (e.g., 682) (e.g., a scrubber bar) for navigating through (e.g., a plurality of frames (e.g., images) of) the visual content of the first aggregated content item. Pausing playing of the visual content of the first aggregated content item and displaying the video navigation user interface element in response to detecting the pause input provides the user with feedback about the current state of the device (e.g., that the computer system has detected the pause input).

In some embodiments, displaying the visual navigation user interface element (e.g., 682) includes concurrently displaying: a representation of a first content item of the first plurality of content items, and a representation of a second content item (e.g., different from the first content item) of the first plurality of content items (e.g., FIGS. 6Z-6AA). In some embodiments, displaying the visual navigation user interface element further includes displaying, concurrently with the representation of the first content item and the representation of the second content item, a representation of a third content item of the first plurality of content items different from the first and second content items. In some embodiments, the visual navigation user interface element is a scrubber bar, and the scrubber bar includes representations of the content items that are aggregated in the first aggregated content item. Concurrently displaying the representation of the first content item and the representation of the second content item provides the user with feedback about the current state of the device (e.g., that the first aggregated content item includes the first content item and the second content item).

In some embodiments, in response to detecting the pause input (e.g., 1226), the computer system displays, via the display generation component, and concurrently with the visual navigation user interface element (e.g., 1228) (in some embodiments, while playing of the visual content of the first aggregated content item is paused), a duration control option (e.g., 1232A). While displaying the duration control option, the computer system detects, via the one or more input devices, a duration control input (e.g., 1242) (e.g., one or more remote control inputs and/or one or more non-remote control inputs) (e.g., one or more tap inputs and/or one or more non-tap inputs) corresponding to a selection of the duration control option. In response to detecting the duration control input, the computer system concurrently displays, via the display generation component: a first playback duration option (e.g., 1233A-1244E) corresponding to a first playback duration (e.g., a short playback duration option); and a second playback duration option (e.g., 1244A-1244E) corresponding to a second playback duration different from the first playback duration (e.g., a long playback duration option). In some embodiments, selection of the first playback duration option and/or the second playback duration option causes the first aggregated content item to be modified based on the selected playback duration option (e.g., increases and/or decreases the number of content items included in the first aggregated content item based on the selected playback duration option). Concurrently displaying the first playback duration option and the second playback duration option enables a user to quickly set the playback duration for the first aggregated content item, thereby reducing the number of inputs needed for setting a playback duration.

In some embodiments, in response to detecting the pause input (e.g., 1226), the computer system displays, via the display generation component, and concurrently with the visual navigation user interface element (e.g., 1228) (in some embodiments, while playing of the visual content of the first aggregated content item is paused), an audio track control option (e.g., 1232B). While displaying the audio track control option, the computer system detects, via the one or more input devices, an audio track control input (e.g., 1248) (e.g., one or more remote control inputs and/or one or more non-remote control inputs) (e.g., one or more tap inputs and/or one or more non-tap inputs) corresponding to a selection of the audio track control option. In response to detecting the audio track control input, the computer system concurrently displays, via the display generation component, a first audio track option (e.g., 1250A-1250E) corresponding to a first audio track; and a second audio track option (e.g., 1250A-1250E) corresponding to a second audio track different from the first audio track. In some embodiments, selection of the first audio track option causes the first audio track to be applied to the first aggregated content item (e.g., causes the first audio track to play while visual content of the first aggregated content item is played), and selection of the second audio track option causes the second audio track to be applied to the first aggregated content item (e.g., causes the second audio track to play while visual content of the first aggregated content item is played). Concurrently displaying the first audio track option and the second audio track option enables a user to quickly set the audio track applied to the first aggregated content item, thereby reducing the number of inputs needed for setting the audio track.

In some embodiments, playing the visual content of the first aggregated content item includes: displaying, via the display generation component, at a first time, a first content item (e.g., 628A, FIG. 6G) of the first plurality of content items in the first aggregated content item; displaying, via the display generation component, concurrently with the first content item (e.g., at the first time), first title information (e.g., 627, FIG. 6G) (e.g., text (e.g., location information and/or date information)) corresponding to the first content item; at a second time subsequent to the first time, displaying, via the display generation component, a second content item (e.g., 628C, FIG. 6Y) (e.g., different from the first content item) of the first plurality of content items in the first aggregated content item; and displaying, via the display generation component, concurrently with the second content item (e.g., at the second time), second title information (e.g., 627, FIG. 6Y) (e.g., text (e.g., location information and/or date information)) corresponding to the second content item and different from the first title information. Displaying the first title information concurrently with the first content item and the second title information concurrently with the second content item provides the user with feedback about the current state of the device (e.g., that the device has identified first title information corresponding to the first content item and second title information corresponding to the second content item).

In some embodiments, while playing the visual content of the first aggregated content item (e.g., 628C, FIG. 6AB) and the audio content (e.g., track 3, FIG. 6AB), the computer system detects, via the one or more input devices, one or more visual parameter modification inputs (e.g., 686, 688, 690) (e.g., one or more touch-screen inputs, one or more remote-control inputs, and/or different inputs). In response to detecting the one or more visual parameter modification inputs: in accordance with a determination that the one or more visual parameter modification inputs correspond to a first gesture (e.g., 686, 688, 690) (e.g., long press, tap on left side of screen, tap on right side of screen, swipe left, and/or swipe right), modifying playing of the visual content of the first aggregated content item in a first manner (e.g., FIGS. 6AB-6AD) (e.g., display a previous content item, display a next content item, and/or maintain display of a current content item); and in accordance with a determination that the one or more visual parameter modification inputs correspond to a second gesture (e.g., 686, 688, 690) (e.g., long press, tap on left side of screen, tap on right side of screen, swipe left, and/or swipe right) different from the first gesture, modifying playing of the visual content of the first aggregated content item in a second manner (e.g., display a previous content item, display a next content item, and/or maintain display of a current content item) different from the first manner (e.g., FIGS. 6AB-6AD). Modifying playing of the visual content of the first aggregated content item in a first manner in response to a first gesture, and in a second manner in response to a second gesture, enables a user to quickly modify playing of the visual content of the first aggregated content item with various gestures, thereby reducing the number of inputs needed to modify playing of the visual content of the first aggregated content item.

In some embodiments, the first gesture is a long press gesture (e.g., 686) (e.g., sustained contact with a touchscreen display, sustained contact with a touchpad, and/or sustained click of a mouse); and modifying playing of the visual content of the first aggregated content item in the first manner includes maintaining display of a currently displayed content item during (e.g., for some or all of the duration of) the long press gesture (e.g., FIGS. 6AB-6AC) (e.g., while contact with the touchscreen display and/or the touchpad is maintained, and/or while mouse button remains depressed). In some embodiments, the computer system maintains display of the currently displayed content item during the long press gesture while continuing to play audio content that is playing. Maintaining display of a currently displayed content item in response to a long press gesture enables a user to easily maintain display of a currently displayed content item, thereby reducing the number of inputs needed to maintain display of the currently displayed content item.

In some embodiments, while maintaining display of the currently displayed content item during the long press gesture (e.g., 686), the computer system detects, via the one or more input devices, termination of the long press gesture. After detecting termination of the long press gesture (e.g., in response to detecting termination of the long press gesture), the computer system modifies a playback duration for one or more subsequent content items (e.g., all subsequent content items) to be displayed subsequent to the currently displayed content item (e.g., decreasing a playback duration for the one or more subsequent content items (e.g., decreasing the amount of time that each content item of the one or more subsequent content items will be displayed)). In some embodiments, prior to detecting the long press gesture, a first subsequent content item configured to be displayed subsequent to the currently displayed content item is configured to be displayed for a first duration of time during playback of the visual content; and, after detecting the long press gesture, the first subsequent content item is configured to be displayed for a second duration of time different from the first duration of time (e.g., a second duration of time shorter than the first duration of time). Automatically adjusting playback durations for one or more subsequent content items in response to termination of a long press gesture that caused extended display of a content item allows a user to adjust playback of the visual content to account for the extended playback duration of the content item without further user inputs.

In some embodiments, the first gesture is a first tap gesture (e.g., 688, 690) (e.g., a tap gesture in a first region of a touch-screen display). Modifying playing of the visual content of the first aggregated content item in the first manner includes navigating to a previous content item in the ordered sequence of content items in the first aggregated content item (e.g., FIGS. 6AC-6AD) (e.g., replacing display of a currently displayed content item in the first aggregated content item with a previous content item in the first aggregated content item) (in some embodiments, while continuing to play audio content that is playing). In some embodiments, the second gesture is a second tap gesture different from the first tap gesture (e.g., 688, 690) (e.g., a tap gesture in a second region of a touch-screen display); and modifying playing of the visual content of the first aggregated content item in the second manner includes navigating to a next content item in the ordered sequence of content items in the first aggregated content item (e.g., FIGS. 6AD-6AE) (e.g., replacing display of a currently displayed content item in the first aggregated content item with a next content item in the first aggregated content item) (in some embodiments, while continuing to play audio content that is playing). Navigating between content items in the first aggregated content item in response to various tap gestures enables a user to easily navigate between content items, thereby reducing the number of inputs needed to navigate between content items in the first aggregated content item.

In some embodiments, the first gesture is a first swipe gesture (e.g., a swipe gesture in a first direction); and modifying playing of the visual content of the first aggregated content item in the first manner includes navigating to a previous content item in the ordered sequence of content items in the first aggregated content item (e.g., FIGS. 6AC-6AD) (e.g., replacing display of a currently displayed content item in the first aggregated content item with a previous content item in the first aggregated content item) (in some embodiments, while continuing to play audio content that is playing). In some embodiments, the second gesture is a second swipe gesture different from the first swipe gesture (e.g., a swipe gesture in a second direction (e.g., a second direction opposite or substantially opposite to the first direction)); and modifying playing of the visual content of the first aggregated content item in the second manner includes navigating to a next content item in the ordered sequence of content items in the first aggregated content item (e.g., FIGS. 6AD-6AE) (e.g., replacing display of a currently displayed content item in the first aggregated content item with a next content item in the first aggregated content item) (in some embodiments, while continuing to play audio content that is playing). Navigating between content items in the first aggregated content item in response to various swipe gestures enables a user to easily navigate between content items, thereby reducing the number of inputs needed to navigate between content items in the first aggregated content item.

In some embodiments, modifying playing of the visual content of the first aggregated content item in the first manner comprises modifying playing of the visual content of the first aggregated content item in the first manner while continuing to play the audio content that is separate from the content items (e.g., FIGS. 6AB-6AE); and modifying playing of the visual content of the first aggregated content item in the second manner comprises modifying playing of the visual content of the first aggregated content item in the second manner while continuing to play the audio content that is separate from the content items (e.g., FIGS. 6AB-6AE). In some embodiments, providing a user input that advances to a next (or previous) content item of the first aggregated content item does not cause a corresponding skip/forward/change in playback of the audio content. Thus, in some embodiments, the audio content plays back independent of user input that advances to a next (or previous) content item of the first aggregated content item. Modifying playing of the visual content of the first aggregated content item while continuing to play the audio content that is separate from the content items provides the user with feedback about the current state of the device (e.g., that the visual content of the first aggregated content item is modified while the first aggregated content item continues to be played).

In some embodiments, while displaying, via the display generation component, a first content item of the first aggregated content item (e.g., during playing of the visual content of the first aggregated content item), detecting, via the one or more input devices, a third user input (e.g., a long press input, a tap input, a swipe input, and/or a different input); and in response to detecting the third user input (e.g., 614), the computer system concurrently displays, via the display generation component: a tagging option (e.g., 616D) that is selectable to initiate a process for identifying a person depicted in the first content item (e.g., tagging a person depicted in the first content item); and a removal option (e.g., 616E, 616F) that is selectable to initiate a process for removing one or more content items from the first aggregated content item that depict a person that is also depicted in the first content item. Displaying a tagging option that is selectable to initiate a process for identifying a person depicted in the first content item enables a user to quickly identify people depicted in the first content item, thereby reducing the number of inputs needed to tag and/or identify depicted people. Displaying a removal option that is selectable to initiate a process for removing one or more content items from the first aggregated content item that depict a person that is also depicted in the first content item enables a user to quickly and easily remove content items that depict particular people, thereby reducing the number of inputs needed to remove such content items.

In some embodiments, the removal option is a “feature this person less” option that reduces the number of instances (e.g., number of content items) in the first aggregated content item in which the person is depicted. In some embodiments, the removal option reduces the number of instances (e.g., the number of content items) in the first aggregated content item in which only the person is depicted (and no other people are depicted). In some embodiments, the removal option is a “never feature this person” option in which all instances (e.g., all content items) in which the person is depicted are removed from the first aggregated content item.

In some embodiments, in response to detecting the third user input, the computer system displays the tagging option (e.g., without displaying the removal option). In some embodiments, in response to detecting the third user input, the computer system displays the removal option (e.g., without displaying the tagging option). In some embodiments, the tagging option and/or the removal option are accessible by interacting with a content item in a media library user interface and/or by interacting with a content item in a featured photos user interface.

Note that details of the processes described above with respect to method 700 (e.g., FIG. 7) are also applicable in an analogous manner to the methods described below. For example, methods 900 and 1100 optionally include one or more of the characteristics of the various methods described above with reference to method 700. For example, the aggregated content item in each method 700, 900, 1100, can be the same aggregated content item. For brevity, these details are not repeated below.

FIGS. 8A-8L illustrate exemplary user interfaces for managing playing of content after playing content items, in accordance with some embodiments. The user interfaces in these figures are used to illustrate the processes described below, including the processes in FIG. 9.

FIG. 8A depicts electronic device 600, which is a smartphone with touch-sensitive display 602. In some embodiments, electronic device 600 includes one or more features of devices 100, 300, and/or 500. Electronic device 600 depicts playback user interface 625, which was described above with reference to FIGS. 6A-6AG. In FIG. 8A, playback user interface 625 displays playback of a first aggregated content item, and displays a final media item 628Z of the first aggregated content item. For example, in FIG. 8A, the first aggregated content item described above with reference to FIGS. 6A-6AG has been allowed to continue playing until it reaches final media item 628Z in FIG. 8A.

In FIG. 8B, in response to a determination that playback of the first aggregated content item has satisfied one or more termination criteria (e.g., that a final media item of the first aggregated content item has been displayed for a threshold duration of time, and/or that less than a threshold duration of time remains in playback of the first aggregated content item), electronic device 600 displays next content item user interface 800. Next content item user interface 800 is overlaid on playback user interface 625, which continues to display final media item 628Z of the first aggregated content item. Playback user interface 625 is visually deemphasized (e.g., darkened and/or blurred) while next content item user interface 800 is overlaid on it. Next content item user interface 800 includes tiles 804A, 804B, 804C that are representative of other aggregated content items, and tiles 804A, 804B, 804C are selectable to initiate playback of a corresponding aggregated content item. Tile 804A corresponds to a “next” or subsequent aggregated content item that would automatically begin playing without further user input.

Next content item user interface 800 includes countdown timer 802A that indicates for a user that, without further user input, a next aggregated content item (e.g., “PALM SPRINGS 2017”) will begin playing at the end of the countdown timer 802A. Next content item user interface 800 also includes replay option 802B, that is selectable to replay the first aggregated content item, and share option 802C, that is selectable to initiate a process for sharing the first aggregated content item via one or more communications mediums.

FIG. 8C depicts an example scenario in which, after electronic device 600 displays next content item user interface 800, no user input is received for a threshold duration of time (e.g., 10 seconds or 20 seconds), and countdown timer 802A counts down to zero. In FIG. 8C, in accordance with a determination that next content item user interface 800 has been displayed for the threshold duration of time without any user input, electronic device 600 automatically begins playback of a second aggregated content item. Playback of the second aggregated content item includes displaying title information 627 for the second aggregated content item, displaying a first media item for the second aggregated content item (media item 806), and playing an audio track (e.g., audio track 4). In FIG. 8D, playback of the second aggregated content item continues, with title information 627 moving from a first display position to a second display position.

FIGS. 8E-8L display alternative scenarios in which one or more user inputs are received while electronic device 600 displays next content item user interface 800. In FIG. 8E, electronic device detects user inputs 808A, 808B, 808C, 808D, and 808E, each of which will be discussed in turn below.

In FIG. 8E, electronic device 600 detects user input 808A (e.g., a tap input) corresponding to selection of tile 804A. Tile 804A corresponds to a second aggregated content item. In FIG. 8F, in response to user input 808A, electronic device 600 ceases display of the first aggregated content item and next content item user interface 800, and initiates playback of the second aggregated content item (e.g., Palm Springs 2017).

In FIG. 8E, electronic device 600 detects user input 808B (e.g., a tap input) corresponding to selection of replay option 802B. In FIG. 8G, in response to user input 808B, electronic device 600 ceases display of next content item user interface 800, and begins replaying the first aggregated content item in playback user interface 625. As described above with reference to FIG. 6F, initiating playback of the first aggregated content item includes displaying title information 627 and a first media item of the first aggregated content item (e.g., media item 628A), and playing an audio track that has been applied to the first aggregated content item (e.g., audio track 3).

In FIG. 8E, electronic device 600 detects user input 808C (e.g., a tap input), which corresponds to “negative space” positioned above next content item user interface 800. In other words, user input 808C does not correspond to selection of any particular user interface object in next content item user interface 800. In FIG. 8H, in response to user input 808C, electronic device 800C ceases displaying next content item user interface 800, and re-displays playback user interface 625 (displaying final media item 628Z of the first aggregated content item) in its previous state (e.g., in its non-deemphasized state (e.g., at an increased brightness and/or clarity)).

In FIG. 8E, electronic device 600 detects user input 808D, which is a swipe left input at a position corresponding to the next content item user interface 800. In FIG. 8I, in response to user input 808D, electronic device 600 shifts tiles 804A-804C based on the user input (e.g., at a translation speed and/or for a translation distance that corresponds to the translation speed and/or translation distance of the user input). In FIG. 8I, tiles 804A, 804B, 804C have been shifted to the left, revealing additional tiles 804D, 804E corresponding to additional aggregated content items. Tiles 804A-804E are selectable to initiate playback of a corresponding aggregated content item. In some embodiments, tiles 804A-804E display animated previews of their corresponding aggregated content items. Furthermore, in FIG. 8I, in response to user input 808D, electronic device 600 ceases displaying timer 802A, and cancels automatic play of a subsequent aggregated content item. In some embodiments, any user input received while displaying next content item user interface 800 (e.g., user inputs 808A, 808B, 808C, 808D, 808E) causes electronic device 600 to cease displaying timer 802A and cancels automatic play of the subsequent aggregated content item.

In FIG. 8E, electronic device 600 detects user input 808E corresponding to selection of share option 802C. In FIG. 8J, in response to user input 808E, electronic device 600 displays share user interface 810. Share user interface 810 includes options 812A-812D. Different ones of options 812A-812D correspond to different users or different groups of users, and selection of a respective option 812A-812D initiates a process for sharing the first aggregated content item with the corresponding user or group of users that is associated with the selected option. Share user interface 810 also includes options 814A-814D. Different ones of options 814A-814D correspond to different communication mediums (e.g., option 814A corresponds to near-field communications, option 814B corresponds to SMS message and/or instant messaging, option 814C corresponds to electronic mail, option 814D corresponds to instant messaging). Selection of a respective option 814A-814D initiates a process for sharing the first aggregated content item via the corresponding communication medium associated with the selection option. Share user interface 810 also includes close option 816 that is selectable to cease displaying share user interface 810, and, optionally, re-display next content item user interface 800.

FIG. 8K illustrates a scenario in which electronic device 600 determines that the first aggregated content item is too long (e.g., the playback duration of the first aggregated content item exceeds a threshold playback duration) to share. In FIG. 8K, in response to user input 808E, and in accordance with a determination that the first aggregated content item is too long to share, electronic device 600 displays notification 818, and options 820A, 820B, 820C. Option 820A is selectable to initiate a process for modifying the playback duration of the first aggregated content item (e.g., by removing and/or adding one or more media items from the first aggregated content item). Option 820B is selectable to initiate a process for modifying an audio track applied to the first aggregated content item (e.g., so that the user can select a shorter audio track that will result in a shorter aggregated content item that can be shared). Option 820C is selectable to cancel the share operation and, optionally, re-display next content item user interface 800.

FIG. 8L illustrates another alternative scenario in which electronic device 600 determines that the first aggregated content item includes one or more media items that are not saved to the user's media library. For example, the first aggregated content item can include one or more media items that are available on and/or available to electronic device 600, but have not been saved to the user's media library. In FIG. 8K, in response to user input 808E, and in accordance with a determination that the first aggregated content item includes one or more media items that are not saved to the user's media library and/or that are not saved locally on electronic device 600, electronic device 600 displays notification 822, and options 824A, 824B, and 824C. Option 824A is selectable to initiate a process for adding the one or more media items to the user's media library and/or saving the one or more media items locally on electronic device 600. Option 824B is selectable to initiate a process for sharing the first aggregated content item without adding the one or more media items to the user's media library and/or saving the one or more media items locally on electronic device 600. Option 824C is selectable to cancel the share operation and, optionally, re-display next content item user interface 800.

FIG. 9 is a flow diagram illustrating a method for managing playing of content after playing content items using a computer system in accordance with some embodiments. Method 900 is performed at a computer system (e.g., 100, 300, 500) (e.g., a smart phone, a smart watch, a tablet, a digital media player; a computer set top entertainment box; a smart TV; and/or a computer system controlling an external display) that is in communication with a display generation component (e.g., a display controller; a touch-sensitive display system; and/or a display (e.g., integrated and/or connected)) and one or more input devices (e.g., a touch-sensitive surface (e.g., a touch-sensitive display); a mouse; a keyboard; and/or a remote control). Some operations in method 900 are, optionally, combined, the orders of some operations are, optionally, changed, and some operations are, optionally, omitted.

As described below, method 900 provides an intuitive way for navigating and viewing content items. The method reduces the cognitive burden on a user for navigating and viewing content items, thereby creating a more efficient human-machine interface. For battery-operated computing devices, enabling a user to navigate and view content items faster and more efficiently conserves power and increases the time between battery charges.

The computer system plays (902), via the display generation component, visual content of a first aggregated content item (e.g., media item 826Z of the first aggregated content item in FIG. 8A) (e.g., displays, via the display generation component, visual content of the first aggregated content item) (e.g., a first video and/or a first content item automatically generated from a plurality of content items) (in some embodiments, the computer system plays visual content and audio content of the first aggregated content item), wherein the first aggregated content item comprises an ordered sequence of a first plurality of content items (e.g., 628A, 862B, 862C, 862Z) that are selected (e.g., automatically and/or without user input) from a media library that includes photos and/or videos taken by a user of the computer system (e.g., 600) (e.g., using a camera of the computer system or one or more cameras of other devices associated with the user, scanned physical photos taken by the user and/or uploaded from a dedicated digital camera), wherein the first plurality of content items is selected based on a first set of selection criteria (e.g., the first aggregated content item depicts an ordered sequence of a plurality of photos and/or videos and/or an automatically generated collection of photos and/or videos (e.g., a collection of photos and/or videos that are automatically aggregated and/or selected from the set of content items based on one or more shared characteristics)). In some embodiments, the plurality of photos and/or videos that make up the first plurality of content items are selected from a set of photos and/or videos that are associated with the computer system (e.g., stored on the computer system, associated with a user of the computer system, and/or associated with a user account associated with (e.g., signed into) the computer system).

While playing the visual content of the first aggregated content item (904), the computer system plays (906) audio content (e.g., FIG. 8A, audio track 3) (e.g., audio content that is separate from the first plurality of content items) (e.g., outputting and/or causing output (e.g., via one or more speakers, one or more headphones, and/or one or more earphones) of an audio track while the visual content of the first aggregated content item is being displayed via the display generation component) (e.g., audio content that corresponds to and/or is part of the first aggregated content item (e.g., audio from one or more videos incorporated into the aggregated content item) and/or audio content that is separate from the first aggregated content item (e.g., an audio track that is overlaid on the first aggregated content item and/or played while visual content of the first aggregated content item is played and/or displayed)).

After playing at least a portion of the visual content of the first aggregated content item (908), the computer system detects (910) that playback of the visual content of the first aggregated content item meets one or more termination criteria (e.g., detecting that playback of the first aggregated content item has completed, detecting that playback of the first aggregated content item has surpassed a threshold playback time, and/or detecting that less than a threshold duration of time remains in the first aggregated content item).

Subsequent to detecting that playback of the visual content of the first aggregated content item meets one or more termination criteria (912) (e.g., in response to detecting that playback of the visual content of the first aggregated content item meets one or more termination criteria): in accordance with a determination that a playback condition of a first set of one or more playback conditions is met (914) (e.g., in accordance with a determination that a threshold duration of time has elapsed since detecting that playback of the visual content of the first aggregated content item meets one or more termination criteria, in accordance with a determination that a threshold duration of time has elapsed since playback of the visual content of the first aggregated content item has completed, and/or in accordance with a determination that a user input has been received corresponding to a request to begin playing visual content of a second aggregated content item), the computer system plays (916) visual content of a second aggregated content item different from the first aggregated content item (e.g., FIG. 8C, media item 806 of the second aggregated content item) (e.g., a second video, the first video and/or a second content item automatically generated from a plurality of content items) (e.g., automatically and/or without user input) (e.g., and ceasing playback of the visual content of the first aggregated content item), wherein the second aggregated content item comprises an ordered sequence of a second plurality of content items different from the first plurality of content items, and further wherein the second plurality of content items is selected from the media library that includes photos and/or videos taken by a user of the computer system, wherein the second plurality of content items is selected based on a second set of selection criteria (e.g., different from the first set of selection criteria) (e.g., the second aggregated content item depicts an ordered sequence of a plurality of photos and/or videos and/or an automatically generated collection of photos and/or videos (e.g., a collection of photos and/or videos that are automatically aggregated and/or selected from the set of content items based on one or more shared characteristics)). In some embodiments, the plurality of photos and/or videos that make up the second plurality of content items are selected from a set of photos and/or videos that are associated with the computer system (e.g., stored on the computer system, associated with a user of the computer system, and/or associated with a user account associated with (e.g., signed into) the computer system)(e.g., selected from the same set of photos and/or videos from which the first plurality of content items of the first aggregated content item were selected). Automatically playing visual content of a second aggregated content item in accordance with a determination that a playback condition is satisfied allows the user to view additional aggregated content items without requiring additional input.

In some embodiments, subsequent to detecting that playback of the visual content of the first aggregated content item meets one or more termination criteria (e.g., has finished): in accordance with the determination that the playback condition of the first set of one or more playback conditions is met, and/or while playing the visual content of the second aggregated content item, the computer system plays second audio content (e.g., different from the audio content) (e.g., automatically and/or without user input) (e.g., and ceasing playback of the audio content that was being played during visual playback of the visual content of the first aggregated content item) (e.g., outputting and/or causing output (e.g., via one or more speakers, one or more headphones, and/or one or more earphones) of an audio track while the visual content of the second aggregated content item is being displayed via the display generation component) (e.g., audio content that corresponds to and/or is part of the second aggregated content item (e.g., audio from one or more videos incorporated into the aggregated content item) and/or audio content that is separate from the second aggregated content item (e.g., an audio track that is overlaid on the second aggregated content item and/or played while visual content of the second aggregated content item is played and/or displayed)).

In some embodiments, the computer system detects, via the one or more input devices, an image capture input (e.g., one or more tap inputs and/or one or more non-tap inputs) corresponding to a request to capture image data using a camera; and in response to detecting the image capture input, the computer system adds a new content item (e.g., a new photo and/or a new video) (e.g., a new photo and/or a new video that is captured using a camera in response to detecting the image capture input) to the media library (e.g., media library user interface 604). Automatically adding a new content item to the media library in response to detecting an image capture input allows a user to save captured images without requiring additional input.

In some embodiments, prior to playing the visual content of the second aggregated content item (e.g., FIG. 8C) (in some embodiments, and subsequent to detecting that playback of the visual content of the first aggregated content item meets one or more termination criteria), the computer system displays, via the display generation component, a timer (e.g., 802A) that indicates progress toward reaching (e.g., counts down to or counts up to) a predetermined duration of time (e.g., 3 seconds, 5 seconds, 10 seconds, or 20 seconds). In some embodiments, the visual content of the second aggregated content item begins playing automatically after the timer counts down the predetermined duration of time (e.g., in accordance with a determination that the timer has counted down the predetermined duration of time) (e.g., immediately after the timer counts down the predetermined duration of time). Displaying a timer that counts down a predetermined duration of time prior to playing the visual content of the second aggregated content item provides the user with feedback about the current state of the device (e.g., visual content of the second aggregated content item will begin playing after the predetermined duration of time).

In some embodiments, while displaying the timer (e.g., 802A), the computer system detects, via the one or more input devices, a first input (e.g., 808A, 808B, 808C, 808D, 808E) (e.g., a tap input and/or a non-tap input); and in response to detecting the first input, the computer system cancels automatic playback of the second aggregated content item (e.g., FIGS. 8F-8L) (e.g., determining that the first set of one or more playback conditions have not been met) (and, optionally, ceasing displaying the timer). Canceling automatic playback of the second aggregated content item in response to detecting the first input provides the user with feedback about the current state of the device (e.g., that the device has detected the first input).

In some embodiments, subsequent to (e.g., in response to) detecting that playback of the visual content of the first aggregated content item meets one or more termination criteria (in some embodiments, prior to playing visual content of the second aggregated content item), the computer system displays, via the display generation component, a first user interface object (e.g., 804A) corresponding to (e.g., corresponding uniquely to) the second aggregated content item (in some embodiments, while continuing playing the audio content). While displaying the first user interface object, the computer system detects, via the one or more input devices, a second input (e.g., 808A) (e.g., one or more tap inputs and/or one or more non-tap inputs) corresponding to selection of the first user interface object. In response to detecting the second input, the computer system plays visual content of the second aggregated content item (e.g., FIG. 8F) (e.g., without waiting for the first set of one or more playback conditions to be met and/or without waiting for a displayed countdown timer to expire). Displaying a first user interface object that is selectable to play visual content of the second aggregated content item enables a user to quickly select a next aggregated content item to be played, thereby reducing the number of inputs needed for selecting a next aggregated content item.

In some embodiments, subsequent to (e.g., in response to) detecting that playback of the visual content of the first aggregated content item meets one or more termination criteria, the computer system displays, via the display generation component, a first user interface object (e.g., 804A) corresponding to (e.g., corresponding uniquely to) the second aggregated content item. In some embodiments, the computer system displays the first user interface object while continuing playing the audio content. While displaying the first user interface object, the computer system detects, via the one or more input devices, a third input (e.g., 808B, 808C, 808D, 808E) (e.g., one or more tap inputs and/or one or more non-tap inputs) that does not correspond to selection of the first user interface object (e.g., at a location on a displayed user interface that does not correspond to the first user interface object) (e.g., that does not correspond to selection of any user interface object). In response to detecting the third input, the computer system cancels automatic playback of (e.g., forgoing automatically playing) visual content of the second aggregated content item (e.g., FIGS. 8G-8L). In some embodiments, in response to detecting the third input, the computer system ceases displaying the first user interface object. Cancelling automatic playback of the second aggregated content item in response to detecting the third input enables a user to easily cancel automatic playing of the second aggregated content item, thereby reducing the number of inputs needed for canceling automatic playing of the second aggregated content item.

In some embodiments, subsequent to (e.g., in response to) detecting that playback of the visual content of the first aggregated content item meets one or more termination criteria (e.g., in response to detecting that playback of the visual content of the first aggregated content item meets one or more termination criteria), the computer system displays, via the display generation component, a replay user interface object (e.g., 802B). In some embodiments, the computer system displays the replay user interface object while continuing playing the audio content. In some embodiments, the computer system displays, concurrently with the replay user interface object, a first user interface object corresponding to the second aggregated content item (and selectable to begin playing visual content of the second aggregated content item). While displaying the replay user interface object, the computer system detects, via the one or more input devices, a fourth input (e.g., 808B) (e.g., one or more tap inputs and/or one or more non-tap inputs) corresponding to selection of the replay user interface object. In response to detecting the fourth input, the computer system plays visual content of the first aggregated content item from the beginning of the first aggregated content item (e.g., FIG. 8G) (e.g., replaying the first aggregated content item). In some embodiments, the order of content items of the aggregated content items is maintained between both the initial playing and the replaying. In some embodiments, no additional content items other than content items of the first aggregated content item are played during the replaying. Playing visual content of the first aggregated content item in response to detecting the fourth input enables a user to quickly replay the first aggregated content item, thereby reducing the number of inputs needed for replaying the first aggregated content item.

In some embodiments, the second aggregated content item (e.g., Palm Springs 2017 in FIG. 8E) is selected from a plurality of aggregated content items based on selection criteria. In some embodiments, the computer system automatically selects content items to be included in the second aggregated content item. Automatically selecting the second aggregated content item based on selection criteria improves the quality of suggestions to the user, thereby providing a means for selection by the user. Otherwise, additional inputs would be required to further locate the desired content.

In some embodiments, prior to playing visual content of the second aggregated content item (e.g., immediately prior to playing visual content of the second aggregated content item), the computer system gradually ceases (e.g., fading) playing the audio content (e.g., track 3 in FIG. 8E). In some embodiments, the computer system ceases playing the audio content before playing visual content of the second aggregated content item. Gradually ceasing playing the audio content prior to playing visual content of the second aggregated content item provides the user with feedback about the current state of the device (e.g., the device will imminently begin playing a new aggregated content item). Gradually ceasing playing the audio content reduces power usage and improves battery life of the device by playing the audio content more quietly.

In some embodiments, subsequent to (e.g., in response to) detecting that playback of the visual content of the first aggregated content item meets one or more termination criteria (e.g., in response to detecting that playback of the visual content of the first aggregated content item meets one or more termination criteria) (in some embodiments, prior to playing visual content of the second aggregated content item), the computer system displays, via the display generation component, a first user interface object (e.g., 804A) corresponding to (e.g., corresponding uniquely to) the second aggregated content item. In some embodiments, the computer system displays the first user interface object while continuing playing the audio content. While displaying the first user interface object, the computer system detects, via the one or more input devices, a fifth input (e.g., 808D) (e.g., one or more swipe inputs and/or one or more non-swipe inputs). In response to detecting the fifth input, the computer system displays, via the display generation component, a user interface object (e.g., 804D, 804E) corresponding to (e.g., corresponding uniquely to) a third aggregated content item different from the first aggregated content item and the second aggregated content item, wherein the third aggregated content item comprises an ordered sequence of a third plurality of content items different from the first plurality of content items and the second plurality of content items, and further wherein the third plurality of content items is selected from the media library that includes photos and/or videos taken by a user of the device, wherein the third plurality of content items is selected based on a third set of selection criteria (e.g., different from the first set of selection criteria and/or the second set of selection criteria). In some embodiments, the third aggregated content item depicts an ordered sequence of a plurality of photos and/or videos and/or an automatically generated collection of photos and/or videos (e.g., a collection of photos and/or videos that are automatically aggregated and/or selected from the set of content items based on one or more shared characteristics). In some embodiments, the plurality of photos and/or videos that make up the third plurality of content items are selected from a set of photos and/or videos that are associated with the computer system (e.g., stored on the computer system, associated with a user of the computer system, and/or associated with a user account associated with (e.g., signed into) the computer system)(e.g., selected from the same set of photos and/or videos from which the first plurality of content items of the first aggregated content item were selected). In some embodiments, while displaying the second user interface object, the computer system detects, via the one or more inputs devices, a user input corresponding to selection of the second user interface object, and in response to detecting the user input corresponding to selection of the second user interface object, the computer system plays visual content of the third aggregated content item. Displaying a second user interface object corresponding to a third aggregated content item in response to detecting the fifth input enables a user to quickly select a next content item to be played, thereby reducing the number of inputs needed for selecting a next content item.

In some embodiments, subsequent to (e.g., in response to) detecting that playback of the visual content of the first aggregated content item meets one or more termination criteria (and, optionally, prior to playing visual content of the second aggregated content item), the computer system concurrently displays, via the display generation component (and, optionally, while continuing playing the audio content): a first user interface object (e.g., 804A) corresponding to (e.g., corresponding uniquely to) the second aggregated content item; and a second user interface object (e.g., 804B-804E) corresponding to (e.g., corresponding uniquely to) a third aggregated content item different from the first aggregated content item and the second aggregated content item, wherein the third aggregated content item comprises an ordered sequence of a third plurality of content items different from the first plurality of content items and the second plurality of content items, and further wherein the third plurality of content items is selected from the media library that includes photos and/or videos taken by a user of the device, wherein the third plurality of content items is selected based on a third set of selection criteria (e.g., different from the first set of selection criteria and/or the second set of selection criteria). Displaying a first user interface object corresponding to a second aggregated content item and a second user interface object corresponding to a third aggregated content item enables a user to quickly select a next content item to be played, thereby reducing the number of inputs needed for selecting a next content item.

In some embodiments, while concurrently displaying the first user interface object (e.g., 804A) and the second user interface object (e.g., 804B-804E), the computer system continues playing the audio content (e.g., FIG. 8I, audio track 3). Continuing to play the audio content while displaying the first user interface object and the second user interface object provides the user with feedback about the current state of the device (e.g., a selection of a next content item to be played has not yet been detected by the device).

In some embodiments, subsequent to (e.g., in response to) detecting that playback of the visual content of the first aggregated content item meets one or more termination criteria (in some embodiments, prior to playing visual content of the second aggregated content item), the computer system displays, via the display generation component, at a first time, a first user interface object (e.g., 804A) corresponding to (e.g., corresponding uniquely to) the second aggregated content item (in some embodiments, while continuing playing the audio content), wherein displaying the first user interface object includes concurrently displaying: a first content item of the second plurality of content items in the second aggregated content item (e.g., image of user in water in FIG. 8E); and title information (e.g., “Palm Springs 2017” in FIG. 8E) (e.g., textual information (e.g., a name generated for the second aggregated content item, location information and/or time information)) corresponding to the second aggregated content item. In some embodiments, playing visual content of the second aggregated content item includes concurrently displaying, via the display generation component, at a second time subsequent to the first time, the first content item (e.g., 806) and the title information (e.g., 627) (in some embodiments, while no longer displaying the first user interface object), and further wherein, at the first time, the title information is displayed within the first user interface object at a first position relative to the first content item; and at the second time, the title information is displayed at a second position relative to the first content item, wherein the second position is different from the first position. In some embodiments, at a third time (e.g., a third time between the first time and the second time and/or a third time that is the second time), the computer system initiates ceasing display of the title information at the first position relative to the first content item (e.g., initiates gradually fading out the title information at the first position relative to the first content item) and initiates displaying the title information at the second position relative to the first content item (e.g., initiates gradually fading in the title information at the second position relative to the first content item). In some embodiments, the computer system gradually fades out display of the title information at the first position relative to the first content item and gradually fades in display of the title information at the second position relative to the first content item (in some embodiments, at least a portion of the gradually fading out display of the title information at the first position occurs concurrently with at least a portion of the gradually fading in display of the title information at the second position). Displaying the title information at a first position relative to the first content item at the first time, and displaying the title information at a second position relative to the first content item at the second time, provides the user with feedback about the current state of the device (e.g., that the device has started playing the second aggregated content item).

In some embodiments, at the second time, the computer system displays, via the display generation component, the title information (e.g., 627) in a first display region (e.g., FIG. 8C) (e.g., concurrently displaying the first content item and the title information, wherein the title information is displayed at a first display region); and at a third time subsequent to the second time, the computer system displays, via the display generation component, the title information (e.g., 627) in a second display region different from the first display region (e.g., FIG. 8D) (e.g., displaying the title information in the second display region without displaying the first content item). In some embodiments, at the second time, the title information is displayed with a first set of visual parameters (e.g., font, color, and/or font size), and at the third time, the title information is displayed with a third set of visual parameters different from the first set. Displaying title information corresponding to a second aggregated content item provides the user with feedback about the current state of the device (e.g., that the device has identified title information corresponding to the second aggregated content item).

In some embodiments, subsequent to (e.g., in response to) detecting that playback of the visual content of the first aggregated content item meets one or more termination criteria, the computer system concurrently displays, via the display generation component (and, optionally, prior to playing visual content of the second aggregated content item and/or while continuing playing the audio content): a first user interface object (e.g., 804A) corresponding to (e.g., corresponding uniquely to) the second aggregated content item; and a share user interface object (e.g., 802C) that is selectable to initiate a process for sharing the first aggregated content item (e.g., sharing the first aggregated content via one or more communications mediums (e.g., text message, electronic mail, near field wireless communication and/or file transfer, uploading to a shared media album, and/or uploading to a third party platform)). In some embodiments, while concurrently displaying the first user interface object and the share user interface object, the computer system detects, via the one or more input devices, an input corresponding to selection of the share user interface object; and in response to detecting the input, the computer system displays, via the display generation component, a share user interface, wherein displaying the share user interface includes concurrently displaying: a first share object corresponding to a first communication medium and a second share object corresponding to a second communication medium. Displaying the share user interface object that is selectable to initiate a process for sharing the first aggregated content item enables a user to quickly share the first aggregated content item, thereby reducing the number of inputs needed for sharing the first aggregated content item.

In some embodiments, while concurrently displaying the first user interface object (e.g., 804A) and the share user interface object (e.g., 802C), the computer system detects, via the one or more input devices, a sixth input (e.g., 808E) (e.g., one or more tap inputs and/or one or more non-tap inputs) corresponding to selection of the share user interface object. In response to detecting the sixth input, in accordance with a determination that audio content applied to the first aggregated content item is not permitted to be shared by a user of the computer system (e.g., a user account logged into the computer system) (e.g., the user of the computer system is not authorized to share the audio content applied to the first aggregated content item), the computer system displays, via the display generation component, an indication that the audio content applied to the first aggregated content item is not permitted to be shared by the user (e.g., 818, FIG. 8K). In some embodiments, in response to detecting the sixth input, and in accordance with a determination that audio content applied to the first aggregated content item is permitted to be shared by the user of the computer system, the computer system displays a sharing user interface comprising one or more selectable objects that are selectable to initiate a process and/or further a process for sharing the first aggregated content item via one or more communication mediums (e.g., a first selectable object that is selectable to initiate a process for sharing the first aggregated content item via a first communication medium, and a second selectable object that is selectable to initiate a process for sharing the first aggregated content item via a second communication medium). Displaying an indication that the audio content applied to the first aggregated content item is not permitted to be shared by the user provides the user with feedback about the current state of the device (e.g., that the device has determined that the audio content applied to the first aggregated content item is not permitted to be shared by the user).

In some embodiments, while concurrently displaying the first user interface object (e.g., 804A) and the share user interface object (e.g., 802C), the computer system detects, via the one or more input devices, a seventh input (e.g., 808E) (e.g., one or more tap inputs and/or one or more non-tap inputs) corresponding to selection of the share user interface object. In response to detecting the seventh input, in accordance with a determination that audio content applied to the first aggregated content item is not permitted to be shared by a user of the computer system (e.g., a user account logged into the computer system) (e.g., the user of the computer system is not authorized to share the audio content applied to the first aggregated content item), the computer system displays, via the display generation component, a playback duration option (e.g., 820A, 802B) that is selectable to initiate a process for shortening a playback duration of the first aggregated content item (e.g., shorten the playback duration of the first aggregated content item to less than a threshold playback duration) (e.g., decrease the number of content items included in the first aggregated content item (e.g., to less than a threshold number of content items)). In some embodiments, while displaying the playback duration option, the computer system detects, via the one or more input devices, an input corresponding to selection of the playback duration option; and, in response to detecting the input, the computer system modifies the first aggregated content item to decrease the playback duration of the first aggregated content item (e.g., decrease the number of content items included in the first aggregated content item). In some embodiments, in response to detecting the seventh input, and in accordance with a determination that audio content applied to the first aggregated content item is permitted to be shared by the user of the computer system, the computer system displays a sharing user interface comprising one or more selectable objects that are selectable to initiate a process and/or further a process for sharing the first aggregated content item via one or more communication mediums (e.g., a first selectable object that is selectable to initiate a process for sharing the first aggregated content item via a first communication medium, and a second selectable object that is selectable to initiate a process for sharing the first aggregated content item via a second communication medium). Displaying a playback duration option in accordance with a determination that audio content applied to the first aggregated content item is not permitted to be shared by the user of the computer system provides the user with feedback about the current state of the device (e.g., that the device has determined that the audio content applied to the first aggregated content item is not permitted to be shared by the user).

In some embodiments, while concurrently displaying the first user interface object (e.g., 804A) and the share user interface object (e.g., 802C), the computer system detects, via the one or more input devices, an eighth input (e.g., 808E) (e.g., one or more tap inputs and/or one or more non-tap inputs) corresponding to selection of the share user interface object. In response to detecting the eighth input, in accordance with a determination that audio content applied to the first aggregated content item is not permitted to be shared by a user of the computer system (e.g., a user account logged into the computer system) (e.g., the user of the computer system is not authorized to share the audio content applied to the first aggregated content item), the computer system displays, via the display generation component, an audio content option (e.g., 820B) that is selectable to initiate a process for selecting different audio content to be applied to the first aggregated content item. In some embodiments, in response to detecting the eighth input, and in accordance with a determination that audio content applied to the first aggregated content item is permitted to be shared by the user of the computer system, the computer system displays a sharing user interface comprising one or more selectable objects that are selectable to initiate a process and/or further a process for sharing the first aggregated content item via one or more communication mediums (e.g., a first selectable object that is selectable to initiate a process for sharing the first aggregated content item via a first communication medium, and a second selectable object that is selectable to initiate a process for sharing the first aggregated content item via a second communication medium). In some embodiments, while displaying the audio content option, the computer system detects, via the one or more input devices, an input corresponding to selection of the audio content option; and, in response to detecting the input, the computer system concurrently displays, via the display generation component, a first audio content option corresponding to first audio content and a second audio content option corresponding to second audio content (e.g., different from the first audio content). In some embodiments, while concurrently displaying the first audio content option and the second audio content option, the computer system detects, via the one or more input devices, a selection input; and in response to detecting the selection input: in accordance with a determination that the selection input corresponds to selection of the first audio content option, the computer system applies the first audio content to the first aggregated content item (e.g., without applying the second audio content); and in accordance with a determination that the selection input corresponds to selection of the second audio content option, the computer system applies the second audio content to the first aggregated content item (e.g., without applying the first audio content). In some embodiments, the first audio content option and the second audio content option are selected for display based on a determination that the user is authorized to share the first audio content and the second audio content. Displaying an audio content option in accordance with a determination that audio content applied to the first aggregated content item is not permitted to be shared by the user of the computer system provides the user with feedback about the current state of the device (e.g., that the device has determined that the audio content applied to the first aggregated content item is not permitted to be shared by the user).

In some embodiments, while concurrently displaying the first user interface object (e.g., 804A) and the share user interface object (e.g., 802C), the computer system detects, via the one or more input devices, a ninth input (e.g., 808E) (e.g., one or more tap inputs and/or one or more non-tap inputs) corresponding to selection of the share user interface object. In response to detecting the ninth input, and in accordance with a determination that the first plurality of content items in the first aggregated content item includes a first content item that is not saved locally to the computer system, the computer system displays, via the display generation component, a sync option (e.g., 824A) that is selectable to initiate a process for saving the first content item to the media library. In some embodiments, while displaying the sync option, the computer system detects, via the one or more input devices, an input corresponding to selection of the sync option; and, in response to detecting the input, the computer system saves the first content item to the computer system. In some embodiments, in accordance with a determination that the first plurality of content items in the first aggregated content item includes one or more content items that are not saved locally to the computer system, the computer system displays, via the display generation component, a sync option that is selectable to initiate a process for saving the one or more content items to the computer system; while displaying the sync option, the computer system detects, via the one or more input devices, an input corresponding to selection of the sync option; and, in response to detecting the input, the computer system saves the one or more content items to the computer system. Displaying a sync option in accordance with a determination that the first plurality of content items in the first aggregated content item includes a first content item that is not saved locally to the computer system provides the user with feedback about the current state of the device (e.g., that the device has determined that the first plurality of content items includes a first content item that is not saved locally to the computer system).

In some embodiments, subsequent to (e.g., in response to) detecting that playback of the visual content of the first aggregated content item meets one or more termination criteria (and, optionally, prior to playing visual content of the second aggregated content item), the computer system displays, via the display generation component, a preview object (e.g., 1276A) displaying an animated preview of visual content of the second aggregated content item (e.g., a moving preview and/or a preview video). In some embodiments, the computer system displays the preview object displaying an animated preview of visual content of the second aggregated content item while continuing to play the audio content. In some embodiments, while displaying the preview object, the computer system detects, via the one or more input devices, a selection input corresponding to selection of the preview object; and in response to detecting the selection input, the computer system plays visual content of the first aggregated content item. Displaying a preview object displaying an animated preview of visual content of the second aggregated content item enables a user to quickly preview and select a next aggregated content item to be played, thereby reducing the number of inputs needed for viewing and selecting a next aggregated content item.

In some embodiments, subsequent to (e.g., in response to) detecting that playback of the visual content of the first aggregated content item meets one or more termination criteria (in some embodiments, prior to playing visual content of the second aggregated content item), the computer system displays, via the display generation component, a places object (e.g., 1282D, 1282E) corresponding to a geographic location and that is selectable to display one or more aggregated content item options corresponding to the geographic location. In some embodiments, the computer system displays the places object while continuing playing the audio content. In some embodiments, while displaying the places object, the computer system detects, via the one or more input devices, a selection input corresponding to selection of the places object; and in response to detecting the selection input, the computer system displays, via the display generation component, a first option representative of a fourth aggregated content item corresponding to the geographic location. In some embodiments, the computer system displays, via the display generation component, concurrently with the places object, a second places object corresponding to a second geographic location different from the geographic location and that is selectable to display one or more aggregated content item options corresponding to the second geographic location; while concurrently displaying the places object and the second places object, the computer system detects a selection input; and in response to detecting the selection input: in accordance with a determination that the selection input corresponds to selection of the places option, the computer system displays, via the display generation component, a first option representative of a fourth aggregated content item corresponding to the geographic location (e.g., without displaying the second option); and in accordance with a determination that the selection input corresponds to selection of the second places option, displaying, via the display generation component, a second option representative of a fifth aggregated content item corresponding to the second geographic location (e.g., without displaying the first option). Displaying a places object corresponding to a geographic location that is selectable to display one or more aggregated content item options corresponding to the geographic location enables a user to quickly view and select aggregated content items corresponding to a particular geographic location, thereby reducing the number of inputs needed for selecting a next aggregated content item.

In some embodiments, subsequent to (e.g., in response to) detecting that playback of the visual content of the first aggregated content item meets one or more termination criteria (in some embodiments, prior to playing visual content of the second aggregated content item), the computer system displays, via the display generation component, a first people object (e.g., 1282A, 1282B, 1282C) corresponding to a first person and that is selectable to display one or more aggregated content item options corresponding to the first person. In some embodiments, the computer system displays the first people object while continuing to play the audio content. In some embodiments, while displaying the first people object, the computer system detects, via the one or more input devices, a selection input corresponding to selection of the first people object; and in response to detecting the selection input, the computer system displays, via the display generation component, a first option representative of a fourth aggregated content item corresponding to the first person. In some embodiments, the computer system displays, via the display generation component, concurrently with the first people object, a second people object corresponding to a second person different from the first person and that is selectable to display one or more aggregated content item options corresponding to the second person; while concurrently displaying the first people object and the second people object, the computer system detects a selection input; and in response to detecting the selection input: in accordance with a determination that the selection input corresponds to selection of the first people option, the computer system displays, via the display generation component, a first option representative of a fourth aggregated content item corresponding to the first person (e.g., without displaying the second option); and in accordance with a determination that the selection input corresponds to selection of the second people option, displaying, via the display generation component, a second option representative of a fifth aggregated content item corresponding to the second person (e.g., without displaying the first option). Displaying a people object corresponding to a first person that is selectable to display one or more aggregated content item options corresponding to the first person enables a user to quickly view and select aggregated content items corresponding to a particular person, thereby reducing the number of inputs needed for selecting a next aggregated content item.

In some embodiments, the computer system displays, via the display generation component, a media library user interface (e.g., 1208). In accordance with a determination that a first setting (e.g., 1220) is enabled (e.g., a “show library” option), the media library user interface provides access to (e.g., displays, and/or displays one or more options that are selectable to cause display and/or initiate a process for displaying) a plurality of aggregated content items (e.g., 1210A, 1212A-1212E) including the first aggregated content item, and the media library that includes photos and/or videos taken by the user of the computer system (e.g., 1210D, 604). In accordance with a determination that the first setting (e.g., 1220) is disabled, the media library user interface provides access to the plurality of aggregated content items without providing access to the media library that includes photos and/or videos taken by the user of the computer system (e.g., provides access to the plurality of aggregated content items that are generated using the photos and/or videos in the media library, but does not provide access to the individual photos and/or videos and/or the full set of individual photos and/or videos that make up the media library). Providing a first setting that can remove access to the media library enhances security by restricting access to the media library by an unauthorized user. Providing improved security enhances the operability of the device and makes the user-device interface more efficient (e.g., by restricting unauthorized access) which, additionally, reduces power usage and improves battery life of the device by limiting the performance of restricted operations.

Note that details of the processes described above with respect to method 900 (e.g., FIG. 9) are also applicable in an analogous manner to the methods described above and/or below. For example, methods 700 and 1100 optionally include one or more of the characteristics of the various methods described above with reference to method 900. For example, the aggregated content item in each method 700, 900, 1100, can be the same aggregated content item. For brevity, these details are not repeated below.

FIGS. 10A-10S illustrate exemplary user interfaces for viewing representations of content items, in accordance with some embodiments. The user interfaces in these figures are used to illustrate the processes described below, including the processes in FIG. 11.

FIG. 10A depicts electronic device 600, which is a smartphone with touch-sensitive display 602. In some embodiments, electronic device 600 includes one or more features of devices 100, 300, and/or 500. Electronic device 600 depicts playback user interface 625, which was described above with reference to FIGS. 6A-6AG. In FIG. 10A, playback user interface 625 displays playback of a first aggregated content item, and displays a first media item 628A of the first aggregated content item, and electronic device plays audio track 1. In FIG. 10B, playback of the first aggregated media continues from FIG. 10A, with title information 627 moving from a first display region to a second display region. In FIG. 10B, while playing the first aggregated content item, electronic device 600 detects user input 1000 (e.g., a tap input and/or a non-tap input).

In FIG. 10C, in response to detecting user input 1000, electronic device 600 displays a plurality of selectable options 632A-632F, which were described above with reference to FIG. 6H. While displaying the plurality of selectable options 632A-632F, and maintaining playback of the first aggregated content item, electronic device 600 detects user input 1002 (e.g., a tap input) corresponding to selection of content grid option 632F.

In FIG. 10D, in response to detecting user input 1002, electronic device 600 pauses playback of the first aggregated content item (e.g., pauses visual and/or audio playback), and displays content grid user interface 1004. Content grid user interface 1004 includes close option 1006A, share option 1006B, and menu option 1006C. Close option 1006A is selectable to cease display of content grid user interface 1004 and return to playback user interface 625. Share option 1006B is selectable to initiate a process for sharing one or more media items of the first aggregated content item and/or for sharing the first aggregated content item via one or more communications mediums. Menu option 1006C is selectable to display a plurality of options, as will be described in greater detail in the next figure. Content grid user interface 1004 also includes a plurality of tiles 1008A-10080. Different ones of tiles 1008A-10080 are representative of different media items that are included in the first aggregated content item. Furthermore, tile 1008A-10080 are arranged in an order representative of the order in which the corresponding media items are configured to be presented during playback of the first aggregated content item. In FIG. 10D, while displaying content grid user interface 1004, electronic device 600 detects user input 1010 corresponding to selection of menu option 1006C.

In FIG. 10E, in response to user input 1010, electronic device 600 displays a plurality of selectable options 1012A-1012J. Option 1012A is selectable to initiate a process for selecting one or more media items (e.g., one or more tiles 1008A-10080 representative of one or more media items) in order to take various actions with the selected media items (e.g., share and/or delete the selected media items). Option 1012B is selectable to add the first aggregated content item to a favorites album. Option 1012C is selectable to initiate a process for changing the title of the first aggregated content item. Option 1012D is selectable to add one or more media items to the first aggregated content item. Option 1012E is selectable to delete the first aggregated content item. Option 1012F is selectable to cause electronic device 600 to modify its selection criteria for generating aggregated content items in the future so that fewer aggregated content items are generated that are similar to the first aggregated content item.

Options 1012G-1012J correspond to different duration options for the first aggregated content item, and are selectable to modify and/or specify a duration of the first aggregated content item. For example, the first aggregated content item currently has a duration corresponding to option 1012G (e.g., a short duration), and the specified duration is a duration of 10 media items. Option 1012H is selectable to increase the duration of the first aggregated content item by increasing the number of media items in the first aggregated content item (e.g., from 10 media items to 30 media items). Option 1012I is selectable to even further increase the duration of the first aggregated content item by increasing the number of media items in the first aggregated content item. In the depicted embodiment, option 1012I corresponds to a specific time duration (e.g., 1 minute 28 seconds), and the time duration corresponds to a maximum time duration that is allowable for sharing the first aggregated content item. Option 1012J is selectable to increase the duration of the first aggregated content item to match a duration of the audio track that has been applied to the first aggregated content item. In FIG. 10E, audio track 1 has been applied to the first aggregated content item, and has a duration of 3 minutes and 15 seconds. Accordingly, selection of option 1012J in FIG. 10E will cause the first aggregated content item to be modified (e.g., by adding and/or removing one or more media items, and/or modifying display durations for the media items in the first aggregated content item) to have a total duration of (e.g., approximately) 3 minutes and 15 seconds. However, because this duration is longer than 1 minute and 28 seconds, selection of option 1012J would prohibit the first aggregated content item from being shared with other users and/or devices. In FIG. 10J, electronic device 600 detects user input 1014 (e.g., a tap input) corresponding to selection of option 1012D.

In FIG. 10F, in response to detecting user input 1014 corresponding to selection of option 1012D, electronic device 600 displays add media items user interface 1015. Add media items user interface 1015 includes cancel option 1016A, that is selectable to cancel the add media items operation (e.g., and optionally, return to content grid user interface 1004), and done option 1016B that is selectable to add one or more selected content items to the first aggregated content item.

Add media items user interface 1015 includes a plurality of tiles 1018A-10180 representative of a plurality of media items (e.g., photos and/or videos) that are not currently included in the first aggregated content item. In the depicted embodiment, the plurality of media items that are represented in the add media items user interface 1015 are selected for inclusion in the add media items user interface 1015 based on content depicted in each media item, and the relevance of the media item to the first aggregated content item. Add media items user interface 1015 also includes option 1016C, that is selectable to display representations (e.g., tiles) of all photos in the user's media library, and option 1016D, that is selectable to display a plurality of media item collections (e.g., albums) stored on electronic device 600. In FIG. 10F, while displaying add media items user interface 1015, electronic device 600 detects user input 1020 (e.g., a tap input) corresponding to selection of tile 1018H.

In FIG. 10G, in response to detecting user input 1020, electronic device 600 displays selection indication 1022 on tile 1018H indicating that tile 1018H is currently selected. In FIG. 10H, while tile 1018H is selected, electronic device 600 detects user input 1024 corresponding to selection of done option 1016B.

In FIG. 10H, in response to detecting user input 1024, electronic device 600 ceases display of add media items user interface 1015, and re-displays content grid user interface 1004. Furthermore, in response to detecting user input 1024 while tile 1018 was selected, content grid user interface 1004 includes new tile 1008P representative of a new media item that was added to the first aggregated content item. In FIG. 10H, new tile 1008P is added to a position within content grid user interface 1004 (and, consequently, into the sequence of media items in the first aggregated content item) based on a date and/or time that the media item corresponding to tile 1008P was captured. In FIG. 10H, electronic device 600 detects user input 1026, which is a drag and drop gesture corresponding to tile 1008K.

In FIG. 10I, in response to drag and drop user input 1026, electronic device 600 displays tile 1008K moved from a first position within content grid user interface 1004 to a second position within content grid user interface 1004. As discussed above, content grid user interface 1004 displays tiles representative of media items in an order indicative of the order in which the media items will be presented during playback of the first aggregated content item. For example, in FIG. 10I, tile 1008A is displayed at a position corresponding to a first media item to be presented during playback of the first aggregated content item, and tile 1008B is displayed at a position corresponding to a second media item to be presented during playback of the first aggregated content item, and so forth. Accordingly, the media item corresponding to tile 1008K was previously presented, in FIG. 10H, at a position indicating that the media item would be presented as the 12th media item during playback of the first aggregated content item. However, after drag and drop user input 1026, tile 1008K is now presented, in FIG. 10I, at a position indicating that the media item will be presented as the 7th media item during playback of the first aggregated content item. Accordingly, in addition to adding and/or deleting media items from the first aggregated content item, content grid user interface 1004 allows a user to re-arrange the order in which media items will be presented during playback of the first aggregated content item (e.g., via one or more drag and drop user inputs). In FIG. 10I, electronic device 600 detects user input 1028 (e.g., a tap input) corresponding to selection of menu option 1006C.

In FIG. 10J, in response to user input 1028, electronic device 600 displays options 1012A-1012J. While displaying options 1012A-1012J, electronic device 600 detects user input 1030 (e.g., a tap input) corresponding to selection of option 1012A. In FIG. 10K, in response to user input 1030, electronic device 600 displays selection user interface 1032. Selection user interface 1032 allows a user to select one or more media items so that the user can take one or more actions with the selected media items. Selection user interface 1032 includes option 1034A, that is selectable to select all media items in the first aggregated content item, and option 1034B that is selectable to cease displaying selection user interface 1032 and, optionally, re-display content grid user interface 1004. Selection user interface 1032 also includes share option 1034C, that is selectable to initiate a process for sharing one or more selected media items, and delete option 1034D that is selectable to initiate a process for deleting one or more selected media items (e.g., remove the one or more selected media items from the first aggregated content item). In the depicted embodiments, share option 1034C and delete option 1034D are displayed even without any content items selected. In some embodiments, share option 1034C and delete option 1034D are not initially displayed and/or are not initially selectable, but become displayed and/or become selectable in response to one or more media items (e.g., one or more tiles 1008A-1008P) being selected. Selection user interface 1032 also includes a plurality of tiles 1008A-1008J, wherein each tile 1008A-1008J is representative of a respective media item that is included in the first aggregated content item. In FIG. 10J, while displaying selection user interface 1032, electronic device 600 detects user input 1036A, corresponding to selection of tile 1008B, and user input 1036B (e.g., a tap input), corresponding to selection of tile 1008E.

In FIG. 10L, in response to user inputs 1036A and 1036B, electronic device 600 displays selection indications 1038A and 1038B on tiles 1008B and 1008E, respectively, indicating that those two tiles are currently selected. In FIG. 10L, electronic device 600 detects user input 1040 (e.g., a tap input) corresponding to selection of share option 1034C.

In FIG. 10M, in response to user input 1040, electronic device 600 displays share user interface 1042. Share user interface 1042 includes close option 1048 that is selectable to cease displaying share user interface 1042 (e.g., and cancel a share operation). Share user interface 1042 includes options 1044A-1044D. Different ones of options 1044A-1044D correspond to different users or groups of users, and selection of a respective option 1044A-1044D initiates a process for sharing the selected media items with the corresponding user or group of users that is associated with the selected option. Share user interface 1042 also includes options 1046A-1046D. Different ones of options 1046A-1046D correspond to different communication mediums (e.g., option 1046A corresponds to near-field communications, option 1046B corresponds to SMS message and/or instant messaging, option 1046C corresponds to electronic mail, option 1046D corresponds to instant messaging). Selection of a respective option 1046A-1046D initiates a process for sharing the selected media items via the corresponding communication medium associated with the selection option. In FIG. 10M, electronic device 600 detects user input 1050 (e.g., a tap input) corresponding to selection of close option 1048.

In FIG. 10N, in response to detecting user input 1050, electronic device 600 ceases displaying share user interface 1042, and displays selection user interface 1032. In FIG. 10N, tiles 1008B and 1008E continue to remain selected. In FIG. 10N, electronic device 600 detects user input 1052 (e.g., a tap input) corresponding to selection of delete option 1034D.

In FIG. 10O, in response to detecting user input 1052, electronic device 600 displays options 1054A, 1054B. Option 1054A is selectable to remove the two selected media items from the first aggregated content item. Option 1054B is selectable to delete the two selected media items from the user's media library. In FIG. 10O, electronic device 600 detects user input 1056 (e.g., a tap input) corresponding to selection of option 1054A.

In FIG. 10P, in response to user input 1056, electronic device displays content grid user interface 1004. In content grid user interface 1004, in response to user input 1056, tiles 1008B and 1008E have been removed, indicating that the media items associated with these tiles have been removed from the first aggregated content item.

As shown above, content grid user interface 1004 and various options presented within content grid user interface 1004 allows a user to add, remove, and/or re-order media items within the first aggregated content item. Furthermore, addition, removal, and/or re-ordering of media items within the first aggregated content item can also cause a change in visual transitions presented between media items during playback of the first aggregated content item. For example, in some embodiments, visual transitions between two adjacent media items in the first aggregated content item can be selected based on a level of similarity between the two media items. For example, if the two media items are determined to be similar, visual transitions of a first type may be used between the two media items, whereas if the two media items are determined not to be substantially similar, then visual transitions of a second type may be used between the two media items.

In FIG. 10P, electronic device 600 detects user input 1058 (e.g., a tap input), corresponding to selection of tile 1008G. In FIG. 10Q, in response to user input 1058, electronic device ceases displaying content grid user interface 1004, and displays playback of the first aggregated content item within playback user interface 625. Tile 1008G was representative of media item 628H, a picture of a fireplace with a marshmallow. In response to user input 1058 selecting tile 1008G in content grid user interface 1004, electronic device 600 re-starts playback of the first aggregated content item starting with media item 628H. In FIG. 10R, playback of the first aggregated content item continues, as display of media item 628H transitions into display of a next media item 628J. In FIG. 10S, playback of the first aggregated content item has progressed until a final media item 628Z is displayed, and next content item user interface 800 (discussed above) is displayed.

FIG. 11 is a flow diagram illustrating a method for viewing representations of content items using a computer system in accordance with some embodiments. Method 1100 is performed at a computer system (e.g., 100, 300, 500) (e.g., a smart phone, a smart watch, a tablet, a digital media player; a computer set top entertainment box; a smart TV; and/or a computer system controlling an external display) that is in communication with a display generation component (e.g., a display controller; a touch-sensitive display system; and/or a display (e.g., integrated and/or connected)) and one or more input devices (e.g., a touch-sensitive surface (e.g., a touch-sensitive display); a mouse; a keyboard; and/or a remote control). Some operations in method 1100 are, optionally, combined, the orders of some operations are, optionally, changed, and some operations are, optionally, omitted.

As described below, method 1100 provides an intuitive way for viewing and editing content items. The method reduces the cognitive burden on a user for viewing and editing content items, thereby creating a more efficient human-machine interface. For battery-operated computing devices, enabling a user to view and edit content items faster and more efficiently conserves power and increases the time between battery charges.

The computer system plays (1102), via the display generation component, visual content of a first aggregated content item (e.g., 628A, FIGS. 10A-0C) (e.g., displays, via the display generation component, visual content of the first aggregated content item) (e.g., a video and/or a content item automatically generated from a plurality of content items) (in some embodiments, the computer system plays visual content and audio content of the first aggregated content item), wherein the first aggregated content item comprises an ordered sequence of a first plurality of content items that are selected (e.g., automatically and/or without user input) from a set of content items based on a first set of selection criteria (e.g., the first aggregated content item depicts an ordered sequence of a plurality of photos and/or videos and/or an automatically generated collection of photos and/or videos (e.g., a collection of photos and/or videos that are automatically aggregated and/or selected from the set of content items based on one or more shared characteristics)). In some embodiments, the plurality of photos and/or videos that make up the first plurality of content items are selected from a set of photos and/or videos that are associated with the computer system (e.g., stored on the computer system, associated with a user of the computer system, and/or associated with a user account associated with (e.g., signed into) the computer system).

While playing the visual content of the first aggregated content item (1104), the computer system detects (1106), via the one or more input devices, a user input (e.g., 1002) (e.g., a gesture (e.g., via a touch-sensitive display and/or a touch-sensitive surface) (e.g., a tap gesture, a swipe gesture) and/or a voice input) (e.g., a user input corresponding to selection of an option and/or a user input corresponding to a request to pause playback of the first aggregated content item).

In response to detecting the user input (1108), the computer system pauses (1110) playback of the visual content of the first aggregated content item (e.g., freezing and/or ceasing video playback of the visual content of the first aggregated content item); and displays (1112), via the display generation component, a user interface (e.g., 1004) (e.g., replacing display of the visual content of the first aggregated content item with display of the user interface, and/or overlaying the user interface on the visual content of the first aggregated content item), wherein displaying the user interface includes concurrently displaying a plurality of representations of content items in the first plurality of content items (e.g., without displaying content items that are not in the first plurality of content items), including: a first representation of a first content item (e.g., 1008A-10080) of the first plurality of content items, and a second representation of a second content item (e.g., 1008A-10080) of the first plurality of content items. In some embodiments, the user input is detected while a respective content item of the plurality of content items is being displayed (e.g., within and/or as part of playback of the first aggregated content item). In some embodiments, the user interface includes a representation of the respective content item. In some embodiments, in accordance with a determination that the user input was detected while the respective content item was displayed, the user interface includes a representation of the respective content item. Displaying the user interface including concurrently displaying the plurality of representations of content items in the first plurality of content items provides the user with feedback about the current state of the device (e.g., that the first aggregated content item being played by the device includes the first plurality of content items).

In some embodiments, the first content item corresponds to a first playback position (e.g., a first playback time) of the first aggregated content item. In some embodiments, the second content item corresponds to a second playback position (e.g., a second playback time) of the first aggregated content item different from the first playback position. In some embodiments, while concurrently displaying the first representation of the first content item (e.g., 1008A-10080) and the second representation of the second content item (e.g., 1008A-10080), the computer system detects, via the one or more input devices, a selection input (e.g., 1058) (e.g., one or more tap inputs and/or one or more non-tap inputs). In response to detecting the selection input: in accordance with a determination that the selection input corresponds to selection of the first representation of the first content item (e.g., a tap input on the first representation of the first content item and/or a remote control input while the first representation of the first content item is selected and/or in focus), the computer system plays visual content of the first aggregated content item from the first playback position (e.g., FIGS. 10P-10Q); and in accordance with a determination that the selection input corresponds to selection of the second representation of the second content item (e.g., a tap input on the second representation of the second content item and/or a remote control input while the second representation of the second content item is selected and/or in focus), the computer system plays visual content of the first aggregated content item from the second playback position (e.g., FIGS. 10P-10Q). In some embodiments, in response to detecting the selection input: in accordance with a determination that the selection input corresponds to selection of the first representation of the first content item, the computer system plays visual content of the first aggregated content item from the first playback position, and plays audio content from a third playback position that corresponds to the first playback position of the visual content; and in accordance with a determination that the selection input corresponds to selection of the second representation of the second content item, the computer system plays visual content of the first aggregated content item from the second playback position, and plays audio content from a fourth playback position that corresponds to the second playback position of the visual content. Playing visual content from the first playback position or from the second playback position based on the selection input enables a user to quickly navigate to a particular playback position in the first aggregated content item, thereby reducing the number of inputs needed for navigating to a particular playback position in the first aggregated content item.

In some embodiments, the computer system displays, via the display generation component, an add content option (e.g., 1012D) that is selectable to initiate a process for adding one or more content items to the first aggregated content item. While displaying the add content option, the computer system detects, via the one or more input devices, a second selection input (e.g., 1014) (e.g., one or more tap inputs and/or one or more non-tap inputs) corresponding to selection of the add content option. In response to detecting the second selection input, the computer system displays, via the display generation component, representations of a plurality of content items (e.g., 1018A-10180) that are not included in the first aggregated content item, including concurrently displaying: a third representation of a third content item (e.g., 1018A-10180), and a fourth representation of a fourth content item (e.g., 1018A-10180). In some embodiments, the computer system ceases display of the plurality of representations of content items in the first plurality of content items and/or replaces display of the plurality of representations of content items in the first plurality of content items with display of representations of the plurality of content items that are not included in the first aggregated content item (e.g., a view of a media library of the user). While concurrently displaying the third representation of the third content item and the fourth representation of the fourth content item, the computer system detects, via the one or more input devices, a first set of inputs (e.g., 1020, 1024) (e.g., one or more tap inputs and/or one or more non-tap inputs) corresponding to a request to add the third content item to the first aggregated content item (e.g., without adding the fourth content item to the first aggregated content item). In response to detecting the first set of inputs, the computer system modified the first aggregated content item to include the third content item (e.g., FIG. 10H, adding new tile 1008P representative of a new media item being added to the first aggregated content item) (e.g., without adding the fourth content item to the first aggregated content item). In some embodiments, the computer system ceases display of the plurality of representations of content items in the first plurality of content items and/or replaces display of the plurality of representations of content items in the first plurality of content items with display of representations of the plurality of content items that are not included in the first aggregated content item (e.g., a view of a media library of the user). Modifying the first aggregated content item to include the third content item in response to the first set of inputs enables a user to quickly add content items to the first aggregated content item, thereby reducing the number of inputs needed for adding content items to the first aggregated content item.

In some embodiments, displaying the third representation of the third content item (e.g., 1018A-10180) comprises: in accordance with a determination that the third content item satisfies one or more relevance criteria with respect to the first aggregated content item (e.g., based on metadata associated with the third content item (e.g., location data and/or time data) (e.g., location data associated with the third content item corresponds to location data for the first aggregated content item and/or time data associated with the third content item corresponds to time data for the first aggregated content item)), displaying the representation of the third content item in a first manner (e.g., highlighting the representation of the third content item (e.g., displaying the third content item with a first set of colors and/or at a first brightness level)); and in accordance with a determination that the third content item does not satisfy the one or more relevance criteria with respect to the first aggregated content item (e.g., based on metadata associated with the third content item (e.g., location data and/or time data) (e.g., location data associated with the third content item does not correspond to location data for the first aggregated content item and/or time data associated with the third content item does not correspond to time data for the first aggregated content item)), displaying the representation of the third content item in a second manner different from the first manner (e.g., visually deemphasizing the representation of the third content item (e.g., displaying the third content item with a second set of color and/or at a second brightness level (e.g., darker than the first brightness level))). In some embodiments, displaying the fourth representation of the fourth content item (e.g., 1018A-10180) comprises: in accordance with a determination that the fourth content item satisfies the one or more relevance criteria with respect to the first aggregated content item (e.g., based on metadata associated with the fourth content item (e.g., location data and/or time data) (e.g., location data associated with the fourth content item corresponds to location data for the first aggregated content item and/or time data associated with the fourth content item corresponds to time data for the first aggregated content item)), displaying the representation of the fourth content item in the first manner; and in accordance with a determination that the fourth content item does not satisfy the one or more relevance criteria with respect to the first aggregated content item (e.g., based on metadata associated with the fourth content item (e.g., location data and/or time data) (e.g., location data associated with the fourth content item does not correspond to location data for the first aggregated content item and/or time data associated with the fourth content item does not correspond to time data for the first aggregated content item)), displaying the representation of the fourth content item in the second manner. Displaying the fourth content item in the first manner in accordance with a determination that the fourth content item satisfies the one or more relevance criteria provides the user with feedback about the current state of the device (e.g., that the device has determined that the fourth content item satisfies the one or more relevance criteria with respect to the first aggregated content item).

In some embodiments, the computer system displays, via the display generation component, a related content option (e.g., 1012D) that is selectable to initiate a process for displaying additional content related to the first aggregated content item (e.g., selection of add photos option 1012D displays (e.g., in FIG. 10F) additional photos that are determined to be relevant to the first aggregated content item) (e.g., one or more photos and/or videos that are not currently included in the first aggregated content item and satisfy one or more relevance criteria with respect to the first aggregated content item). While displaying the related content option (e.g., 1012D), the computer system detects, via the one or more input devices, a third selection input (e.g., 1014) (e.g., one or more tap inputs and/or one or more non-tap inputs) corresponding to selection of the related content option. In response to detecting the third selection input: in accordance with a determination that a fifth content item of a media library (e.g., a media library of photos and/or videos taken by a user of the computer system (e.g., using a camera of the computer system or one or more cameras of other devices associated with the user, scanned physical photos taken by the user and/or uploaded from a dedicated digital camera)) is not included in the first aggregated content item and satisfies one or more relevance criteria with respect to the first aggregated content item (e.g., based on metadata associated with the fifth content item (e.g., location data and/or time data) (e.g., location data associated with the fifth content item corresponds to location data for the first aggregated content item and/or time data associated with the fifth content item corresponds to time data for the first aggregated content item)), the computer system displays, via the display generation component, a representation of the fifth content item (e.g., 1018A-10180); and in accordance with a determination that the fifth content item of the media library does not satisfy the one or more relevance criteria with respect to the first aggregated content item (e.g., based on metadata associated with the fifth content item (e.g., location data and/or time data) (e.g., location data associated with the fifth content item does not correspond to location data for the first aggregated content item and/or time data associated with the fifth content item does not correspond to time data for the first aggregated content item)), the computer system forgoes displaying the representation of the fifth content item. In some embodiments, in response to detecting the third selection input, the computer system displays representations of one or more content items (e.g., representations of a plurality of content items) that are not included in the first aggregated content item and satisfy one or more relevance criteria with respect to the first aggregated content item, and forgoes displaying representations of one or more content items (forgoes displaying representations for a plurality of content items) that do not satisfy the one or more relevance criteria with respect to the first aggregated content item. Displaying the representation of the fifth content item in accordance with a determination that the fifth content item is not included in the first aggregated content item and satisfies one or more relevance criteria with respect to the first aggregated content item enables a user to quickly view content items that are not in the first aggregated content item and satisfy relevance criteria with respect to the first aggregated content item, thereby reducing the number of inputs needed for viewing such content items.

In some embodiments, while displaying the plurality of representations of content items in the first plurality of content items (e.g., 1008A-1008P), the computer system detects, via the one or more input devices, a fourth selection input (e.g., 1036A, 1036B) (e.g., one or more tap inputs and/or one or more non-tap inputs) corresponding to selection of one or more content items of the first plurality of content items including the first content item. In response to detecting the fourth selection input, the computer system displays, via the display generation component, a share option (e.g., 1034C) that is selectable to initiate a process for sharing (e.g., to one or more external computer systems and/or one or more users) the selected one or more content items via one or more communication mediums (e.g., text message, electronic mail, near field wireless communication and/or file transfer, uploading to a shared media album, and/or uploading to a third party platform). In some embodiments, while displaying the share option (e.g., and while the one or more content items are selected), the computer system detects, via the one or more input devices, a selection input corresponding to selection of the share option; and in response to detecting the selection input, the computer system displays, via the display generation component, a share user interface, wherein displaying the share user interface comprises concurrently displaying: a first option that is selectable to initiate a process for sharing the selected one or more content items via a first communication medium (e.g., text message, electronic mail, near field wireless communication and/or file transfer, uploading to a shared media album, and/or uploading to a third party platform); and a second option that is selectable to initiate a process for sharing the selected one or more content items via a second communication medium different from the first communication medium. Displaying a share option that is selectable to initiate a process for sharing the selected one or more content items via one or more communication mediums enables a user to quickly share content items, thereby reducing the number of inputs needed to share content items.

In some embodiments, while displaying the plurality of representations of content items in the first plurality of content items (e.g., 1008A-1008P), the computer system detects, via the one or more input devices, a fifth selection input (e.g., 1036A, 1036B) (e.g., one or more tap inputs and/or one or more non-tap inputs) corresponding to selection of one or more content items of the first plurality of content items including the first content item. In response to detecting the fifth selection input, the computer system displays, via the display generation component, a remove option (e.g., 1034D) that is selectable to initiate a process for removing the selected one or more content items from the first aggregated content item (e.g., such that the removed content items are no longer displayed when the first aggregated content item is played). In some embodiments, subsequent to displaying the remove option (e.g., while displaying the remove option), the computer system detects, via the one or more input devices, one or more inputs corresponding to a request to remove the selected one or more content items from the first aggregated content item; and in response to detecting the one or more inputs, the computer system modifies the first aggregated content item to remove the selected one or more content items. Displaying a remove option that is selectable to initiate a process for removing the selected one or more content items from the first aggregated content item enables a user to quickly remove items from the first aggregated content item, thereby reducing the number of inputs needed to remove content items from the first aggregated content item.

In some embodiments, prior to displaying the user interface, the first content item is positioned at a first sequential position in the ordered sequence of the first plurality of content items. In some embodiments, playing the visual content of the first aggregated content item includes sequentially displaying the content items of the first plurality of content items according to the ordered sequence. In some embodiments, displaying the user interface comprises displaying the first representation of the first content item at a first display position corresponding to the first sequential position (e.g., tile 1008A, representative of media item 628A, is displayed at a first position, tile 1008K, representative of a media item, is displayed at an 11^{th} position). While displaying the plurality of representations of content items in the first plurality of content items, the computer system detects, via the one or more input devices, a gesture (e.g., 1026) (e.g., a hold and drag gesture and/or a different gesture) corresponding to the first representation of the first content item (e.g., 1008K). In response to detecting the gesture: the computer system moves the first representation of the first content item from the first display position to a second display position different from the first display position (e.g., FIGS. 10H-10I, tile 1008K moves from one position to another based on user input 1026), wherein the second display position corresponds to a second sequential position in the ordered sequence of the first plurality of content items (e.g., moving the representation of the first content item according to the gesture). The computer system reorders the ordered sequence of the first plurality of content items, including moving the first content item from the first sequential position to the second sequential position. The computer system modifies the first aggregated content item based on the reordering of the ordered sequence of the first plurality of content items (e.g., changing the sequence in which content items of the first plurality of content items are displayed during playing of visual content of the first aggregated content item (e.g., based on movement of the first content item from the first sequential position to the second sequential position in the ordered sequence)). Modifying the first aggregated content item based on a gesture moving a representation of a first content item from a first display position to a second display position enables a user to quickly reorder content items in the first aggregated content item, thereby reducing the number of inputs needed to reorder content items in the first aggregated content item.

In some embodiments, while displaying the user interface (e.g., 1004), the computer system detects, via the one or more input devices, a set of user inputs (e.g., 1010) (e.g., one or more tap inputs and/or one or more non-tap inputs). In response to detecting the set of user inputs, the computer system concurrently displays, via the display generation component: a first content length option (e.g., 1012G) corresponding to a first number of content items (e.g., 10 content items, 15 content items, and/or 20 content items), wherein displaying the first content length option comprises displaying the first number of content items (in some embodiments, the first number of content items is indicative of the number of content items to be included in the first aggregated content item if the first content length option is selected); and a second content length option (e.g., 1012H) corresponding to a second number of content items different from the first number of content items (e.g., 25 content items, 30 content items, and/or 35 content items), wherein displaying the second content length option comprises displaying the second number of content items (in some embodiments, the second number of content items is indicative of the number of content items to be included in the first aggregated content item if the second content length option is selected). In some embodiments, while concurrently displaying the first content length option and the second content length option, the computer system detects, via the one or more input devices, a selection input; and in response to detecting the selection input: in accordance with a determination that the selection input corresponds to selection of the first content length option, the computer system modifies the first aggregated content item to include the first number of content items (e.g., adding content items to and/or removing content items from the first aggregated content item so that the first aggregated content item includes (e.g., exactly) the first number of content items); and in accordance with a determination that the selection input corresponds to selection of the second content length option, the computer system modifies the first aggregated content item to include the second number of content items (e.g., adding content items to and/or removing content items from the first aggregated content item so that the first aggregated content item includes (e.g., exactly) the second number of content items). Displaying a first content length option and a second content length option enables a user to quickly modify the length of the first aggregated content item, thereby reducing the number of inputs needed to modify the length of the first aggregated content item.

In some embodiments, while displaying the user interface (e.g., 1004), the computer system detects, via the one or more input devices, a second set of user inputs (e.g., 1010) (e.g., one or more tap inputs and/or one or more non-tap inputs). In response to detecting the second set of user inputs: the computer system concurrently displays, via the display generation component: a third content length option (e.g., 1012G) corresponding to a first number of content items (e.g., a first playback duration); and a fourth content length option (e.g., 1012H) corresponding to a second number of content items different from the first number of content items (e.g., a second playback duration different from the first playback duration). While concurrently displaying the third content length option (e.g., 1012G) and the fourth content length option (e.g., 1012H), the computer system detects, via the one or more input devices, a sixth selection input (e.g., one or more tap inputs and/or one or more non-tap inputs). In response to detecting the sixth selection input: in accordance with a determination that the sixth selection input corresponds to selection of the third content length option, the computer system modifies the user interface (e.g., 1004) to display representations of the first number of content items (e.g., display exactly the first number of content items); and in accordance with a determination that the sixth selection input corresponds to selection of the fourth content length option, the computer system modifies the user interface (e.g., 1004) to display representations of the second number of content items (e.g., display exactly the second number of content items). Modifying the user interface to display representations of the first number of content items or the second number of content items in response to the sixth selection input provides the user with feedback about the current state of the device (e.g., that the device has modified the first aggregated content item to include the first number of content items or the second number of content items in response to the sixth selection input).

In some embodiments, subsequent to displaying the user interface (e.g., 1004) (e.g., while displaying the user interface), the computer system detects, via the one or more input devices, a third set of inputs (e.g., 1014, 1020, 1024, 1036A, 1036B, 1052, 1056) (e.g., one or more tap inputs and/or one or more non-tap inputs) corresponding to a request to add a first set of one or more additional content items to the first aggregated content item and/or remove a first set of one or more removed content items from the first aggregated content item. In response to detecting the third set of inputs, the computer system modifies the first aggregated content item to include the one or more additional content items and/or modifying the first aggregated content item to exclude one or more removed content items (e.g., FIGS. 10H, 10P). After modifying the first aggregated content item to include the one or more additional content items, the computer system detects, via the one or more input devices, a fourth set of inputs (e.g., one or more tap inputs and/or one or more non-tap inputs) corresponding to a request to modify a duration of the first aggregated content item. In response to detecting the fourth set of inputs, the computer system changes a duration of the first aggregated content item including adding a second set of one or more additional content items to the first aggregated content item based on the change in duration of the first aggregated content item and/or removing a second set of one or more removed content items from the first aggregated content item based on the change in duration of the first aggregated content item. Automatically adding or removing content from the first aggregated content item in response to a user input corresponding to a request to modify the duration of the first aggregated content item allows a user to quickly and effectively modify the duration of the first aggregated content item without further user input.

In some embodiments, in response to detecting the fourth set of inputs, in accordance with a determination that the fourth set of inputs includes a request to decrease the duration of the first aggregated content item, the computer system reduces the duration of the first aggregated content item by removing the second set of removed content items without removing any of the first set of one or more additional content item (e.g., removes the second set of removed content items without removing tile 1008P, which has been manually added by a user). Automatically removing content from the first aggregated content item in response to a user input corresponding to a request to modify the duration of the first aggregated content item allows a user to quickly and effectively modify the duration of the first aggregated content item without further user input.

In some embodiments, in response to detecting the fourth set of inputs, in accordance with a determination that the fourth set of inputs includes a request to increase the duration of the first aggregated content item, the computer system increases the duration of the first aggregated content item by adding the second set of additional content items without adding any of the first set of one or more removed content item (e.g., adds the second set of additional content items without adding the media items corresponding to tiles 1008B and 1008E, which have been manually removed by a user). Automatically adding or removing content from the first aggregated content item in response to a user input corresponding to a request to modify the duration of the first aggregated content item allows a user to quickly and effectively modify the duration of the first aggregated content item without further user input.

In some embodiments, playing the visual content of the first aggregated content item comprises: displaying, via the display generation component, the first content item; and subsequent to displaying the first content item, (e.g., immediately after displaying the first content item and/or while displaying the first content item) displaying, via the display generation component, a transition from the first content item to the second content item (e.g., a subsequent content item and/or a next content item in the ordered sequence of the first plurality of content items), wherein: in accordance with a determination that the second content item satisfies one or more similarity criteria with respect to the first content item (e.g., similarity in content, similarity in location, and/or similarity in date and/or time of capture), the transition from the first content item to the second content item is of a first visual transition type (e.g., transitions between media items represented by tiles 1008C, 1008D, 1008E, and 1008P are of the first visual transition type based on similarities between these media items) (e.g., a crossfade, a fade to black, an exposure bleed, a pan, a scale, and/or a rotate); and in accordance with a determination that the second content item does not satisfy the one or more similarity criteria with respect to the first content item, the transition from the first content item to the second content item is of a second visual transition type different from the first visual transition type (e.g., transitions between media items represented by tiles 1008P and 1008K in FIG. 10K are of the second visual transition type based on a lack of similarity between these media items) (e.g., a crossfade, a fade to black, an exposure bleed, a pan, a scale, and/or a rotate). Automatically selecting transition types based on similarity criteria between content items improves the quality of visual transitions suggested to a user and allows a user to apply transition types without further user input.

In some embodiments, the one or more similarity criteria includes one or more of: a time-based similarity criteria (e.g., similarity in date and/or time when content items were captured); a location-based similarity criteria (e.g., similarity in geographic location where content items were captured); and/or a content-based similarity criteria (e.g., similarity in content depicted in the content items). Automatically selecting transition types based on time-based similarity criteria, location-based similarity criteria, and/or content-based similarity criteria improves the quality of visual transitions suggested to a user, and allows a user to apply transition types without further user input.

In some embodiments, the transition from the first content item to the subsequent content item is of the first visual transition type; and playing the visual content of the first aggregated content item further comprises: subsequent to displaying the transition from the first content item to the second content item (e.g., immediately after displaying the transition from the first content item to the second content item and/or while displaying the transition from the first content item to the second content item), displaying, via the display generation component, the second content item; subsequent to displaying the second content item (e.g., immediately after displaying the second content item and/or while displaying the second content item), displaying, via the display generation component, a transition from the second content item to a third content item different from the first and second content items (e.g., a subsequent content item and/or a next content item in the ordered sequence of the first plurality of content item), wherein: in accordance with a determination that the third content item satisfies one or more similarity criteria with respect to the second content item, the transition from the second content item to the third content item is of the first visual transition type (e.g., a crossfade, a fade to black, an exposure bleed, a pan, a scale, and/or a rotate) (e.g., maintain the same transition type between the first and second content item and between the second and third content items based on similarity between the first, second, and third content items). Automatically selecting transition types based on similarity criteria between content items improves the quality of visual transitions suggested to a user and allows a user to apply transition types without further user input.

In some embodiments, displaying the transition from the second content item to the third content item further comprises: wherein, in accordance with a determination that the third content item does not satisfy the one or more similarity criteria with respect to the second content item, the transition from the first content item to the second content item is of a third visual transition type different from the first visual transition type (e.g., a crossfade, a fade to black, an exposure bleed, a pan, a scale, and/or a rotate). Automatically selecting transition types based on similarity criteria between content items improves the quality of visual transitions suggested to a user and allows a user to apply transition types without further user input.

In some embodiments, while playing the visual content of the first aggregated content item (e.g., FIGS. 10A-10C, media item 628A), the computer system plays audio content (e.g., track 1, FIGS. 10A-10C) that is separate from the first plurality of content items (e.g., an audio track that is overlaid on the first aggregated content item and/or played while visual content of the first aggregated content item is played and/or displayed) (e.g., outputting and/or causing output (e.g., via one or more speakers, one or more headphones, and/or one or more earphones) of an audio track while the visual content of the first aggregated content item is being displayed via the display generation component). In some embodiments, the computer system also plays audio content that corresponds to and/or is part of the first aggregated content item (e.g., audio from one or more videos incorporated into the aggregated content item). Playing audio content while playing the visual content of the first aggregated content item provides the user with feedback about the current state of the device (e.g., that the device is currently playing the visual content of the first aggregated content item).

In some embodiments, displaying the user interface (e.g., 1222 in FIG. 12D) includes concurrently displaying, via the display generation component: paused visual content of the first aggregated content item (e.g., 1224A, FIG. 12D); and a video navigation user interface element (e.g., 1228) (e.g., a scrubber bar) for navigating through (e.g., a plurality of frames (e.g., images) of) the visual content of the first aggregated content item, wherein the first representation of the first content item (e.g., 1230A-1230I) and the second representation of the second content item (e.g., 1230A-1230I) are concurrently displayed as part of the video navigation user interface element. In some embodiments, the video navigation user interface element comprises representations of the first plurality of content items in the first aggregated content item (e.g., representations of each content item of the first plurality of content items (e.g., a respective representation for each content item of the first plurality of content items)). In some embodiments, the user input corresponds to a request to pause playback of the visual content of the first aggregated content item, and the video navigation user interface element is displayed in response to detecting the user input. In some embodiments, the user input is a user input detected via a remote control. Displaying a navigation user interface element for navigating through the visual content of the first aggregated content item enables a user to quickly navigate through the visual content of the first aggregated content item, thereby reducing the number of inputs required to navigate through the first aggregated content item.

In some embodiments, while displaying the video navigation user interface element (e.g., 1228), including concurrently displaying the first representation of the first content item (e.g., 1230A-1230I) and the second representation of the second content item (e.g., 1230A-1230I), the computer system detects, via the one or more input devices, a first set of navigation inputs (e.g., 1234, 1238) (e.g., one or more swipe gesture inputs and/or one or more directional inputs). In response to detecting the first set of navigation inputs: at a first time (e.g., at a start of the first set of navigation inputs), the computer system concurrently displays, via the display generation component: the first representation of the first content item in a first manner (e.g., tile 1230B in FIG. 12E) (e.g., visually emphasized and/or highlighted (e.g., having an increased brightness level and/or increased color saturation relative to one or more other representations of content items in the video navigation user interface element (e.g., relative to all other representations of content items in the video navigation user interface element))) (e.g., a first manner indicative of the first representation of the first content item currently being selected and/or in focus); and the second representation of the second content item in a second manner (e.g., tile 1230A in FIG. 12E) different from the first manner (e.g., visually de-emphasized relative to the first manner (e.g., having a decreased brightness level and/or decreased color saturation relative to the first manner)) (e.g., a second manner indicative of the second representation of the second content item not being currently selected and/or in focus). At a second time subsequent to the first time (e.g., in the middle and/or at the end of the first set of navigation inputs), the computer system concurrently displays, via the display generation component: the first representation of the first content item in the second manner (e.g., tile 1230B in FIG. 12H); and the second representation of the second content item in the first manner (e.g., tile 1230A in FIG. 12H) (e.g., in response to detecting the first set of navigation inputs, the computer system shows image thumbnails sequentially highlighted in accordance with the first set of navigation inputs (e.g., in accordance with a translation speed and/or direction of the first set of navigation inputs)). Displaying different representations of content items in the first manner based on which content item is currently selected and/or in focus provides the user with feedback about the current state of the device (e.g., informing the user as to which content item is currently selected and/or in focus).

In some embodiments, prior to detecting the one or more navigation inputs (e.g., 1234, 1238), the computer system concurrently displays, via the display generation component: the first representation of the first content item in the first manner (e.g., tile 1230B in FIG. 12D); and the second representation of the second content item in the first manner (e.g., tile 1230A in FIG. 12D). In some embodiments, prior to detecting the one or more navigation inputs, the video navigation user interface element (e.g., the video scrubber) is displayed with all representations of content items displayed in the first manner (e.g., all image thumbnails shown in the first manner (e.g., highlighted, visually emphasized, and/or at a particular brightness level and/or color saturation)); and after detecting the one or more navigation inputs, a single representation of a content item is displayed in the first manner at any given time while all other representations of content items are displayed in the second manner (e.g., visually de-emphasized, and/or at a second brightness level and/or color saturation). Displaying all representations of content items in the first manner prior to detecting one or more navigation inputs provides the user with feedback about the current state of the device (e.g., the device has not detected any navigation inputs after displaying the video navigation user interface element).

In some embodiments, after concurrently displaying the paused visual content of the first aggregated content item (e.g., 1224A, FIG. 12D) and the video navigation user interface element (e.g., 1228, FIG. 12D), in accordance with a determination that one or more fading criteria have been met (e.g., in accordance with a determination that one or more inputs of certain types have not been detected for a threshold duration of time), the computer system ceases display of the video navigation user interface element. In some embodiments, the computer system ceases display of the video navigation user interface element while maintaining display of the paused visual content of the first aggregated content item. In some embodiments, after ceasing display of the video navigation user interface element, the computer system detects, via the one or more input devices, one or more user inputs; and in response to detecting the one or more user inputs, the computer system re-displays, via the display generation component, the video navigation user interface element. Ceasing display of the video navigation user interface element in accordance with a determination that one or more fading criteria have been met provides the user with feedback about the current state of the device (e.g., the device has determined that the one or more fading criteria have been met).

In some embodiments, while concurrently displaying the paused visual content of the first aggregated content item (e.g., 1224A, FIG. 12D) and the video navigation user interface element (e.g., 1228), the computer system detects, via the one or more input devices, a second set of one or more navigation inputs (e.g., 1234, 1238) (e.g., one or more swipe gesture inputs and/or one or more directional inputs). In response to detecting the second set of one or more navigation inputs: in response to detecting a first portion of the second set of one or more navigation inputs (e.g., 1234), the computer system replaces display of the paused visual content of the first aggregated content item with display of the first content item (e.g., FIG. 12E, replacing display of media item 1224A with media item 1224B) (e.g., at a first time when the representation of the first content item is selected and/or in focus in the video navigation user interface element); and in response to detecting a second portion of the second set of one or more navigation inputs (e.g., 1238), the computer system replaces display of the first content item (e.g., media item 1224B in FIG. 12G) with display of the second content item (e.g., media item 1224A in FIG. 12H) (e.g., at a second time when the second representation of the second content item is selected and/or in focus in the video navigation user interface element). Displaying the first content item when the representation of the first content item is selected, and displaying the second content item when the representation of the second content item is selected provides the user with feedback about the current state of the device (e.g., providing the user with feedback about which content item is currently selected and/or in focus).

Note that details of the processes described above with respect to method 1100 (e.g., FIG. 11) are also applicable in an analogous manner to the methods described above. For example, methods 700 and 900 optionally include one or more of the characteristics of the various methods described above with reference to method 1100. For example, the aggregated content item in each method 700, 900, 1100, can be the same aggregated content item. For brevity, these details are not repeated below.

FIGS. 12A-12W illustrate exemplary user interfaces for viewing and editing content items, in accordance with some embodiments. The user interfaces in these figures are used to illustrate the processes described above, including the processes in FIGS. 7, 9, and 11.

FIG. 12A illustrates electronic device 1200 (e.g., device 100, 300, 500) displaying media browsing user interface 1208 on display 802 (e.g., a smart television (e.g., a computer system with dedicated media playback functionality) (e.g., a device having one or more features of device 100, 300, or 500)), a television connected to a digital media player (e.g., a computer system with dedicated media playback functionality (e.g., a device having one or more features of device 100, 300, or 500))). In some embodiments, display 1202 is an integrated part of electronic device 1200. In some embodiments, electronic device 1200 is a separate digital media player that is in communication (e.g., wireless, wired) with display 1202.

FIG. 12A also illustrates remote control 1204, which is configured to transmit data (e.g., via RF communication, via Bluetooth, via infrared) to electronic device 1200 based on user input that is detected at remote control 1204. Remote control 1204 includes a selection region 1206A, which includes a touch-sensitive surface for detecting tap, press, and swipe gestures, a back button 1206B, a television button 1206C, a play/pause button 1206D, volume control buttons 1206E, a mute button 1206F, and a power button 1206G.

Media browsing user interface 1208 includes selectable options 1210A, 1210B, 1210C, 1210D. Option 1210A is selectable to display representations of one or more aggregated content items. Option 1210B is selectable to display representations of one or more shared media items (e.g., media items that have been shared with a user and/or have been shared by the user). Option 1210C is selectable to display representations of one or more collections of media items (e.g., albums). Option 1210D is selectable to display representations of media items in a media library. In some embodiments, a setting (e.g., setting 1220 shown in FIG. 12B) can be enabled to enable option 1210D (e.g., to allow users of electronic device 1200 to view the media library), and can be disabled to disable option 1210D (e.g., to prohibit users of electronic device 1200 from viewing the media library).

Media browsing user interface 1208 also includes tiles 1212A-1212E. Each tile 1212A-1212E is representative of a respective aggregated content item. For example, tile 1212A is representative of a first aggregated content item, tile 1212B is representative of a second aggregated content item, and so forth. In some embodiments, each tile 1212A-1212E displays a preview (e.g., an animated preview and/or a moving preview) of its corresponding aggregated content item (e.g., when a focus selection is on the respective tile 121A-1212E). In FIG. 12A, while electronic device 1200 displays media browsing user interface 1208 with a selection focus on tile 1212A, remote control 1204 detects activation of selection region 1206A via button press input 1216 corresponding to selection of tile 1212A, and transmits an indication of the input to electronic device 1200. Electronic device 1200 receives, from remote control 1204, the indication of input 1216 corresponding to selection of tile 1212A.

In FIG. 12C, in response to detecting (e.g., receiving the indication of) input 1216, electronic device 1200 causes display 1202 to display playback user interface 1222 displaying playback of the first aggregated content item. In FIG. 12C, displaying playback of the first aggregated content item includes displaying a first media item 1224A of the first aggregated content item. Electronic device 1200 also causes display 1202 to play an audio track (e.g., audio track 1) with visual playback of the first aggregated content item. In FIG. 12C, while electronic device 1200 plays the first aggregated content item, remote control 1204 detects activation of play/pause button 1206D via button press input 1226, and transmits an indication of the input to electronic device 1200. Electronic device 1200 receives, from remote control 1204, the indication of input 1226.

In FIG. 12D, in response to detecting (e.g., receiving the indication of) input 1226, electronic device 1200 pauses playback (e.g., visual and/or audio playback) of the first aggregated content item. Furthermore, electronic device 1200 causes display 1202 to display, overlaid on paused media item 1224A, title information 1227, scrubber 1228, and options 1232A-1232E. Title information 1227 includes title information corresponding to the first aggregated content item (e.g., Yosemite October 2020). Scrubber 1228 includes representations 1230A-1230I of each media item that is included in the first aggregated content item, arranged in the order that each media item will be presented in the first aggregated content item, so that a user can navigate through the media items while the first aggregated content item is paused. In FIG. 12D, each representation 1230A-1230I is displayed at the same size and brightness. As will be demonstrated in later figures, if a user starts to navigate through scrubber 1228 (e.g., via user inputs on remote control 1204), a currently selected media item representation will be displayed at a greater size and brightness than the other non-selected media item representations.

Option 1232A is selectable to display a plurality of duration options. Option 1232B is selectable to display a plurality of audio track options. Option 1232C is selectable to display a plurality of menu options. Option 1232D is selectable to display a plurality of aggregated content item options. Option 1232E is selectable to display one or more people options and/or one or more places options that allow a user to view aggregated content items pertaining to particular people and/or places. In FIG. 12D, remote control 1204 detects swipe right gesture 1234 via selection region 1206A, and transmits an indication of the input to electronic device 1200. Electronic device 1200 receives, from remote control 1204, the indication of input 1234.

In FIG. 12E, in response to detecting (e.g., receiving the indication of) input 1234, electronic device 1200 causes display 1202 to display a focus selection on media item representation 1230B within scrubber 1228. In FIG. 12E, media item representation 1230B is displayed at a larger size and greater brightness relative to other media item representations in scrubber 1228 (or all other media items in scrubber 1228). Furthermore, in response to input 1234, which causes selection of media item representation 1230B, playback user interface 1222 displays media item 1224B, which corresponds to media item representation 1230B, in a paused state.

In FIG. 12F, in accordance with a determination that a user input has not been received (e.g., via remote control 1204) for a threshold period of time, electronic device 1200 causes display 1202 to cease displaying title information 1227, scrubber 1228, and options 1232A-1232E, while maintaining display of playback user interface 1222, which continues to display media item 1224B in the paused state. In FIG. 12F, remote control 1204 detects button press input 1236 via selection region 1206A, and transmits an indication of the input to electronic device 1200. Electronic device 1200 receives, from remote control 1204, the indication of input 1236.

In FIG. 12G, in response to detecting (e.g., receiving the indication of) input 1236, electronic device causes display 1202 to re-display title information 1227, scrubber 1228, and options 1232A-1232E overlaid on playback user interface 1222. In FIG. 12G, remote control 1204 detects swipe left input 1238 via selection region 1206A, and transmits an indication of the input to electronic device 1200. Electronic device 1200 receives, from remote control 1204, the indication of input 1238.

In FIG. 12H, in response to detecting (e.g., receiving the indication of) input 1238, electronic device causes display 1202 to display the focus selection on media item representation 1230A within scrubber 1228. In FIG. 12H, media item representation 1230A is displayed at a larger size and greater brightness relative to the other media item representations in scrubber 1228. Furthermore, in response to input 1236, which causes selection of media item representation 1230A, playback user interface 1222 displays media item 1224A, which corresponds to media item representation 1230A, in a paused state. In FIG. 12H, remote control 1204 detects swipe up input 1240 via selection region 1206A, and transmits an indication of the input to electronic device 1200. Electronic device 1200 receives, from remote control 1204, the indication of input 1240.

In FIG. 12I, in response to detecting (e.g., receiving the indication of) input 1240, electronic device causes display 1202 to display the focus selection on option 1232A. In FIG. 12I, remote control 1204 detects button press input 1242 via selection region 1206A, and transmits an indication of the input to electronic device 1200. Electronic device 1200 receives, from remote control 1204, the indication of input 1242.

In FIG. 12J, in response to detecting (e.g., receiving the indication of) input 1242, electronic device causes display 1202 to display options 1224A-1224E. Different ones of options 1224A-1224E correspond to different playback durations for the first aggregated content item. Option 1224A is selectable to shorten the duration of the first aggregated content item by decreasing the number of media items in the first aggregated content item (e.g., from 38 media items to 24 media items). Option 1244C is selectable to increase the duration of the first aggregated content item by increasing the number of media items in the first aggregated content item. In the depicted embodiment, option 1244C corresponds to a specific time duration (e.g., 1 minute 28 seconds). Option 1244D is selectable to increase the duration of the first aggregated content item to match a duration of the audio track that has been applied to the first aggregated content item. In FIG. 12J, audio track 1 has been applied to the first aggregated content item, and has a duration of 3 minutes and 15 seconds. Accordingly, selection of option 1244D in FIG. 12J will cause the first aggregated content item to be modified (e.g., by adding and/or removing one or more media items, and/or modifying display durations for the media items in the first aggregated content item) to have a total duration of (e.g., approximately) 3 minutes and 15 seconds. In FIG. 12J, remote control 1204 detects swipe right input 1246 via selection region 1206A, and transmits an indication of the input to electronic device 1200. Electronic device 1200 receives, from remote control 1204, the indication of input 1246.

In FIG. 12K, in response to detecting (e.g., receiving the indication of) input 1246, electronic device causes display 1202 to display the focus selection on option 1232B. In FIG. 12K, remote control 1204 detects button press input 1248 via selection region 1206A, and transmits an indication of the input to electronic device 1200. Electronic device 1200 receives, from remote control 1204, the indication of input 1248.

In FIG. 12L, in response to detecting (e.g., receiving the indication of) input 1248, electronic device 1200 causes display 1202 to display options 1250A-1250E. Different ones of options 1250A-1250E correspond to different audio tracks, and are selectable to apply the selected audio track to playback of the first aggregated content item. In FIG. 12L, option 1250A is selected, and audio track 1 is applied to the first aggregated content item. In FIG. 12L, remote control 1204 detects swipe right input 1252 via selection region 1206A, and transmits an indication of the input to electronic device 1200. Electronic device 1200 receives, from remote control 1204, the indication of input 1248.

In FIG. 12M, in response to detecting (e.g., receiving the indication of) input 1252, electronic device 1200 causes display 1202 to display the focus selection on option 1232C. In FIG. 12M, remote control 1204 detects button press input 1254 via selection region 1206A, and transmits an indication of the input to electronic device 1200. Electronic device 1200 receives, from remote control 1204, the indication of input 1254.

In FIG. 12N, in response to detecting (e.g., receiving the indication of) input 1254, electronic device 1200 causes display 1202 to display options 1256A-1256B. Option 1256A is selectable to add the first aggregated content item to a favorites album. Option 1256B is selectable to delete the first aggregated content item. In FIG. 12N, remote control 1204 detects swipe down input 1258 via selection region 1206A, and transmits an indication of the input to electronic device 1200. Electronic device 1200 receives, from remote control 1204, the indication of input 1258.

In FIG. 12O, in response to detecting (e.g., receiving the indication of) input 1258, electronic device 1200 causes display 1202 to display the focus selection on option 1232D. In FIG. 12O, input 1258 causes navigation downward past scrubber 1228 to option 1232D. Accordingly, in FIG. 12O, scrubber 1228 is no longer displayed, and focus selection is on option 1232D. Electronic device 1200 also causes display 1202 to display a plurality of tiles 1260A-1260D representative of other aggregated content items. Each tile 1260A-1260D is selectable to begin playback of the selected aggregated content item. In FIG. 12O, remote control 1204 detects swipe right input 1262 via selection region 1206A, and transmits an indication of the input to electronic device 1200. Electronic device 1200 receives, from remote control 1204, the indication of input 1262.

In FIG. 12P, in response to detecting (e.g., receiving the indication of) input 1262, electronic device 1200 causes display 1202 to display the focus selection on option 1232E. Electronic device 1200 also causes display 1202 to display options 1264A-1264E. Different ones of options 1264A-1264C are associated with (e.g., correspond to) different people, or groups of people, and are selectable to cause playback of an aggregated content item that corresponds to the selected person or group of people. Different ones of options 1264D-1264E are associated (e.g., correspond to) different geographic locations, and are selectable to cause playback of an aggregated content item that corresponds to the selected geographic location. In FIG. 12P, remote control 1204 detects swipe up input 1266 via selection region 1206A, and transmits an indication of the input to electronic device 1200. Electronic device 1200 receives, from remote control 1204, the indication of input 1266.

In FIG. 12Q, in response to detecting (e.g., receiving the indication of) input 1266, electronic device 1200 causes display 1202 to re-display scrubber 1228, with the focus selection on media item representation 1230A. In FIG. 12Q, remote control 1204 detects button press input 1268 via selection region 1206A, and transmits an indication of the input to electronic device 1200. Electronic device 1200 receives, from remote control 1204, the indication of input 1268.

In FIG. 12R, in response to detecting (e.g., receiving the indication of) input 1268, electronic device 1200 begins to play (e.g., including visual and audio playback) the first aggregated content item from a playback position corresponding to the selected media item (e.g., from a playback position corresponding to media item 1224A, which corresponds to selected media item representation 1230A). Electronic device 1200 also ceases display of title information 1227, scrubber 1228, and options 1232A-1232E. In FIG. 12S, playback of the first aggregated content item (e.g., visual and/or audio playback) continues, and media item 1224A is replaced by a subsequent media item 1224B.

In FIG. 12T, playback of the first aggregated content item has continued until a final media item 1224Z is displayed. In FIG. 12T, in response to a determination that playback of the first aggregated content item has satisfied one or more termination criteria (e.g., that a final media item of the first aggregated content item has been displayed for a threshold duration of time, and/or that less than a threshold duration of time remains in playback of the first aggregated content item), electronic device 1200 causes display 1202 to display next content item user interface 1270. Next content item user interface 1270 is overlaid on playback user interface 1222, which continues to display final media item 1224Z of the first aggregated content item. In some embodiments, playback user interface 1222 is visually deemphasized (e.g., darkened and/or blurred) while next content item user interface 1270 is overlaid on it. Next content item user interface 1270 includes tiles 1276A-1276D that are representative of other aggregated content items, and each tile 1276A-1276D is selectable to initiate playback of a corresponding aggregated content item. Tile 1276A corresponds to a “next” or subsequent aggregated content item that would automatically begin playing without further user input.

Next content item user interface 1270 includes countdown timer 1274 that indicates for a user that, without further user input, a next aggregated content item (e.g., “PALM SPRINGS 2017”) will begin playing at the end of the countdown timer 1274. In FIG. 12T, remote control 1204 detects swipe down input 1278 via selection region 1206A, and transmits an indication of the input to electronic device 1200. Electronic device 1200 receives, from remote control 1204, the indication of input 1278.

In FIG. 12U, in response to detecting (e.g., receiving the indication of) input 1278, electronic device 1200 causes display 1202 to display the focus selection on tile 1276A. In response to the focus selection being positioned on tile 1276A, which is representative of a second aggregated content item, electronic device 1200 causes tile display 1202 to display a preview (e.g., an animated preview and/or a moving preview) of the second aggregated content item within tile 1276A, as can be seen in FIGS. 12U-12V. In FIG. 12V, remote control 1204 detects a diagonal swipe input 1280 via selection region 1206A, and transmits an indication of the input to electronic device 1200. Electronic device 1200 receives, from remote control 1204, the indication of input 1280.

In FIG. 12W, in response to detecting (e.g., receiving the indication of) input 1280, electronic device 1200 causes display 1202 to display the focus selection on option 1272B. In response to input 1280, electronic device 1200 also causes display 1202 to display options 1282A-1282E, which are identical to options 1264A-1264E, which were discussed above with reference to FIG. 12P. Different ones of options 1282A-1282C are associated with (e.g., correspond to) different people, or groups of people, and are selectable to cause playback of an aggregated content item that corresponds to the selected person or group of people. Different ones of options 1282D-1282E are associated with (e.g., correspond to) different geographic locations, and are selectable to cause playback of an aggregated content item that corresponds to the selected geographic location.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the presentation of media content or any other content that may be of interest to users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to present targeted content that is of greater interest to the user. Accordingly, use of such personal information data enables users to have calculated control of the presented content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of media content presentation services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and presented to users by inferring preferences based on non-personal information data or a bare minimum amount of personal information, such as the content being requested by the device associated with a user, other non-personal information available to the content presentation services, or publicly available information.

1-109. (canceled)

110. A computer system configured to communicate with a display generation component and one or more input devices, comprising:
one or more processors; and
memory storing one or more programs configured to be executed by the one or more processors, the one or more programs including instructions for:
playing, via the display generation component, visual content of a first aggregated content item, wherein the first aggregated content item comprises an ordered sequence of a first plurality of content items that are selected from a set of content items based on a first set of selection criteria;
while playing the visual content of the first aggregated content item, playing audio content that is separate from the content items;
while playing the visual content of the first aggregated content item and the audio content, detecting, via the one or more input devices, a user input; and
in response to detecting the user input:
modifying audio content that is playing while continuing to play visual content of the first aggregated content item.

111. The computer system of claim 110, the one or more programs further including instructions for:
in response to detecting the user input:
modifying a visual parameter of playback of visual content of the first aggregated content item while continuing to play visual content of the first aggregated content item.

112. The computer system of claim 111, wherein:
playing, via the display generation component, the visual content of the first aggregated content item includes displaying the visual content with a first visual filter applied to a first region of the visual content; and
modifying the visual parameter of playback of visual content of the first aggregated content item while continuing to play visual content of the first aggregated content item includes displaying the visual content with a second visual filter different from the first visual filter applied to the first region of the visual content.

113. The computer system of claim 112, wherein:
playing audio content that is separate from the content items while playing the visual content of the first aggregated content item includes playing a first audio track separate from the content items while playing the visual content of the first aggregated content item;
while playing the first audio track, the visual content of the first aggregated content item is displayed with the first visual filter applied to the first region of the visual content;
the first audio track is part of a first predefined combination with the first visual filter;
modifying audio content that is playing while continuing to play visual content of the first aggregated content item includes playing a second audio track separate from the content items and different from the first audio track while continuing to play visual content of the first aggregated content item;
while playing the second audio track, the visual content of the first aggregated content item is displayed with the second filter applied to the first region of the visual content;
the second audio track is part of a second predefined combination with the second visual filter;
the first predefined combination and the second predefined combination are part of a plurality of predefined combinations of filters and audio tracks;
the plurality of predefined combinations of filters and audio tracks are arranged in an order; and
the second predefined combination is selected to be adjacent to the first predefined combination in the order, and the first audio track is different from the second audio track.

114. The computer system of claim 113, wherein the first visual filter is selected to be part of the first predefined combination with the first audio track based on one or more audio characteristics of the first audio track and one or more visual characteristics of the first visual filter.

115. The computer system of claim 112, wherein playing the visual content of the first aggregated content item comprises:
concurrently displaying, via the display generation component:
the visual content with the first visual filter applied to the first region of the visual content, wherein the first region includes a center display portion of the visual content; and
the visual content with the second visual filter applied to a second region of the visual content different from the first region, wherein the second region includes a first edge of the visual content.

116. The computer system of claim 115, wherein playing the visual content of the first aggregated content item further comprises:
while concurrently displaying the visual content with the first visual filter applied to the first region and the second visual filter applied to the second region, displaying, via the display generation component, the visual content with a third visual filter different from the first visual filter and the second visual filter applied to a third region of the visual content different from the first region and the second region, wherein the third region includes a second edge of the visual content different from the first edge.

117. The computer system of claim 111, wherein:
playing the visual content of the first aggregated content item includes applying transitions of a first visual transition type to the visual content of the first aggregated content item, and
modifying the visual parameter of playback of visual content of the first aggregated content item while continuing to play visual content of the first aggregated content item includes modifying the transitions to a second visual transition type different from the first visual transition type.

118. The computer system of claim 117, wherein:
the first visual transition type is selected from a plurality of visual transition types based on the audio content that is played prior to detecting the user input; and
the second visual transition type is selected from the plurality of visual transition types based on audio content that is played after detecting the user input.

119. The computer system of claim 117, wherein:
the first visual transition type is selected from a first set of visual transition types based on a tempo for the audio content that is played prior to detecting the user input; and
the second visual transition type is selected from a second set of visual transition types different from the first set based on a tempo for the audio content that is played after detecting the user input.

120. The computer system claim 111, wherein playing the visual content of the first aggregated content item includes:
displaying the visual content with a first set of visual parameters applied to a first region of the visual content;
displaying the visual content with a second set of visual parameters different from the first set of visual parameters applied to a second region of the visual content different from and adjacent to the first region while concurrently displaying the visual content with the first visual filter applied to the first region; and
displaying a divider between the first region and the second region.

121. The computer system of claim 120, the one or more programs further including instructions for:
in response to detecting the user input:
shifting the divider in concurrence with the user input while continuing to play the visual content of the first aggregated content item and without shifting the visual content of the first aggregated content item.

122. The computer system of claim 111, wherein:
prior to detecting the user input, the first aggregated content item is configured to display a first content item of the first plurality of content items for a first duration of time; and
modifying the visual parameter of playback of visual content of the first aggregated content item comprises configuring the first aggregated content item to display the first content item for a second duration of time that is different from the first duration of time.

123. The computer system of claim 110, wherein the user input comprises a gesture.

124. The computer system of claim 110, wherein modifying audio content that is playing while continuing to play visual content of the first aggregated content item comprises changing the audio content from a first audio track to a second audio track different from the first audio track while continuing to play visual content of the first aggregated content item.

125. The computer system of claim 124, wherein changing the audio content from the first audio track to the second audio track comprises:
ceasing playing the first audio track at a first playback position of the first audio track, wherein the first playback position is not a beginning position of the first audio track; and
initiating playing the second audio track at a second playback position of the second audio track, wherein the second playback position is not a beginning position of the second audio track.

126. The computer system of claim 110, the one or more programs further including instructions for:
detecting, via the one or more inputs devices, one or more duration setting inputs; and
in response to detecting the one or more duration setting inputs, modifying a duration of the first aggregated content item.

127. The computer system of claim 110, wherein:
modifying audio content that is playing while continuing to play visual content of the first aggregated content item comprises changing the audio content from a first audio track to a second audio track different from the first audio track while continuing to play visual content of the first aggregated content item, wherein the first audio track has a first duration, and the second audio track has a second duration different from the first duration; and
the one or more programs further include instructions for:
in response to detecting the user input, modifying a duration of the first aggregated content item based on the second duration.

128. The computer system of claim 110, the one or more programs further including instructions for:
while playing the audio content, detecting, via the one or more inputs devices, one or more duration fitting inputs; and
in response to detecting the one or more duration fitting inputs, and in accordance with a determination that the audio content has a first duration, modifying a duration of the first aggregated content item from a second duration different from the first duration to the first duration.

129. The computer system of claim 110, the one or more programs further including instructions for:
while playing the visual content of the first aggregated content item and the audio content that is separate from the content items, displaying, via the display generation component, a first selectable object that is selectable to display a plurality of visual filter options;
while displaying the first selectable object, detecting, via the one or more input devices, a first selection input corresponding to selection of the first selectable object; and
in response to detecting the first selection input, displaying a visual filter selection user interface while continuing to play visual content of the first aggregated content item, wherein displaying the visual filter selection user interface comprises concurrently displaying:
a first user interface object that includes display of the continued playing of the visual content of the first aggregated content item with the first visual filter applied to the visual content; and
a second user interface object that includes display of the continued playing of the visual content of the first aggregated content item with a second visual filter different from the first visual filter applied to the visual content.

130. The computer system of claim 110, the one or more programs further including instructions for:
while playing the visual content of the first aggregated content item and the audio content that is separate from the content items, displaying, via the display generation component, a second selectable object that is selectable to display a plurality of audio track options;
while displaying the second selectable object, detecting, via the one or more input devices, a second selection input corresponding to selection of the second selectable object; and
in response to detecting the second selection input, displaying an audio track selection user interface, wherein the audio track selection user interface comprises:
a third user interface object corresponding to a first audio track, wherein the third user interface object is selectable to initiate a process for applying the first audio track to the first aggregated content item; and
a fourth user interface object corresponding to a second audio track different from the first audio track, wherein the fourth user interface object is selectable to initiate a process for applying the second audio track to the first aggregated content item.

131. The computer system of claim 130, wherein:
the third user interface object includes display of a track title corresponding to the first audio track; and
the fourth user interface object includes display of a track title corresponding to the second audio track.

132. The computer system of claim 130, the one or more programs further including instructions for:
while displaying the audio track selection user interface, including the third user interface object and the fourth user interface object, detecting, via the one or more input devices, a third selection input; and
in response to detecting the third selection input:
in accordance with a determination that the third selection input corresponds to selection of the third user interface object, playing the first audio track from the beginning of the first audio track; and
in accordance with a determination that the third selection input corresponds to selection of the fourth user interface object, playing the second audio track from the beginning of the second audio track.

133. The computer system of claim 130, the one or more programs further including instructions for:
while displaying the audio track selection user interface, including the third user interface object and the fourth user interface object, detecting, via the one or more input devices, a fourth selection input corresponding to selection of the third user interface object; and
in response to detecting the fourth selection input:
in accordance with a determination that a user of the computer system is not subscribed to an audio service, initiating a process to display a prompt for the user to subscribe to the audio service.

134. The computer system of claim 130, the one or more programs further including instructions for:
while displaying the audio track selection user interface, including the third user interface object and the fourth user interface object, detecting, via the one or more input devices, a fifth selection input corresponding to selection of the third user interface object; and
in response to detecting the fifth selection input:
in accordance with a determination that a user of the computer system is not subscribed to an audio service, initiating a process to display a preview user interface, wherein displaying the preview user interface includes playing a preview of the first aggregated content item in which the first audio track is applied to the visual content of the first aggregated content item, wherein the preview user interface does not permit the user from sharing the preview and/or saving the preview for later playback until the user subscribes to the audio service.

135. The computer system of claim 110, the one or more programs further including instructions for:
while playing the visual content of the first aggregated content item and the audio content that is separate from the content items, displaying a fifth user interface object that is selectable to cause the computer system to enter an editing mode;
subsequent to displaying the fifth user interface object, detecting, via the one or more input devices, a second user input; and
in response to detecting the second user input:
in accordance with a determination that the computer system is in the editing mode, modifying the audio content that is playing while continuing to play visual content of the first aggregated content item; and
in accordance with a determination that the computer system is not in the editing mode, forgoing modifying the audio content that is playing.

136. The computer system of claim 135, the one or more programs further including instructions for:
while playing the visual content of the first aggregated content item and the audio content that is separate from the content items, and while displaying the fifth user interface object, displaying, via the display generation component, a sixth user interface object that is selectable to pause playing of the visual content of the first aggregated content item;
while displaying the sixth selectable user interface object, detecting, via the one or more input devices, a sixth selection input corresponding to selection of the sixth user interface object;
in response to detecting the sixth selection input:
pausing playing of the visual content of the first aggregated content item; and
replacing display of the fifth user interface object with a seventh user interface object that is selectable to modify an aspect ratio of the visual content of the first aggregated content item;
while displaying the seventh user interface object, detecting, via the one or more input devices, a seventh selection input corresponding to selection of the seventh user interface object; and
in response to detecting the seventh selection input, displaying, via the display generation component, the visual content of the first aggregated content item transition from being displayed at a first aspect ratio to being displayed at a second aspect ratio different from the first aspect ratio.

137. The computer system of claim 110, the one or more programs further including instructions for:
while playing the visual content of the first aggregated content item, detecting, via the one or more input devices, a pause input corresponding to a request to pause playing of the visual content of the first aggregated content item; and
in response to detecting the pause input:
pausing playing of the visual content of the first aggregated content item; and
displaying, via the display generation component, a video navigation user interface element for navigating through the visual content of the first aggregated content item.

138. The computer system of claim 137, wherein displaying the visual navigation user interface element includes concurrently displaying:
a representation of a first content item of the first plurality of content items, and
a representation of a second content item of the first plurality of content items.

139. The computer system of claim 137, the one or more programs further including instructions for:
in response to detecting the pause input:
displaying, via the display generation component, and concurrently with the visual navigation user interface element, a duration control option;
while displaying the duration control option, detecting, via the one or more input devices, a duration control input corresponding to a selection of the duration control option; and
in response to detecting the duration control input, concurrently displaying, via the display generation component:
a first playback duration option corresponding to a first playback duration; and
a second playback duration option corresponding to a second playback duration different from the first playback duration.

140. The computer system of claim 137, the one or more programs further including instructions for:
in response to detecting the pause input:
displaying, via the display generation component, and concurrently with the visual navigation user interface element, an audio track control option;
while displaying the audio track control option, detecting, via the one or more input devices, an audio track control input corresponding to a selection of the audio track control option; and
in response to detecting the audio track control input, concurrently displaying, via the display generation component:
a first audio track option corresponding to a first audio track; and
a second audio track option corresponding to a second audio track different from the first audio track.

141. The computer system of claim 110, wherein playing the visual content of the first aggregated content item includes:
displaying, via the display generation component, at a first time, a first content item of the first plurality of content items in the first aggregated content item;
displaying, via the display generation component, concurrently with the first content item, first title information corresponding to the first content item;
at a second time subsequent to the first time, displaying, via the display generation component, a second content item of the first plurality of content items in the first aggregated content item; and
displaying, via the display generation component, concurrently with the second content item, second title information corresponding to the second content item and different from the first title information.

142. The computer system of claim 110, the one or more programs further including instructions for:
while playing the visual content of the first aggregated content item and the audio content, detecting, via the one or more input devices, one or more visual parameter modification inputs; and
in response to detecting the one or more visual parameter modification inputs:
in accordance with a determination that the one or more visual parameter modification inputs correspond to a first gesture, modifying playing of the visual content of the first aggregated content item in a first manner; and
in accordance with a determination that the one or more visual parameter modification inputs correspond to a second gesture different from the first gesture, modifying playing of the visual content of the first aggregated content item in a second manner different from the first manner.

143. The computer system of claim 142, wherein:
the first gesture is a long press gesture; and
modifying playing of the visual content of the first aggregated content item in the first manner includes maintaining display of a currently displayed content item during the long press gesture.

144. The computer system of claim 143, the one or more programs further including instructions for:
while maintaining display of the currently displayed content item during the long press gesture, detecting, via the one or more input devices, termination of the long press gesture; and
after detecting termination of the long press gesture, modifying a playback duration for one or more subsequent content items to be displayed subsequent to the currently displayed content item.

145. The computer system of claim 142, wherein:
the first gesture is a first tap gesture;
modifying playing of the visual content of the first aggregated content item in the first manner includes navigating to a previous content item in the ordered sequence of content items in the first aggregated content item;
the second gesture is a second tap gesture different from the first tap gesture; and
modifying playing of the visual content of the first aggregated content item in the second manner includes navigating to a next content item in the ordered sequence of content items in the first aggregated content item.

146. The computer system of claim 142, wherein:
the first gesture is a first swipe gesture;
modifying playing of the visual content of the first aggregated content item in the first manner includes navigating to a previous content item in the ordered sequence of content items in the first aggregated content item;
the second gesture is a second swipe gesture different from the first swipe gesture; and
modifying playing of the visual content of the first aggregated content item in the second manner includes navigating to a next content item in the ordered sequence of content items in the first aggregated content item.

147. The computer system of claim 142, wherein:
modifying playing of the visual content of the first aggregated content item in the first manner comprises modifying playing of the visual content of the first aggregated content item in the first manner while continuing to play the audio content that is separate from the content items; and
modifying playing of the visual content of the first aggregated content item in the second manner comprises modifying playing of the visual content of the first aggregated content item in the second manner while continuing to play the audio content that is separate from the content items.

148. The computer system of claim 110, the one or more programs further including instructions for:
while displaying, via the display generation component, a first content item of the first aggregated content item; and
in response to detecting the third user input, concurrently displaying, via the display generation component:
a tagging option that is selectable to initiate a process for identifying a person depicted in the first content item; and
a removal option that is selectable to initiate a process for removing one or more content items from the first aggregated content item that depict a person that is also depicted in the first content item.

149. A non-transitory computer-readable storage medium storing one or more programs configured to be executed by one or more processors of a computer system that is in communication with a display generation component and one or more input devices, the one or more programs including instructions for:
playing, via the display generation component, visual content of a first aggregated content item, wherein the first aggregated content item comprises an ordered sequence of a first plurality of content items that are selected from a set of content items based on a first set of selection criteria;
while playing the visual content of the first aggregated content item, playing audio content that is separate from the content items;
while playing the visual content of the first aggregated content item and the audio content, detecting, via the one or more input devices, a user input; and
in response to detecting the user input:
modifying audio content that is playing while continuing to play visual content of the first aggregated content item.

150. A method, comprising:
at a computer system that is in communication with a display generation component and one or more input devices:
playing, via the display generation component, visual content of a first aggregated content item, wherein the first aggregated content item comprises an ordered sequence of a first plurality of content items that are selected from a set of content items based on a first set of selection criteria;
while playing the visual content of the first aggregated content item, playing audio content that is separate from the content items;
while playing the visual content of the first aggregated content item and the audio content, detecting, via the one or more input devices, a user input; and
in response to detecting the user input:
modifying audio content that is playing while continuing to play visual content of the first aggregated content item.
